(19) United States
(12) Patent Application Publication
(10) Pub. No.: US 2015/0235302 A1
(43) Pub. Date: Aug. 20, 2015

(54) CONTROL METHOD OF MANAGEMENT APPARATUS AND COMPUTER-READABLE RECORDING MEDIUM

(71) Applicant: KONAMI DIGITAL ENTERTAINMENT CO., LTD., Tokyo (JP)

(72) Inventors: Takuya HASHIMOTO, Tokyo (JP); Kengo SHINODA, Tokyo (JP); Takayuki NATSUME, Tokyo (JP)

(73) Assignee: KONAMI DIGITAL ENTERTAINMENT CO., LTD., Tokyo (JP)

(21) Appl. No.: 14/699,077

(22) Filed: Apr. 29, 2015

Related U.S. Application Data
(63) Continuation of application No. PCT/JP2013/059689, filed on Mar. 29, 2013.

(30) Foreign Application Priority Data
Oct. 31, 2012 (JP) 2012-241363
Mar. 29, 2013 (JP) 2013-071861

(51) Int. Cl. G06Q 30/06; G01C 21/34; G06Q 50/00

(52) U.S. Cl. CPC G06Q 30/0639; G06Q 50/01; G01C 21/3461

(57) ABSTRACT

A management server has a user information obtainer that obtains identification information of a golf user, a friend information obtainer that obtains friend information indicating friend information between golf users, a location information obtainer that obtains location information of a home of a golf user and that of a golf course, a target user identifier that identifies a target user who is in friendship with a predetermined golf user, a route determiner that determines a route from the home of the predetermined golf user to the golf course, a distance calculator that calculates a distance between the home of the target user and a place on the route as an off-route distance, a candidate user for selection identifier that identifies a target user for whom the off-route distance is equal to or smaller than a predetermined value, as a candidate user for selection, and a display information generator that generates display information representing the candidate user for selection.

### CROSS REFERENCE TO RELATED APPLICATIONS

This application is a Continuation Application of PCT Application No. PCT/JP2013/059689, filed Mar. 29, 2013, and is based on and claims priority from Japanese Patent Application No. 2012-241363, filed Oct. 31, 2012, and Japanese Patent Application No. 2013-071861, filed on Mar. 29, 2013, the entire contents of each of which are incorporated herein by reference.

### BACKGROUND OF THE INVENTION

1. Field of the Invention

The present invention relates to a control method for a management apparatus and a computer-readable recording medium having recorded thereon a computer program for the management apparatus.

2. Description of Related Art

In recent years, services dedicated to searching for facilities such as golf courses and the like by use of the Internet have become widespread. For example, Patent Document 1 discloses a system for setting conditions such as a time required to reach a golf course from a home, and for displaying a list of golf courses that match such conditions.

### RELATED ART DOCUMENT

### Patent Document

### Patent Document 1

### Japanese Patent Application Laid-Open Publication 2005-84797

### DISCLOSURE OF THE INVENTION

### Problems to be Solved by the Invention

A plurality of people may at times wish to use a facility such as a golf course together, and at other times it may be necessary for several people to use such a facility at the same time. An event organizer (hereinafter, “organizer”) may wish to invite people to use such a facility together with other people, and in such an event the organizer may drive a vehicle so as to provide a shared ride for a number of people who are traveling to the facility. In such a case, invitation of a person who is located adjacent to the organizer's home or the destination facility, or who is located adjacent to a route that connects the home to the facility may be convenient both for the person invited and for the organizer.

However, in practice, selection of a person who is located adjacent to the organizer's home or the destination facility, or who is located adjacent to a route that connects the home to the facility may involve difficulties and may conversely require considerable effort on behalf of the organizer.

Moreover, when a facility for use already has been decided on and an organizer subsequently invites other people, the organizer may face significant logistical difficulties.

In view of the above-stated problem, it is an object of the present invention to provide with relative ease a service that enables identification of persons who are logistically and otherwise suited for use together of a facility that already has been decided upon.

### Means of Solving the Problems

Means employed by the present invention to achieve the above-described object will be described below.

To solve the problem set out in the foregoing, in accordance with one aspect of the present invention, a non-transitory computer-readable recording medium has recorded thereon a computer program for a management apparatus that provides users with a service relating to a predetermined object, the management apparatus having a computer. The computer program causes the computer to execute: a location information obtaining process for obtaining location information of a reference point of a user and location information of a facility relating to the predetermined object; a determination process for determining a route for traveling from a reference point of a predetermined user to a predetermined facility based on location information of the reference point obtained for the predetermined user and location information of the predetermined facility; a calculation process for calculating an off-route distance, which is a distance between a place on the route determined in the determination process and a reference point of a user who is not the predetermined user from among the users of the service relating to the predetermined object; a candidate identifying process for identifying, from among the users other than the predetermined user, at least one user for whom the off-route distance calculated in the calculation process turns out to be equal to or smaller than a predetermined value, as a candidate user for selection; and a display information generating process for generating display information representing the candidate user for selection identified in the candidate identifying process.

A non-transitory computer-readable recording medium according to still another aspect has recorded thereon a computer program for a management apparatus that provides users with a service relating to a predetermined object, the management apparatus having a computer, the computer program causing the computer to execute: a location information obtaining process for obtaining location information of a reference point of a user and location information of a facility relating to a predetermined object; a route information obtaining process for transmitting location information of a reference point obtained for a predetermined user and location information of the predetermined facility to a first external apparatus, and of obtaining, from the first external apparatus, location information of one or more transit point on a route from the reference point of the predetermined user to the predetermined facility, the route having been determined by the first external apparatus based on the transmitted location information; a distance information obtaining process for transmitting, to the first external apparatus, location information of a reference point obtained for a user who is not the predetermined user from among the users of the service relating to the predetermined object and at least one of, the location information of the one or more transit points obtained in the route information obtaining process, the location information of the reference point of the predetermined user, or the location information of the predetermined facility, and for obtaining an off-route distance which is a shortest one of a first distance between the reference point of the user who is not the predetermined user and the transit point, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information; a candidate identifying process for identifying, from among the users other than the predetermined user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

A control method of a management apparatus in accordance with one aspect of the present invention is a method of controlling a management apparatus that provides users with a service relating to a predetermined object. The management apparatus is capable of communicating with a terminal device of a user having a display unit for displaying a screen based on predetermined display information. The method includes: obtaining location information of a reference point of a user and location information of a facility relating to a predetermined object; in response to a request from a terminal device of a predetermined user, determining a route for traveling from a reference point of the predetermined user to a predetermined facility based on location information of the reference point obtained for the predetermined user and location information of the predetermined facility; calculating an off-route distance which is a distance between a reference point of a user who is not the predetermined user from among the users of the service relating to the predetermined object and a place on the route; identifying, from among the users other than the predetermined user, a user for whom the off-route distance turns out to be equal to or smaller than a predetermined value, as a candidate user for selection; generating display information representing the candidate user for selection; and executing transmission control of transmitting the display information to the terminal device of the predetermined user.

### BRIEF DESCRIPTION OF THE DRAWINGS

FIG. 1 is a block diagram illustrating a configuration of a service providing a system according to an embodiment of the present invention;

FIG. 2 is a schematic diagram illustrating relationships between social networking service (SNS) users and golf users;

FIG. 3 is a block diagram illustrating a configuration of a management server; FIG. 4 is a block diagram illustrating a configuration of a terminal device;

FIG. 5 is a block diagram illustrating a configuration of a map information server;

FIG. 6 is a schematic diagram illustrating an example display screen of the terminal device;

FIG. 7 is a sequence chart showing an operation sequence of a friend map display process executed in a service providing system;

FIG. 8 is a sequence chart showing an operation sequence of the friend map display process performed in the service providing system;

FIG. 9 is a schematic diagram illustrating a process for identifying SNS friends who have friendships with a predetermined golf user;

FIG. 10 is a schematic diagram illustrating a process for identifying indirect SNS friends;

FIG. 11 is a schematic diagram illustrating an example data structure of an SNS user information table;

FIG. 12 is a schematic diagram illustrating an example data structure of an SNS friend information table;

FIG. 13 is a schematic diagram illustrating an example display screen displayed on the terminal device;

FIG. 14 is a schematic diagram illustrating an example display screen displayed on the terminal device;

FIG. 15 is a schematic diagram illustrating an example display screen displayed on the terminal device;

FIG. 16 is a schematic diagram illustrating an example display screen displayed on the terminal device;

FIG. 17 is a schematic diagram illustrating an example display screen displayed on the terminal device;

FIG. 18 is a schematic diagram illustrating an example data structure of a golf course information table;

FIG. 19 is a sequence chart showing an operation sequence of a route determining process performed in the service providing system;

FIG. 20 is a schematic diagram illustrating an example data structure of an intersection information table;

FIG. 21 is a schematic diagram illustrating an example data structure of a road information table;

FIG. 22 is a schematic diagram illustrating an example data structure of a golf user information table;

FIG. 23 is a schematic diagram explaining the route determining process;

FIG. 24 is a schematic diagram explaining the route determining process;

FIG. 25 is a sequence chart showing an operation sequence of a nearby-route user identifying process executed in the service providing system;

FIG. 26 is a schematic diagram explaining the nearby-route user identifying process;

FIG. 27 is a schematic diagram illustrating an example display screen displayed on the terminal device;

FIG. 28 is a schematic diagram explaining a process for displaying a map;

FIG. 29 is a schematic diagram illustrating an example display screen displayed on the terminal device;

FIG. 30 is a schematic diagram illustrating an example data structure of an address information table;

FIG. 31 is a schematic diagram illustrating a nearby-user identifying process according to modification 1;

FIG. 32 is a schematic diagram illustrating a nearby route user identifying process according to modification 2;

FIG. 33 is a schematic diagram illustrating a route determining process according to modification 3;

FIG. 34 is a block diagram illustrating a configuration of a service providing system according to modification 9;

FIG. 35 is a block diagram illustrating a configuration of a service providing system according to modification 10;

FIG. 36 is a schematic diagram illustrating an example data structure of a golf friend information table;

FIG. 37 is a schematic diagram illustrating a process for identifying indirect golf friends;

FIG. 38 is a block diagram illustrating a configuration of a service providing system according to modification 11; and

FIG. 39 is a block diagram illustrating a configuration of a service providing system according to modification 13.

### DESCRIPTION OF PREFERRED EMBODIMENTS

In the following, description will be given of a service providing system using a management server according to an embodiment of the present invention with reference to the drawings.

### Embodiment

### 1. Overview of Service Providing System

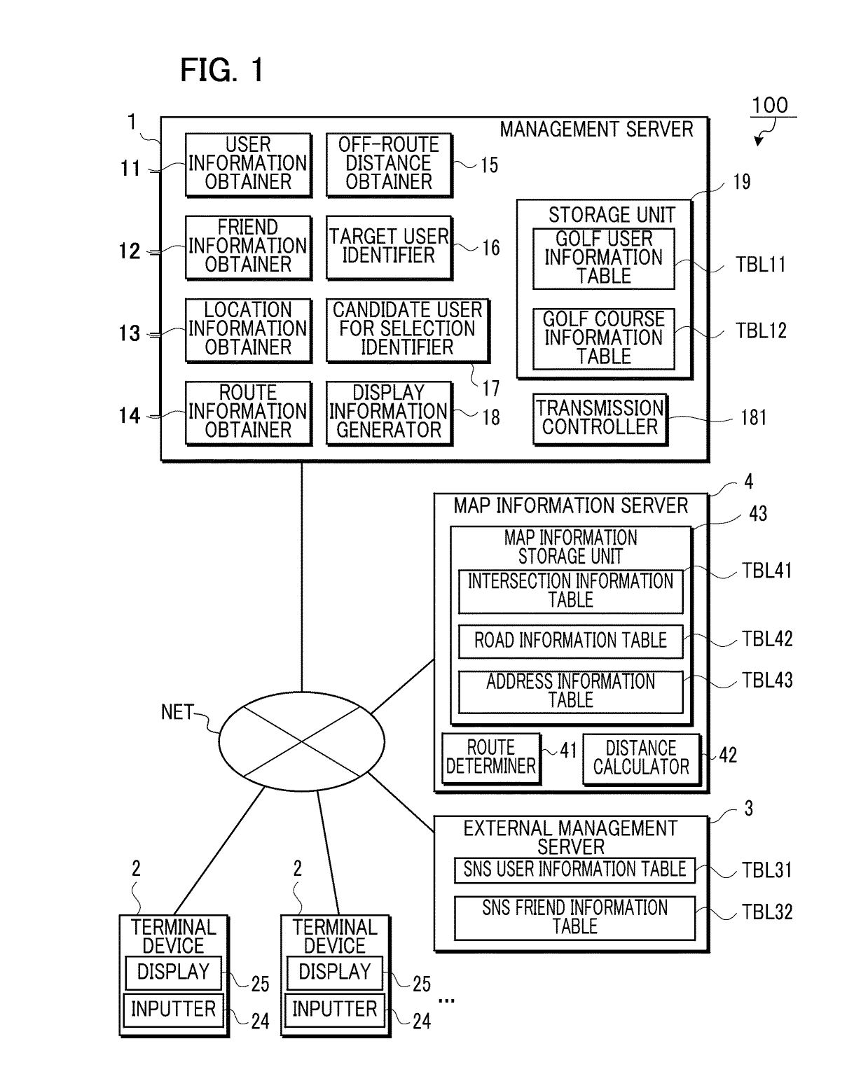

FIG. 1 is a block diagram showing a configuration of a service providing system 100 according to an embodiment of the present invention.

The service providing system 100 has a communication network NET, such as the Internet, etc., a management server 1 (a non-limiting example of a management apparatus), a terminal device 2 of a user, a map information server 4 (a non-limiting example of a first external apparatus), and an external management server 3 that provides a social networking service (SNS) site (a non-limiting example of a second external apparatus).

The management server 1 provides a golf information application service (a non-limiting example of a service relating to a predetermined object), such as an information service, and a community service relating to golf (a non-limiting example of a predetermined object), to golf users U1 (a non-limiting example of users).

By way of example, in the present embodiment description is given of a golf information application service as a service that the management server 1 provides to users. However, the management server 1 may provide application services other than the golf information application service, and such application services may include providing trip information including hotel reservations and the like, providing information on sports facilities and the like, and providing concert information and the like.

The external management server 3 provides an SNS to SNS users U2 (a non-limiting example of external users). An SNS web site provides a tool to the SNS users U2 (e.g., a message board, mail, chat, or the like) for use by the SNS users U2 in communicating with each other. On the SNS web site, one of the SNS users U2 (action originator) makes a friend request, and another one of the SNS users U2 (action destination) approves the request, whereby a specific relationship between the SNS users U2, i.e., an SNS friendship, is established. The external management server 3 manages friend information (a non-limiting example of specific relationship information) showing SNS friendships, which are specific relationships among the SNS users U2.

In the SNS provided by the external management server 3, users are able to use not only a message board, mail, chat, etc., but also social applications such as games and practical tools. Providers other than SNS providers provide social applications, and the SNS users U2 can freely select whether to use social applications and which social application to use. When the SNS users U2 wish to use a social application, the SNS users U2 may be requested to provide permission to enable on their behalf certain functions to be carried out, such as a function of the social application for accessing individual information and SNS friend information of the SNS users U2, and a function of the social application for posting a message on the message board, and other such social application functions. If the SNS users U2 permit use of these social application functions, the SNS users U2, in turn, may be allowed to use such social applications. Screens for these social applications are generally displayed on the SNS site, and the SNS users U2 use the social applications as if they were using one of the services provided by the SNS.

A golf information application service provided by the management server 1 of the present embodiment is an example service provided by a social application such as that mentioned above. In the present embodiment, for one of the SNS users U2 to become a golf user U1 who is a golf information application user, the one of the SNS users U2 is required to approve: a function of the golf information application to access individual information and the SNS friend information of the one of the SNS users U2; a function of the golf information service to post a message on the message board or the like, on behalf of the one of the SNS users U2, and any other similar function. Having approved these functions, the one of the SNS users U2 becomes a golf user U1.

Only those of the SNS users U2 who are users of the SNS provided by the external management server 3 are allowed to make use of the golf information application service provided by the management server 1. That is, the SNS users U2 are allowed to register as the golf users U1 only by way of the management server 1. The golf users U1 each are one of the SNS users U2, but the latter users may or may not include the non-golf users U1.

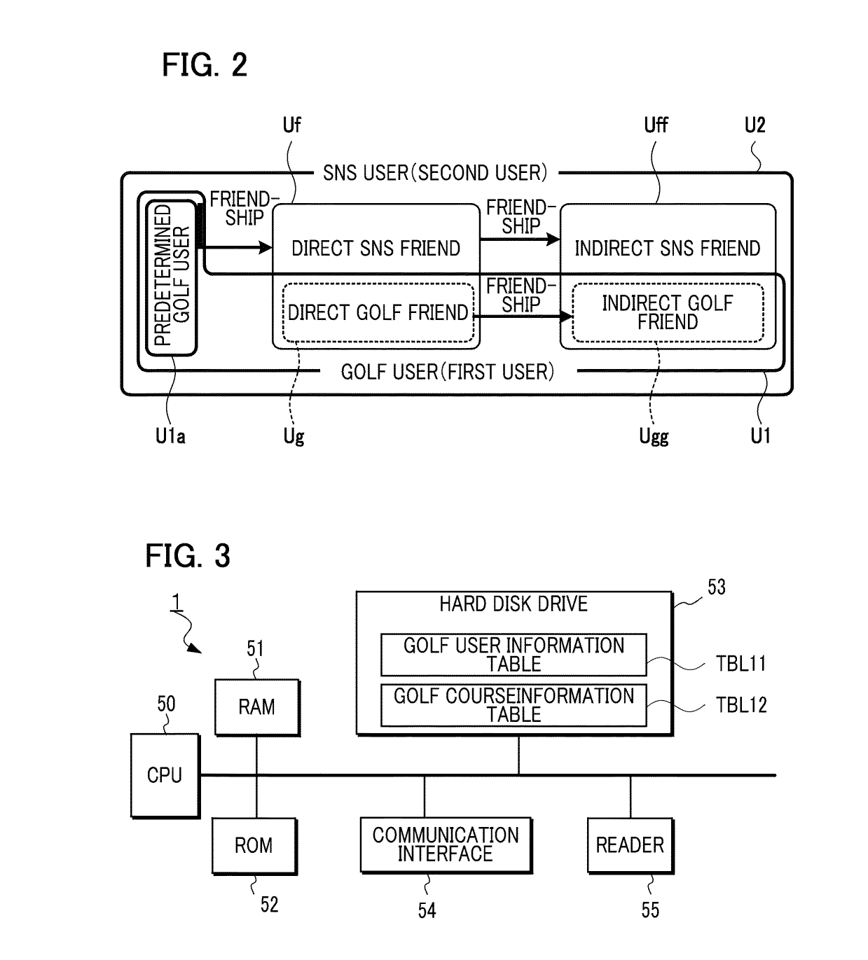

As shown in FIG. 2, a golf user U1 set is included in an SNS user U2 set. In this manner the management server 1 of the present embodiment uses the friend information indicating the SNS friendship to manage a golf friendship, which is a specific relationship between the golf users U1. As shown in FIG. 2, hereinafter the SNS users U2 who have an SNS friendship with a predetermined golf user U1a will be referred to as a “direct SNS friend Uf of the predetermined golf user U1a”; and hereinafter the SNS users U2 who have an SNS friendship with the direct SNS friend Uf of the predetermined golf user U1a will be referred to as an “indirect SNS friend Uff of the predetermined golf user U1a”. However, indirect SNS friends Uff of the predetermined golf user U1a do not include the predetermined golf user U1a or the direct SNS friends Uf of the predetermined golf user U1a.

A user who is a direct SNS friend Uf of the predetermined golf user U1a and who also is one of the golf users U1 will be referred to as a direct golf friend Ug (a non-limiting example of a specific relationship user) of the predetermined golf user U1a. A user who is an indirect SNS friend Uff of one of the golf users U1 and who also is another of the golf users U1 will be referred to as an indirect golf friend Ugg of the predetermined golf user U1a. The management server 1 manages a user who is a direct SNS friend Uf of the predetermined golf user U1a (a non-limiting example of a predetermined user) and who also is a golf user U1, from among the golf users U1, as a direct golf friend Ug of the predetermined golf user U1a.

The management server 1 manages a user who is an indirect SNS friend Uff of the predetermined golf user U1a and who also is a golf user U1 as an indirect golf friend Ugg of the predetermined golf user U1a. To “manage” does not necessarily require storing in a storage device of the management server 1 information that relates to the SNS users U2, information that relates to the golf users U1, SNS friend information that indicates a friendship of the SNS users U2, or other information necessary for managing a friendship between the golf users U1; alternatively, these items of information may be stored in an apparatus such as an external server apparatus, or the like, with the management server 1 communicating with the apparatus to request the items of information, and thereby access details of the golf users U1 and identify a friendship of the golf users U1a friendship of the golf users U1. As will be described later, the management server 1 of the present embodiment identifies direct golf friends Ug and indirect golf friends Ugg by referring to a golf user information table TBL11 stored in the management server 1, or to an SNS user information table TBL31 or an SNS friend information table TBL32 stored in the external management server 3. In the following description, a particular one of the golf users U1 sometimes will be referred to by addition of a subscript “a” to U1, as in“U1a”.

As shown in FIG. 1, the external management server 3 has the SNS user information table TBL31 and the SNS friend information table TBL32. The SNS user information table TBL31 stores identification information UID that uniquely identifies the SNS users U2 and individual information about the SNS users U2, which individual information have been registered by the SNS users U2 at the external management server 3. The SNS friend information table TBL32 stores friend information indicating SNS friendships, which consist of specific relationships between the SNS users U2. The external management server 3 is capable of executing various types of APIs (Application Program Interfaces), and upon receiving a request including parameters from the management server 1, extracts predetermined information from the SNS user information table TBL31 or from the SNS friend information table TBL32, to reply to the management server 1.

The terminal device 2 of a user is provided with an inputter 24, such as a ten-key keyboard, a mouse, or other inputter, and also includes a display 25 (a non-limiting example of a display unit), that displays screens. The terminal device 2 is capable of communication via the communication network NET, and may be, for example, a personal computer, a portable phone, a smartphone, a tablet-type terminal device, and so on. The golf information application service is provided by the management server 1 to the golf users U1 via the terminal devices 2, and the SNS is provided by the external management server 3 to the SNS users U2 via the terminal devices 2.

The map information server 4 has a map information storage device 43 in which there is stored an intersection information table TBL41, a road information table TBL42, and an address information table TBL43. The intersection information table TBL41 stores latitude and longitude information (a non-limiting example of location information) indicating a longitude and latitude of each of plural intersections (a non-limiting example of transit point candidates) existing throughout the country. The road information table TBL42 stores a time required (a non-limiting example of an index value indicative of an amount of burden involved in traveling) for traveling, for example, by vehicle on a road (i.e., a road segment) connecting two adjacent intersections (two intersections having an adjacency relationship) and between the two adjacent intersections (i.e., from one intersection to the other). The address information table TBL43 stores address information and the latitude and longitude information in association with each other. The address information includes a street address, city (municipality district town and village), prefecture, and region. Additionally, the address information may include a zip code.

The map information server 4 also has a route determiner 41 (a non-limiting example of a determiner) that determines based on two sets of latitude and longitude information locations of two places, and a route for traveling from one of the places to the other by vehicle.

More specifically, the route determiner 41 determines, from among intersections of the whole country stored in the intersection information table TBL41, plural intersections (a non-limiting example of transit points) through which one should travel from one place to the other, such that a time required for traveling between the two places is minimized, so as to determine a route for traveling from one place to the other.

The plural intersections can be determined by executing Dijkstra's Algorithm, A-star algorithm, or any other known route search calculation by using a directed graph generated based on information on plural intersections stored in the intersection information table TBL41, and based on information on a time required for traveling between intersections stored in the road information table TBL42.

The route determiner 41 generates route information indicating the determined route (route for traveling between two places). The route information includes plural pieces of latitude and longitude information corresponding to plural intersections through which one should travel from one place to the other.

The map information server 4 has a distance calculator 42 (a non-limiting example of a calculator) that calculates a distance between a route and a selected place (either on the route or off the route), the calculation being performed on the basis of on-route location information and latitude and longitude information of the selected place, with the route for traveling from a place of departure to a place of arrival and the on-route location information consisting of one or plural pieces of latitude and longitude information of one or plural places on the route.

The management server 1 has a storage unit 19 for storage of control programs that are used to control the management server 1, and for storage of several types of tables. The tables stored in the storage unit 19 include a golf user information table TBL11 in which there are stored pieces of identification information UID that uniquely identify golf users U1, and address information and latitude and longitude information of the home, or the like of one of the golf users U1, and a golf course information table TBL12 in which there are stored golf course IDs that uniquely identify golf courses (a non-limiting example of a facility relating to a predetermined object) and address information and latitude and longitude information of the golf courses.

A home, or the like of each of the golf users U1 may be a home of the golf user U1, a closest train station from the home, or a workplace, etc., namely, a place where daily activity or daily life of the golf user U1 is based. In the following, a home, etc., of one of the golf users U1 will be referred to simply as a home or as a reference point of the golf user U1. In addition to the above tables, the storage unit 19 stores a table in which there are stored setting values, and the like for generating a variety of types of display information.

The management server 1 has a user information obtainer 11 (a non-limiting example of an identification information obtainer) that obtains an identification information UID of one of the golf users U1, a friend information obtainer 12 (a non-limiting example of a relationship information obtainer) that obtains, based on the obtained identification information UID of the golf user U1, friend information and individual information from the external management server 3, and a location information obtainer 13 that obtains latitude and longitude information of various places, such as latitude and longitude information of a reference point of the golf user U1, and of a golf course.

The management server 1 has a target user identifier 16 (a non-limiting example of a target user identifier) that identifies, as a target user Utg of the predetermined golf user U1a, a user who is one of the golf users U1 from among the SNS users U2 having specific relationships with the predetermined golf user U1a (i.e., a direct golf friend Ug of the predetermined golf user U1a), and a user who is one of the golf users U1 from among the SNS users U2 having specific relationships with the direct golf friends Ug of the predetermined golf user U1a (i.e., an indirect golf friend Ugg of the predetermined golf user U1a) based on identification information UID of the predetermined golf user U1a and friend information, with the identification information UID of the predetermined golf user U1a having been obtained by the user information obtainer 11 and the friend information having been obtained based on the identification information UID of the predetermined golf user U1a by the friend information obtainer 12.

The management server 1 has a route information obtainer 14 that transmits latitude and longitude information of the home of the predetermined golf user U1a, and of a golf course to the map information server 4, and obtains route information from the map information server 4, the route information showing a route (i.e., a route for traveling from the home of the predetermined golf user U1a to the golf course), and the route having been determined by the route determiner 41 of the map information server 4 based on the transmitted latitude and longitude information.

The management server 1 has an off-route distance obtainer 15 (a non-limiting example of a distance information obtainer) that transmits the on-route location information and latitude and longitude information of a reference point of the target user Utg to the map, the on-route location information consisting of latitude and longitude information for intersections included in the route information obtained by the route information obtainer 14, for the reference point of the predetermined golf user U1a, and for the golf course. The off-route distance obtainer 15 also obtains information showing an off-route distance calculated by the distance calculator 42 based on the transmitted on-route location information and latitude and longitude information of the reference point of the target user Utg.

The management server 1 has a candidate user for selection identifier 17 (a non-limiting example of a candidate identifier) that identifies the target user Utg as a candidate user for selection Use 1 if the off-route distance of the target user Utg is equal to or shorter than a predetermined distance (predetermined value).

The management server 1 has a display information generator 18 that uses individual information obtained by the friend information obtainer 12 from the external management server 3 based on the identification information UID of the candidate users for the selection Use1, so as to generate display information including information indicating the candidate users for the selection Use1. The management server 1 has a transmission controller 181 that controls a communication interface 54 (FIG. 3) to transmit the display information to the terminal device 2 of the predetermined golf user U1a.

The display 25 of the terminal device 2 of the predetermined golf user U1a is capable of displaying a screen based on the display information generated by the display information generator 18.

### 2. Hardware Configuration

FIG. 3 shows a configuration of the management server 1. As shown in the figure, the management server 1 has a CPU (Central Processing Unit) 50 that controls the server, a RAM (Random Access Memory) 51 that is a work area for the CPU 50, a ROM (Read Only Memory) 52 that has stored therein a boot program, and the like, a hard disk drive 53 for storage of various types of computer programs and data, a communication interface (communicator) 54 that communicates with an external apparatus via the communication network NET, and a reader 55 that reads data from an information recording medium such as a compact disc and others. The hard disk drive 53 serves as the above-mentioned storage unit 19, and has stored therein a control program that controls the management server 1, various tables such as the golf user information table TBL11 and the golf course information table TBL12. The management server 1 may additionally have an inputter such as a keyboard, a mouse, or the like, and a display for displaying images.

The above-mentioned user information obtainer 11, friend information obtainer 12, location information obtainer 13, route information obtainer 14, off-route distance obtainer 15, target user identifier 16, candidate user for selection identifier 17, display information generator 18, and transmission controller 181 are each a functional block enabled by the CPU 50 executing the control program and that function in accordance with the execution of the control program.

The configuration of the external management server 3 is similar to that of the management server 1, except that the hard disk drive has stored therein the SNS user information table TBL31 and the SNS friend information table TBL32.

FIG. 4 shows a configuration of the terminal device 2. The terminal device 2 has a CPU 20 that controls the device, a RAM 21 that serves as a work area of the CPU 20, a ROM 22 that has stored therein a boot program and the like and a storage device 23 that has stored therein various types of computer programs and data, an inputter 24, such as a mouse and a keyboard, the display 25 that displays images, and a communication interface 26 that communicates with an external apparatus via the communication network NET.

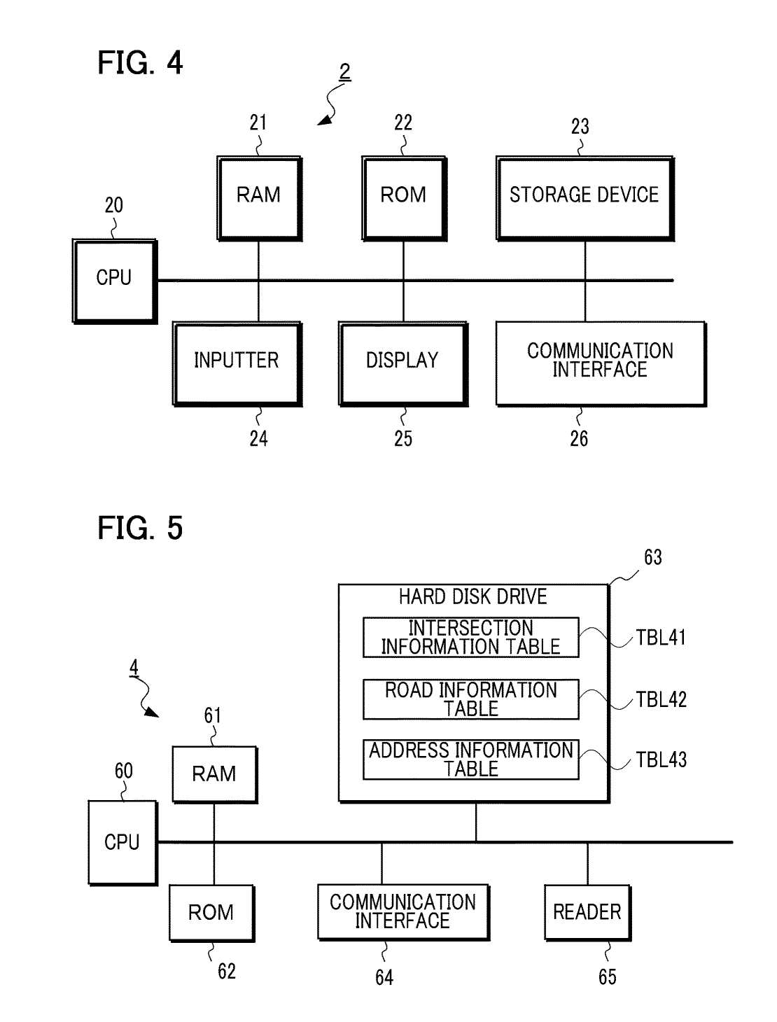

FIG. 5 shows a configuration of the map information server 4. The map information server 4 has a CPU 60 that controls the entire apparatus, a RAM 61 that serves as a work area of the CPU 60, a ROM 62 that has stored therein a map information server control program that controls the map information server 4 and a boot program, etc., a storage device (hard disk drive) 63 that has stored therein various computer programs and data, an inputter 64, such as a mouse, and a keyboard, and the display 65 that displays images, and a communication interface 66 that communicates with an external apparatus via the communication network NET.

The above-mentioned route determiner 41 and the distance calculator 42 are functional blocks enabled by the CPU 60 executing the map information server control program and that function in accordance with the execution of the map information server control program.

### 3. Operation of Service Providing System

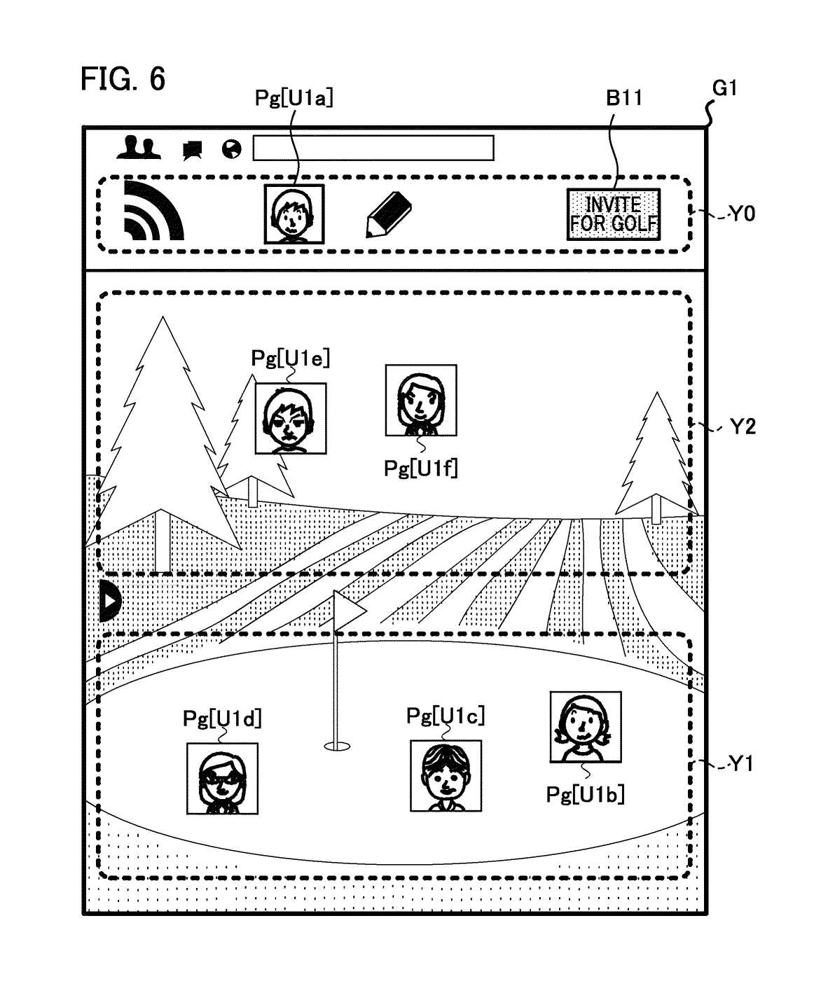

An operation of the service providing system 100 provided by the management server 1 will be explained with reference to FIGS. 6 to 30.

The management server 1 provides, to each of the golf users U1, a personalized page that collectively shows various types of information on golf.

The personalized page of the present embodiment includes a golf friend list screen G1 (friend map), a golf friend selection screen G2, a region selection screen G3, a prefecture selection screen G4, a Japanese alphabet selection screen G5, a golf course selection screen G6, a nearby-route friend selection screen G7, and an address registration screen G8.

In the following, description will be given of an overview on each of the above screens and a process for displaying each of the above screens.

### 3.1. Golf Friend List Screen

FIG. 6 is an example golf friend list screen G1 (friend map), and is one example of different types of personalized pages that can be displayed on the display 25 of the terminal device 2 of the predetermined golf user U1a. When the predetermined golf user U1a logs into the golf information application service, the golf friend list screen G1 is displayed on the display 25 of the terminal device 2 of the predetermined golf user U1a.

As shown in FIG. 6, a region Y0 of the golf friend list screen G1 displays a profile image Pg [U1a] of the predetermined golf user U1a and a button B11, “invite for golf”.

A region Y1 of the golf friend list screen G1 displays profile images Pg (hereinafter, these profile images on occasion will be referred to as “information indicating direct golf friend Ug”) of direct golf friends Ug (in the shown example, golf users U1b, U1c, and U1d) of the predetermined golf user U1a. A region Y2 displays profile images Pg (hereinafter, these profile images on occasion will be referred to as “information showing indirect golf friend Ugg”) of indirect golf friends Ugg (in the shown example, golf users U1e and U1f) of the predetermined golf user U1a.

Since the golf friend list screen G1 thus displays the profile images Pg of the direct golf friends Ug of the predetermined golf user U1a, and the profile images Pg of the indirect golf friends Ugg of the predetermined golf user U1a respectively in the separate regions Y1 and Y2, the predetermined golf user U1a is able to easily grasp a hierarchical friendship.

The predetermined golf user U1a can click, etc., a log-out button (not shown) to log out of the golf information application service.

In the following, description will be given of an example friend map display process for causing the display 25 of the terminal device 2 of the predetermined golf user U1a to display the golf friend list screen G1.

### 3.2. Friend Map Display Process

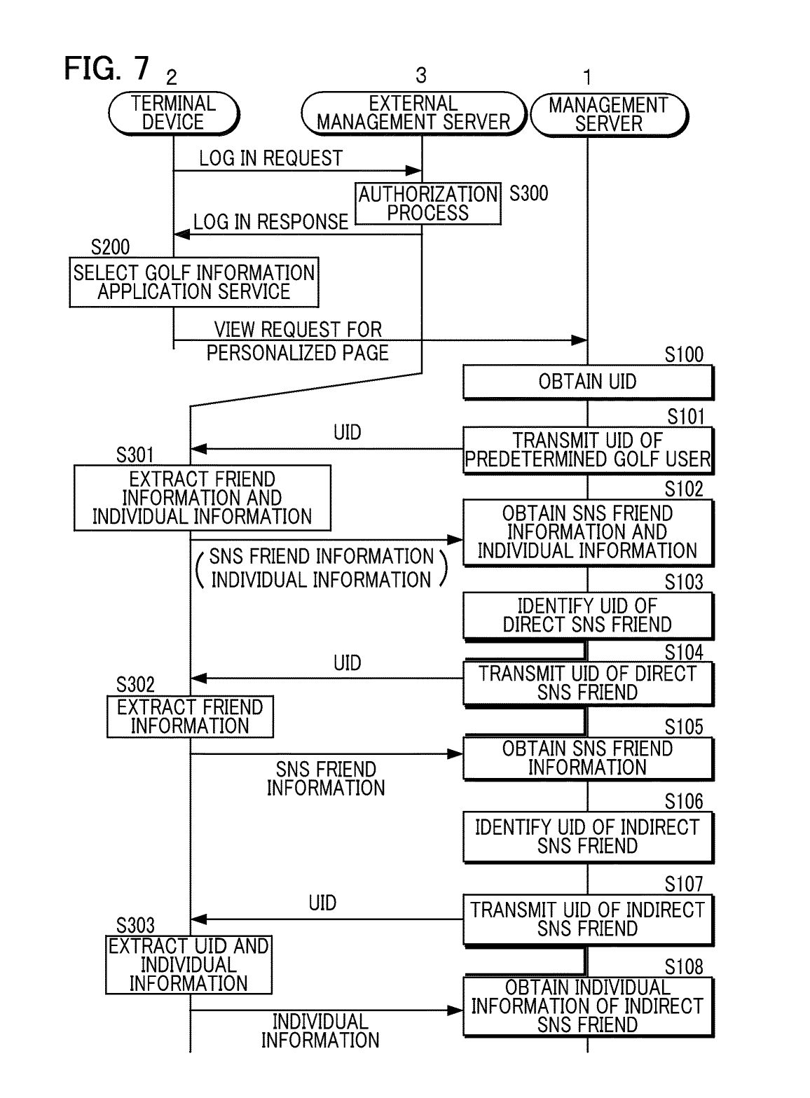

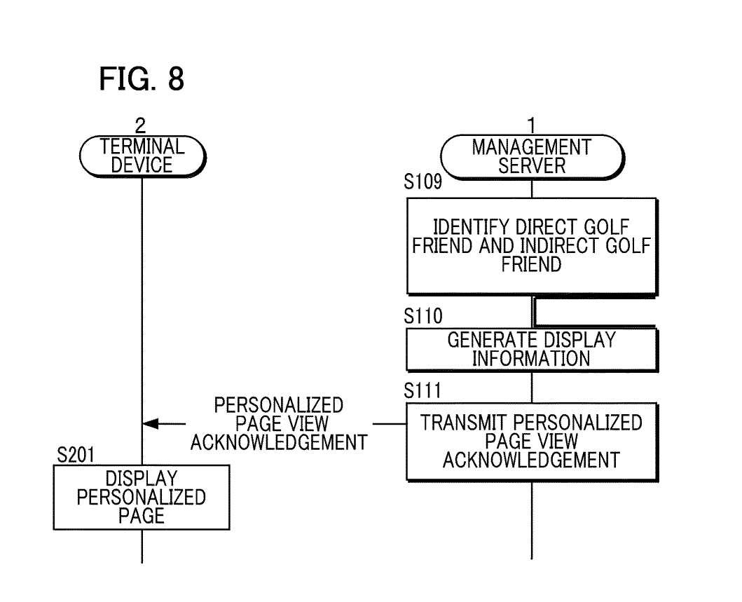

FIGS. 7 and 8 show an operation sequence of the service providing system 100 with respect to the friend map display process. The friend map display process is performed every time the golf user U1 logs into the golf information application service.

When an SNS user U2 of the terminal device 2 activates an application that runs on a web browser or that runs when installed on the terminal device 2, to access the SNS site, the display 25 of the terminal device 2 displays a log-in screen (it is of note that the SNS user U2 is also a golf user U1, and in the following, this golf user U1 will be referred to as “predetermined golf user U1a”). The log-in screen displays an input box for inputting identification information UID and a password and a transmission button. When the predetermined golf user U1a enters the identification information UID and the password in the input box, to click the transmission button, the terminal device 2 transmits a log-in request containing the entered identification information UID and password, to the external management server 3.

Upon receiving the log-in request, the external management server 3 executes an authorization process (S300). Specifically, the CPU of the external management server 3 determines whether a pair of the identification information UID and the password has been stored, to accept the log-in if conditions for determination are satisfied, and reject the log-in otherwise. The CPU of the external management server 3 transmits a log-in response showing a determination result to the terminal device 2. FIG. 7 shows an example accepting the log-in. The pair of the identification information UID and the password once entered in the terminal device 2 may be stored in the terminal device 2 for a predetermined period, such that the log-in can be omitted if a subsequent access is made within the predetermined period.

When the predetermined golf user U1a selects the golf information application service from a menu (S200), the terminal device 2 transmits a personalized page view request to the management server 1. Upon receiving the personalized page view request, the CPU 50 of the management server 1 obtains the identification information UID of the predetermined golf user U1a from the personalized page view request (S100).

The CPU 50 of the management server 1 performs Step S100, thereby serving as the user information obtainer 11.

The CPU 50 of the management server 1 then controls transmission of the identification information UID of the predetermined golf user U1a to the external management server 3 (S101).

The external management server 3, upon receiving the identification information UID of the predetermined golf user U1a, the CPU of the external management server 3 accesses the SNS friend information table TBL32, to obtain SNS friend information and accesses the SNS user information table TBL31, to obtain individual information (S301).

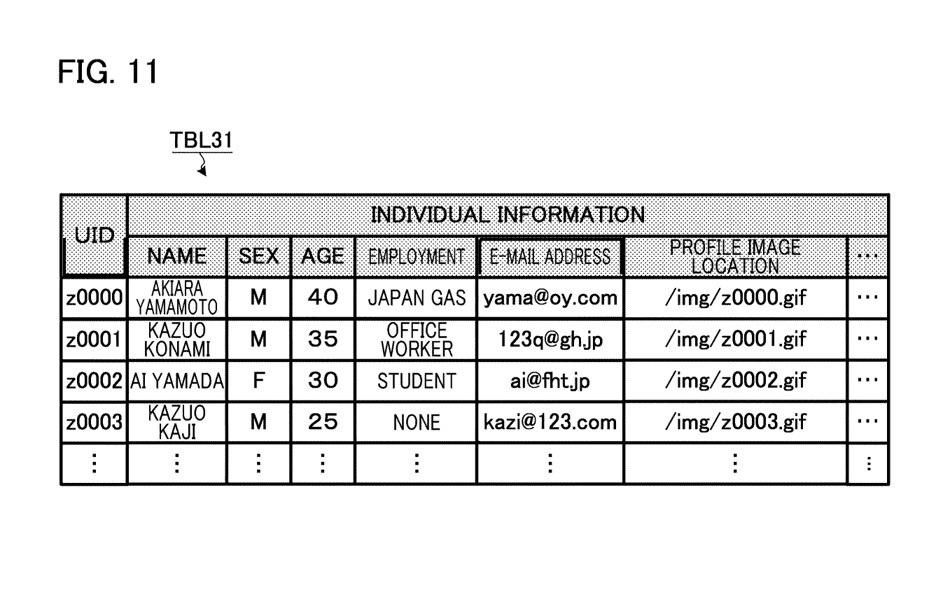

FIG. 11 illustrates an example data structure of the SNS user information table TBL31. The SNS user information table TBL31 has stored therein plural records. Each record contains identification information UID (serving as account) that uniquely identifies an SNS user U2 and individual information registered by the SNS user U2 at the external management server 3. The individual information includes, for example, a name, sex, place of employment, mail address, hyperlink destination to the profile image Pg, and any other relevant individual information of the SNS user U2.

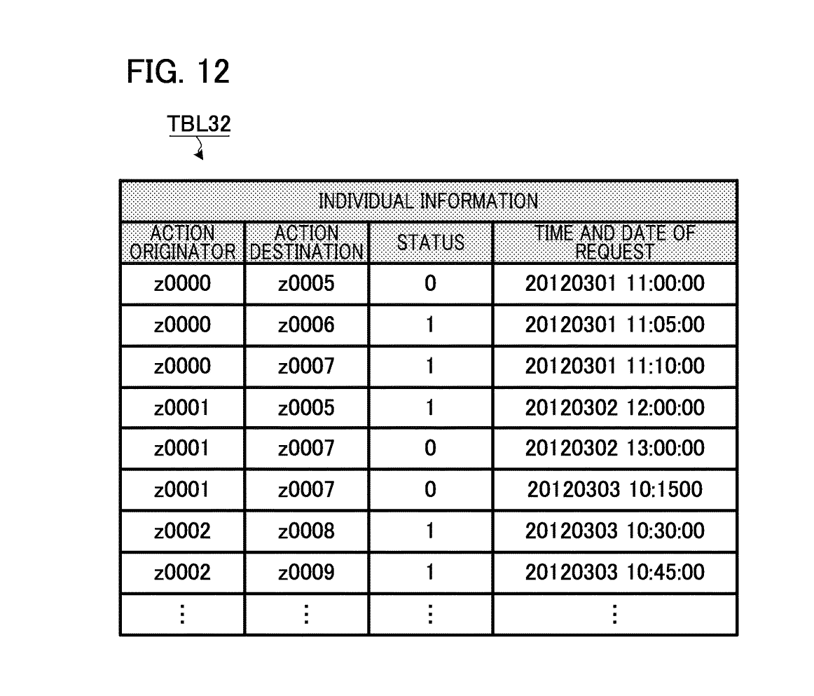

FIG. 12 shows an example data structure of the SNS friend information table TBL32. The SNS friend information table TBL32 has plural records. Each record contains SNS friend information, i.e., identification information UID of an action originator, identification information UID of an action destination, a status, and time and date of a friend request. The action originator (friend request transmitter) is an SNS user U2 who has transmitted a friend request, and the action destination (friend request receiver) is an SNS user U2 who has received the friend request. The status indicates a status of the friend request, with “0” indicating a corresponding request pending and “1” indicating a corresponding request having been accepted. In the example shown in FIG. 12, the SNS user U2 having the identification information UID of “z0000” makes a friend request to an SNS user U2 having the identification information UID of “z0006”, and the request is accepted.

The CPU of the external management server 3 accesses the SNS friend information table TBL32, to extract records that have the identification information UID of the predetermined golf user U1a as the action originator or as the action destination, thereby extracting the SNS friend information. The CPU of the external management server 3 extracts individual information from the SNS user information table TBL31 using, as a search key, identification information UID stored in the extracted records as action originator or as action destination. The external management server 3 transmits information including the extracted SNS friend information and individual information to the management server 1.

The CPU 50 of the management server 1 obtains, from the information, the SNS friend information and individual information received from the external management server 3 (S102). The individual information obtained at Step S102 includes the individual information of the predetermined golf user U1a and that of the one or more direct SNS friends Uf, if any, of the predetermined golf user U1a.

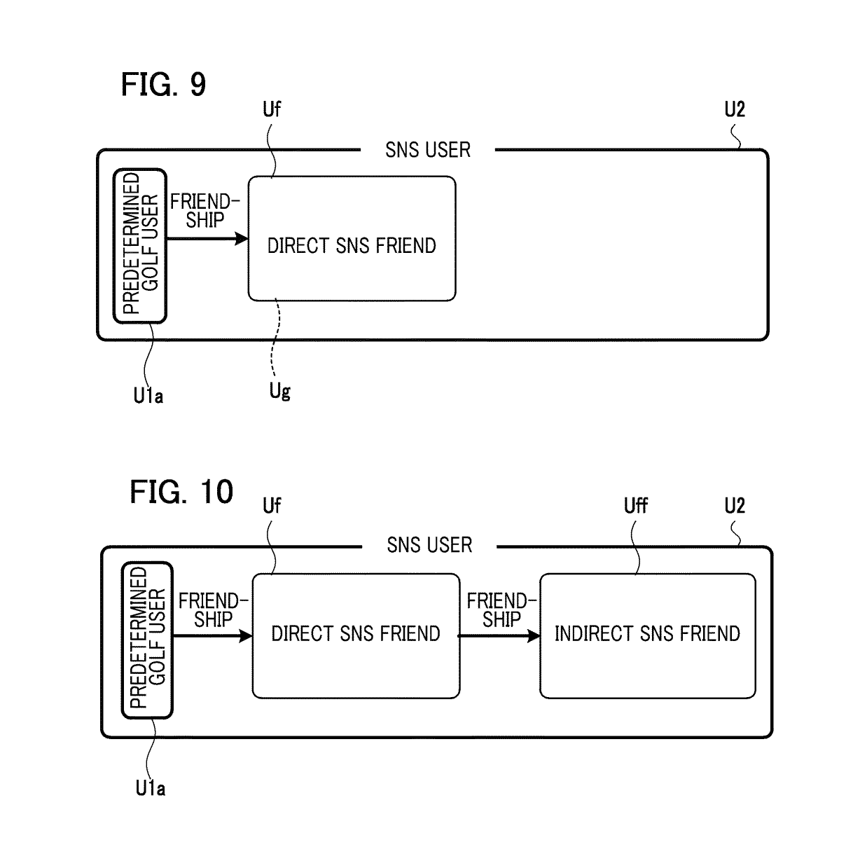

The CPU 50 of the management server 1 then identifies identification information UID of the one or more direct SNS friends Uf of the predetermined golf user U1a (S103). Specifically, the identification information UID of the predetermined golf user U1a and an overlapping piece or pieces of identification information UID are removed from the identification information UID stored as an action originator or action destination in the records of the SNS friend information, and the remaining piece or pieces of identification information UID are identified as the identification information UID of the one or more direct SNS friends Uf of the predetermined golf user U1a. This process enables identification of a direct SNS friend Uf who is in friendship with the predetermined golf user U1a, as illustrated in FIG. 9. In a case in which there is no direct SNS friend Uf of the predetermined golf user U1a, the process proceeds to Step S110. The CPU 50 of the management server 1 subsequently controls transmission of the identification information UID of the one or more direct SNS friends Uf of the predetermined golf user U1a to the external management server 3 (S104).

Upon receiving the identification information UID of the direct SNS friends Uf of the predetermined golf user U1a, the CPU of the external management server 3 accesses the SNS friend information table TBL32, to extract, for each of the one or more pieces of identification information UID, a record having a corresponding identification information UID either as action originator or as action destination, to extract the SNS friend information (S302). The external management server 3 then transmits information including the extracted SNS friend information to the management server 1.

Upon receiving the information including the SNS friend information, the CPU 50 of the management server 1 obtains the received SNS friend information (S105).

The CPU 50 of the management server 1 subsequently identifies one or more pieces of identification information UID of one or more indirect SNS friends Uff of the predetermined golf user U1a (S106). Specifically, an overlapping piece or pieces of identification information UID are removed from pieces of identification information UID stored as action originator or action destination in records of the SNS friend information, and the remaining piece or pieces of identification information UID are identified as identification information UID of the one or more indirect SNS friends Uff of the predetermined golf user U1a. The above processes enable the identification of a direct SNS friend Uf and an indirect SNS friend Uff of the predetermined golf user U1a, as illustrated in FIG. 10.

The CPU 50 of the management server 1 subsequently controls transmission of the one or more pieces of identification information UID of the one or more indirect SNS friends Uff of the predetermined golf user U1a to the external management server 3 (S107).

Upon receiving the one or more pieces of identification information UID of the one or more indirect SNS friends Uff of the predetermined golf user U1a, the CPU of the external management server 3 accesses the SNS user information table TBL31, to extract, for each of the one or more pieces of the identification information UID, a record having a corresponding identification information UID (S303). The external management server 3 then transmits information including the individual information recorded in each of the one or more extracted records to the management server 1.

When the management server 1 receives the information including the individual information, the CPU 50 of the management server 1 obtains the individual information (S108). The individual information obtained at Step S108 is individual information of the one or more indirect SNS friends Uff of the predetermined golf user U1a.

Subsequently, as shown in FIG. 8, the CPU 50 of the management server 1 identifies one or more direct golf friends Ug and one or more indirect golf friends Ugg, if any, of the predetermined golf user U1a on the basis of the identification information UID of the one or more direct SNS friends Uf of the predetermined golf user U1a, identification information UID of the one or more indirect SNS friends Uff of the predetermined golf user U1a, and the identification information UID stored in the golf user information table TBL11. The CPU 50 determines the one or more direct golf friends Ug and one or more indirect golf friends Ugg identified, as a target user Utg of the predetermined golf user U1a (S109).

Specifically, the CPU 50 determines, as identification information UID of the direct golf friend Ug of the predetermined golf user U1a, that which, if any, corresponds to any one of the pieces of identification information UID of the golf users U1, from among the one or more pieces of identification information UID of the one or more direct SNS friends Uf of the predetermined golf user U1a identified at Step S103. Also, the CPU 50 determines, as identification information UID of the indirect golf friend Ugg of the predetermined golf user U1a, any information that corresponds to one or more of the pieces of identification information UID of the golf users U1 from among the one or more pieces of identification information UID of the one or more indirect SNS friends Uff of the predetermined golf user U1a identified at Step S106. This process enables identification of the direct golf friend Ug and the indirect golf friend Ugg of the predetermined golf user U1a, such as illustrated in FIG. 2.

Thus, the CPU 50 of the management server 1 performs Steps S103, S106, and S109, thereby functioning as the target user identifier 16.

The CPU 50 performs Steps S101, S102, S104, S105, S107, and S108, thereby functioning as the friend information obtainer 12.

Subsequently, the CPU 50 of the management server 1 generates display information on the basis of the one or more pieces of individual information obtained at Step S102 and the one or more pieces of individual information obtained at Step S108 (S110). Specifically, the CPU 50 of the management server 1 first extracts, from each of the one or more pieces of individual information obtained at Steps S102 and S108, hyperlink information indicating an address which stores data of the profile image Pg of a corresponding target user Utg. The CPU 50 of the management server 1 generates display information including the extracted hyperlink information. The present embodiment provides the profile image Pg representing the target user Utg as hyperlink information indicating an address which stores data of the profile image Pg of a corresponding target user Utg in order to reduce the transmission data amount; however, the CPU 50 may alternatively provide the image data itself of the profile image Pg. The display information generated at Step S110 includes information indicating a position on the screen where the profile image Pg of the target user Utg is disposed. The CPU 50 of the management server 1 subsequently controls transmission of a personalized page view acknowledgement containing the display information to the terminal device 2 of the predetermined golf user U1a (S111).

When the terminal device 2 of the predetermined golf user U1a receives the personalized page view acknowledgement, the CPU 20 of the terminal device 2 causes the display 25 to display a golf friend list screen G1 showing the one or more profile images Pg of the one or more direct golf friends Ug, if any, and those of the one or more indirect golf friends Ugg, if any (S201).

### 3.3. Golf Course Selection Screen

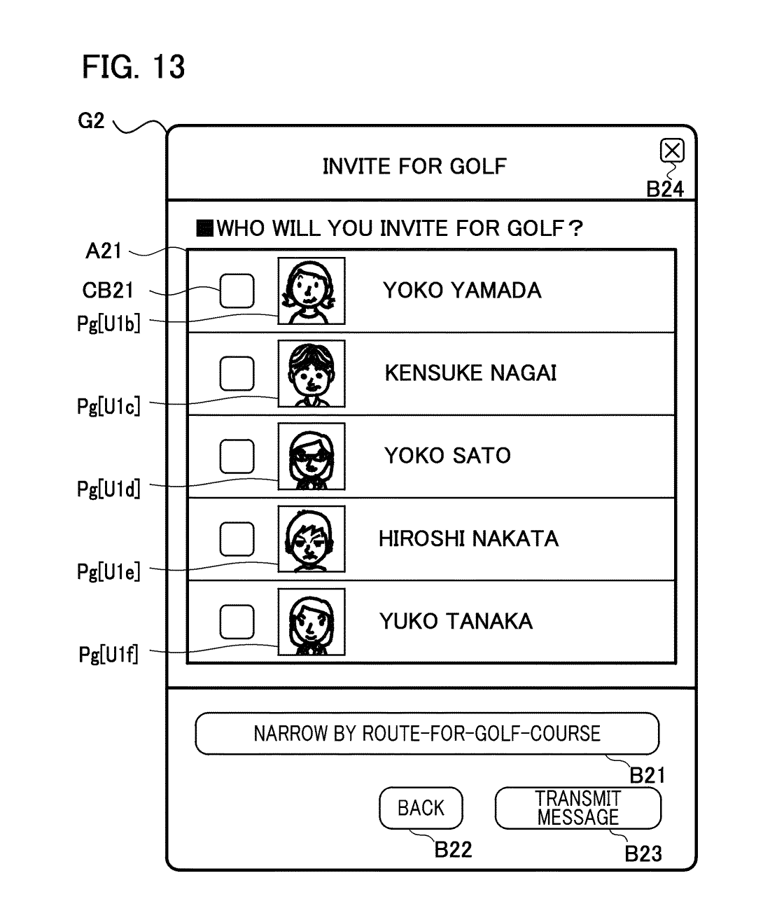

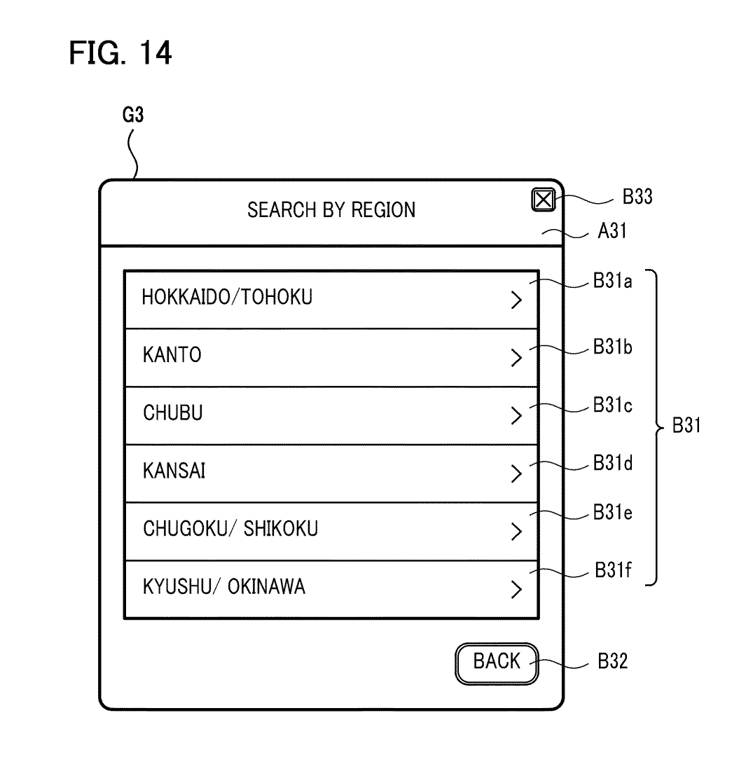

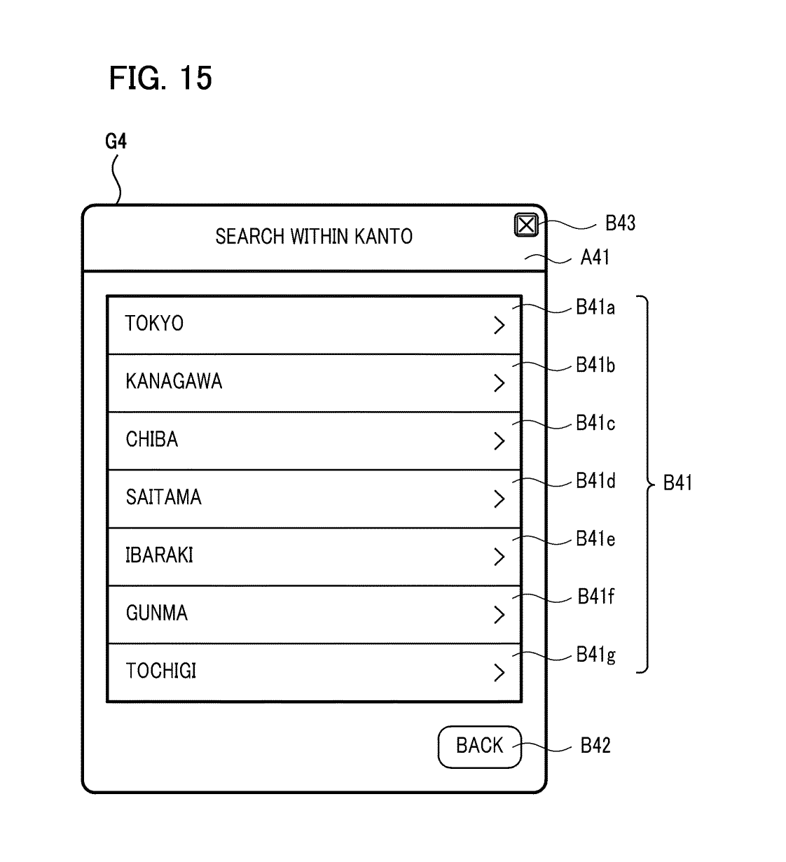

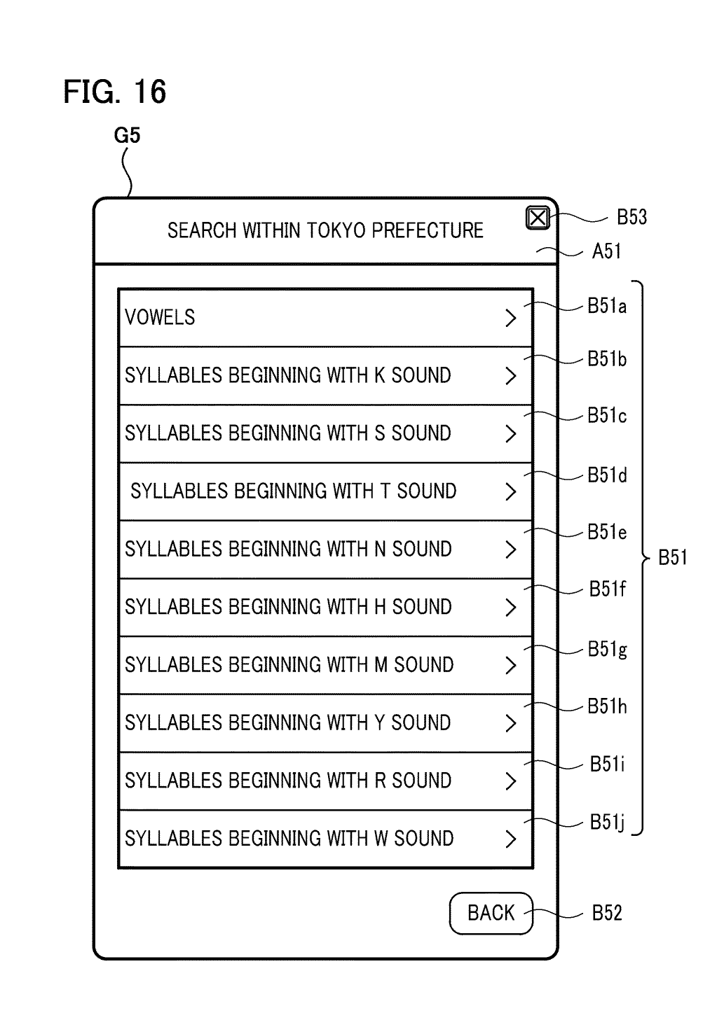

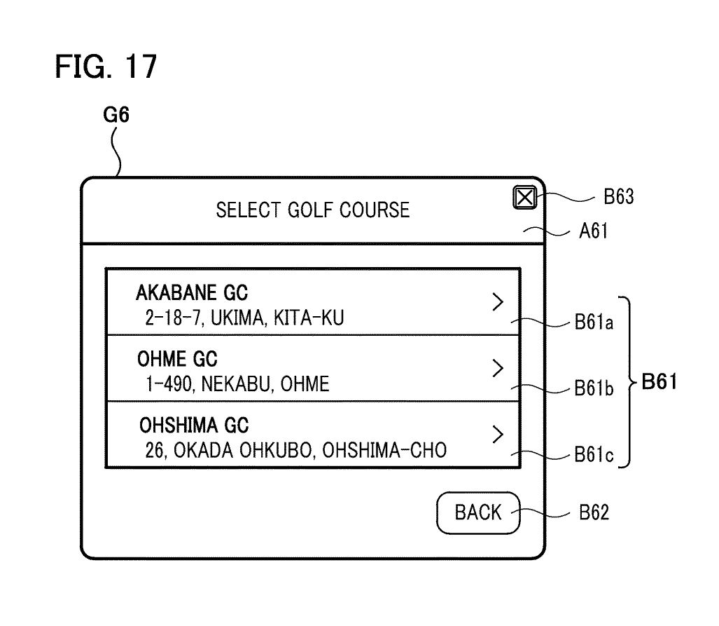

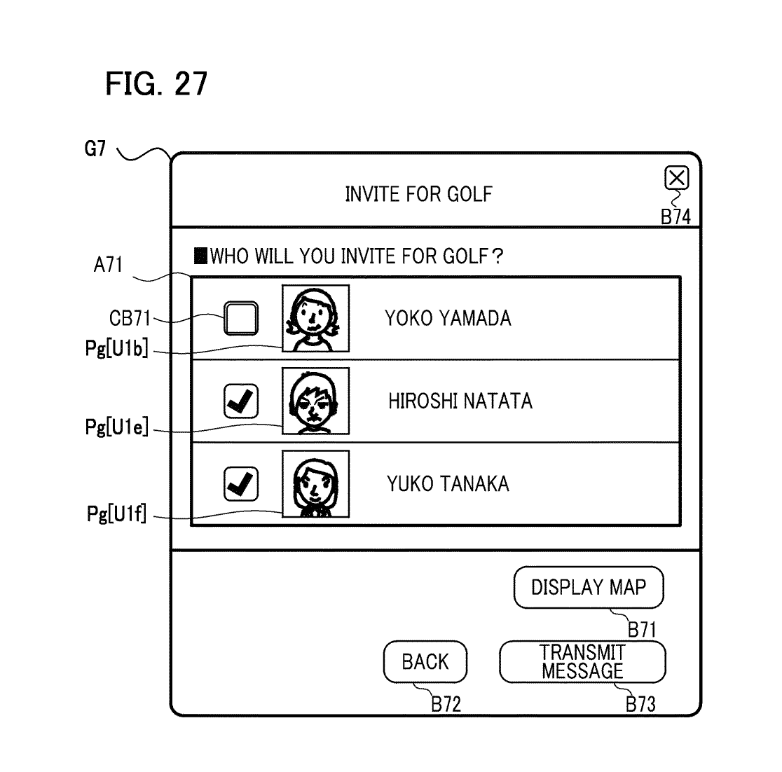

The predetermined golf user U1a is able to select a golf course on which to play and also to select a golf user U1 to invite to the golf course, with a golf friend selection screen G2 (FIG. 13), a region selection screen G3 (FIG. 14), a prefecture selection screen G4 (FIG. 15), a Japanese alphabet selection screen G5 (FIG. 16), a golf course selection screen G6 (FIG. 17), and a nearby-route friend (near-route friend) selection screen G7 (FIG. 27).

The following description gives overviews of these screens and processes for displaying the screens.

Upon receiving a click operation on the invite-for-golf button B11 of the golf friend list screen G1 (FIG. 6) of the personalized page of the predetermined golf user U1a, the terminal device 2 transmits a view request of the golf friend selection screen G2 to the management server 1. Upon receiving the view request of the golf friend selection screen G2, the CPU 50 of the management server 1 generates information (display information of the golf friend selection screen G2) necessary for the CPU 20 of the terminal device 2 of the predetermined golf user U1a to cause the display 25 to display the golf friend selection screen G2, and transmits a response containing the display information to the terminal device 2 of the predetermined golf user U1a.

Upon receiving the display information of the golf friend selection screen G2, the CPU 20 of the terminal device 2 of the predetermined golf user U1a causes the display 25 to display the golf friend selection screen G2 as depicted in FIG. 13, for example with a pop-up. The present embodiment causes the golf friend selection screen G2 to be displayed with a pop-up. Alternatively, the golf friend list screen G1 may be switched to the golf friend selection screen G2, to display the golf friend selection screen G2.

As shown in FIG. 13, the golf friend selection screen G2 includes a narrow down button B21 for narrowing down golf friend candidates with a route to the golf course, a message transmission button B23, a back button B22 for returning to the previously displayed golf friend list screen G1, and a close button B24 for closing the golf friend selection screen G2. The display area A21 of the golf friend selection screen G2 displays a list of items of information on the target users Utg of the predetermined golf user U1a, and has check boxes CB21 for selecting one or more of the target users Utg, the check boxes corresponding one to one to each item of information on each target user Utg. Each information item on the target user Utg is, for example the profile image Pg and the name of a corresponding target user Utg. The golf friend selection screen G2 depicted in FIG. 13 displays information on five golf users U1 (U1b to U1f), who are each the target user Utg of the predetermined golf user U1a (i.e., profile images Pg[U1b] to Pg[U1f], and names of the golf users U1b to U1f).

In a case where at least one target user Utg has been selected (i.e., at least one check box CB21 has been checked), and a click operation is performed on the message transmission button B23 of the golf friend selection screen G2 of FIG. 13, the CPU 20 carries out a process for inviting the selected at least one target user Utg for golf.

Specifically, when a click operation is performed on the message transmission button B23, the terminal device 2 of the predetermined golf user U1a transmits a request for transmitting an invite-for-golf message to the management server 1. The invite-for-golf message is a message meaning that the predetermined golf user U1a is inviting the at least one target user Utg selected on the golf friend selection screen G2. The request for transmitting an invite-for-golf message is a request that the management server 1 transmits as an invite-for-golf message to the at least one target user Utg selected on the golf friend selection screen G2.

Upon receiving the request, the CPU 50 of the management server 1 transmits the invite-for-golf message from the predetermined golf user U1a to the terminal device 2 of the at least one target user Utg whom the predetermined golf user U1a has selected. The CPU 50 of the management server 1 may transmit the invite-for-golf message to the terminal device 2 of the at least one target user Utg when a corresponding target user Utg logs into the golf information application service. That is, when the corresponding target user Utg logs into the golf information application service, the personalized page of the target user Utg may display details of the invite-for-golf message transmitted from the golf user U1a (i.e., a message that the target user Utg has been invited for golf by the predetermined golf user U1a). Alternatively, the invite-for-golf message may be notified by electronic mail. Another alternative process includes transmitting the invite-for-golf message from the management server 1 to the external management server 3 and the SNS web site displaying contents of the invite-for-golf message from the predetermined golf user U1a when the target user Utg logs in the SNS as an SNS user U2.

Upon receiving a click operation on the route-for-golf-course narrow down button B21 on the golf friend selection screen G2 shown in FIG. 13, the terminal device 2 transmits a view-request of the region selection screen G3 to the management server 1. Upon receiving a view request of the region selection screen G3, the CPU 50 of the management server 1 generates information necessary for the CPU 20 of the terminal device 2 of the predetermined golf user U1a to cause the display 25 to display the region selection screen G3 (i.e., display information of the region selection screen G3), to transmit a response containing the display information to the terminal device 2 of the predetermined golf user U1a.

When the terminal device 2 of the predetermined golf user U1a receives the display information of the region selection screen G3, the CPU 20 of the terminal device 2 causes the display 25 to display the region selection screen G3 as illustrated in FIG. 14.

As illustrated in FIG. 14, the region selection screen G3 displays plural region selection buttons B31 (B31a to B31f), a back button B32 to return to the previous golf friend selection screen G2, and a close button B33 for closing the region selection screen G3. The region selection buttons B31a to 31f display names of regions (names of sectioned regions of Japan), such as the Kanto region (eastern part of Japan, including Tokyo) and the Kansai region (south-western part of Japan, including Kyoto and Osaka).

Upon receiving a click operation on any one of the plural region selection buttons B31, the terminal device 2 transmits a view request of the prefecture selection screen G4 to the management server 1. The request includes information for identifying a region corresponding to the clicked region selection button B31 (e.g., the name of a region displayed on the clicked one of the plural region selection buttons B31).

Upon receiving the view request of the prefecture selection screen G4, the CPU 50 of the management server 1 generates information necessary for the CPU 20 of the terminal device 2 of the predetermined golf user U1a to cause the display 25 to display the prefecture selection screen G4 (i.e., display information of prefecture selection screen G4), to transmit a response containing the display information to the terminal device 2 of the predetermined golf user U1a. The display information includes the name of the region displayed on the clicked region selection button B31 of the region selection screen G3 and the names of prefectures located in the region.

When the terminal device 2 of the predetermined golf user U1a receives the display information of the prefecture selection screen G4, the CPU 20 of the terminal device 2 causes the display 25 to display the prefecture selection screen G4 as illustrated in FIG. 15.

As illustrated in FIG. 15, the prefecture selection screen G4 has plural prefecture selection buttons B41, a back button B42 for returning to the previous region selection screen G3, and a close button B43 for closing the prefecture selection screen G4.

The plural prefecture selection buttons B41 display names of prefectures located in the region displayed on the clicked region selection button B31 of the region selection screen G3. For example, when a click operation is performed on the region selection button B31b, which displays the Kanto Region, of the region selection screen G3, the prefecture selection screen G4 displays seven prefecture selection buttons B41a to B41g, which display prefectures of the Kanto Region. The display area A41 of the prefecture selection screen G4 displays the name of the region displayed on the clicked region selection button B31 of the region selection screen G3.

Upon receiving a click operation on any one of the plural prefecture selection buttons B41, the terminal device 2 transmits a view request for the Japanese alphabet selection screen G5 to the management server 1. The request includes information for identifying a prefecture corresponding to the clicked prefecture selection button B41 (e.g., name of prefecture displayed on the clicked prefecture selection button B41).

Upon receiving the view request for the Japanese alphabet selection screen G5, the CPU 50 of the management server 1 generates information necessary for the CPU 20 of the terminal device 2 of the predetermined golf user U1a to cause the display 25 to display the Japanese alphabet selection screen G5 (i.e., display information of the Japanese alphabet selection screen G5), to transmit a response containing the display information to the terminal device 2 of the predetermined golf user U1a.

When the terminal device 2 of the predetermined golf user U1a receives the display information of the Japanese alphabet selection screen G5, the CPU 20 of the terminal device 2 causes the display 25 to display the Japanese alphabet selection screen G5 as illustrated in FIG. 16.

As illustrated in FIG. 16, the Japanese alphabet selection screen G5 has plural Japanese alphabet selection buttons B51 (B51a to B51j), a back button B52 for returning to the previous prefecture selection screen G4, and a close button B53 for closing the Japanese alphabet selection screen G5. The plural Japanese alphabet selection button B51 displays names of columns (vowels, syllables beginning with the k sound, . . . , syllables beginning with the w sound) of the Japanese syllabary or the Japanese alphabet table consisting of 50 sounds. The display area A51 of the Japanese alphabet selection screen G5 displays the name of the prefecture displayed on the clicked prefecture selection button B41 of the prefecture selection screen G4.

Upon receiving a click operation on any one of the plural Japanese alphabet selection buttons B51, the terminal device 2 transmits a view request for the golf course selection screen G6 to the management server 1. This request contains the name of a column of the Japanese alphabet table displayed on the clicked Japanese alphabet selection button B51.

Upon receiving the view request for the golf course selection screen G6, the CPU 50 of the management server 1 accesses the golf course information table TBL12, to perform a process for identifying a golf course that is located in the prefecture selected on the prefecture selection screen G4 and that starts with one of 5 vowels or one of syllables beginning with a selected sound of the Japanese alphabet table selected on the Japanese alphabet selection screen G5.

The Japanese alphabet selection screen G5 of the present embodiment is a screen that displays prompts for selecting one of the names of the columns of the Japanese alphabet table, but the prompts may be for selecting one of the Japanese alphabets (“a”, “i”, “u”, . . . ) or for selecting the Roman alphabets (A, B, C, . . . ). For example, in a case in which the Japanese alphabet selection screen G5 displays prompts for selecting one of the Roman alphabets, the view request for the golf course selection screen G6 may include information indicating the selected Roman alphabet. In this case, the process for identifying a golf course may be one that identifies a golf course that is located in a prefecture selected in the prefecture selection screen G4 and that has a name starting with the selected Roman alphabet.

In the following, description will be given of a process for identifying a golf course according to the present embodiment.

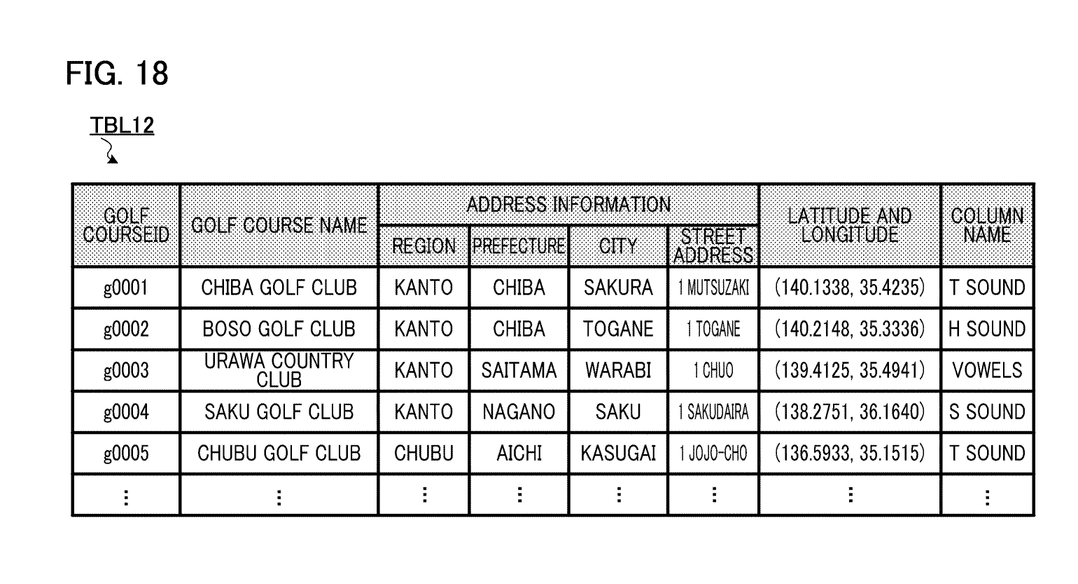

FIG. 18 shows an example data structure of the golf course information table TBL12. The golf course information table TBL12 has plural records. A record contains a golf course ID that uniquely identifies a golf course, a golf course name indicating a name of the golf course, address information indicating an address of each golf course, latitude and longitude information indicating latitude and longitude of each golf course, and a name of a column of the Japanese alphabet table (hereinafter referred to as “column name”). The column name is the name of a column (vowels, syllables beginning with the k sound, syllables beginning with the s sound, . . . , etc.,) including a vowel or consonant of the first letter of the golf course name in hiragana, etc. The record may include any other item.

The CPU 50 of the management server 1 accesses the golf course information table TBL12, to identify a record that includes the prefecture selected on the prefecture selection screen G4 and the column name selected on the Japanese alphabet selection screen G5, the column name specifying a column of vowels or syllables of the Japanese syllabary, thereby to identify a golf course.

The CPU 50 of the management server 1 subsequently obtains a golf course ID, a golf course name, and address information contained in the identified record. The CPU 50 of the management server 1 then generates information necessary for the CPU 20 of the terminal device 2 of the predetermined golf user U1a to cause the display 25 to display the golf course selection screen G6 (i.e., display information of the golf course selection screen G6), to transmit a response containing the display information to the terminal device 2 of the predetermined golf user U1a. The display information includes a golf course name and address information of the identified golf course. In a case in which plural golf courses are identified, the display information includes plural pairs of the golf course name and the address information.

As illustrated in FIG. 17, when the terminal device 2 of the predetermined golf user U1a receives the display information of the golf course selection screen G6, the CPU 20 of the terminal device 2 causes the display 25 to display the golf course selection screen G6.

Also as illustrated in FIG. 17, the golf course selection screen G6 includes one or more golf course selection buttons B61, a back button B62 for returning to the previous Japanese alphabet selection screen G5, and a close button B63 for closing the golf course selection screen G6. Each of the one or more golf course selection buttons B61 displays the golf course name and address information of a corresponding golf course, the golf course name and address information having been included in the display information of the golf course selection screen G6. For example, when a click operation is performed on the Japanese alphabet selection button B51a displaying “vowels” on the Japanese alphabet selection screen G5, the golf course selection screen G6 displays golf course selection buttons B61a to B61c, each of which displays a name and an address of a corresponding one of one or more golf courses that start with a letter of one of the vowels (“a”, “i”, “u”, “e”, and “o”) and that are located in the prefecture selected on the prefecture selection screen G4.

Upon receiving a click operation performed on one of the one or more golf course selection buttons B61, the terminal device 2 transmits a view request for the nearby-route friend selection screen G7 (FIG. 27) to the management server 1. The request contains information for identifying a golf course (hereinafter, on occasion referred to as “selected golf course”, where the selected golf course is an example of a predetermined facility), the golf course having been displayed on the clicked golf course selection button B61. The information for identifying the selected golf course is, for example, a golf course name corresponding to the selected golf course.

Upon receiving the view request for the nearby-route friend selection screen G7, the management server 1 performs a route determining process and a nearby-route user identifying process. The route determining process determines a route for traveling from the home of the predetermined golf user U1a to the selected golf course in coordination with the map information server 4. The nearby-route user identifying process identifies a target user Utg who has a home adjacent to the route determined in the route determining process, from among the target user(s) Utg displayed on the Utg golf friend selection screen G2. In the following, description is given of an example route determining process.

### 3.4. Route Determining Process

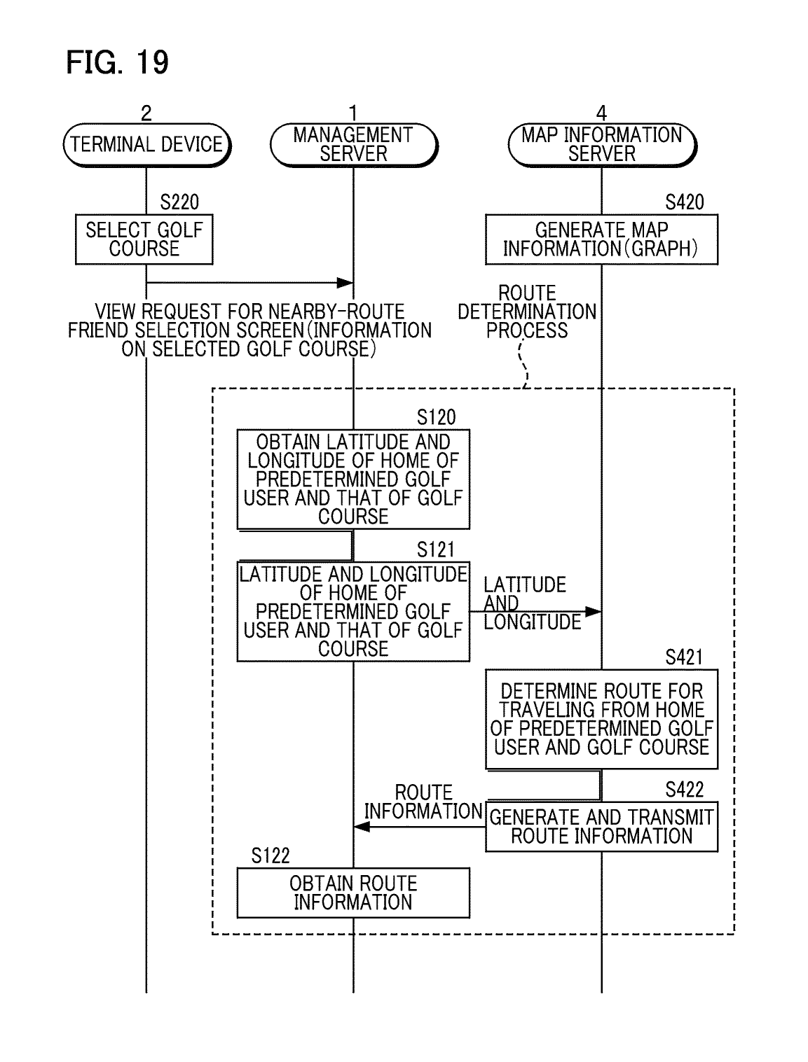

FIG. 19 is an example operation sequence of the route determining process of the service providing system 100.

Before performing the route determining process, the map information server 4, in advance, generates map information in the form of a graph having plural intersections as nodes and roads each connecting two adjacent intersections as links on the basis of information on intersections of the whole country recorded in the intersection information table TBL41 and information on roads recorded in the road information table TBL42 (S420).

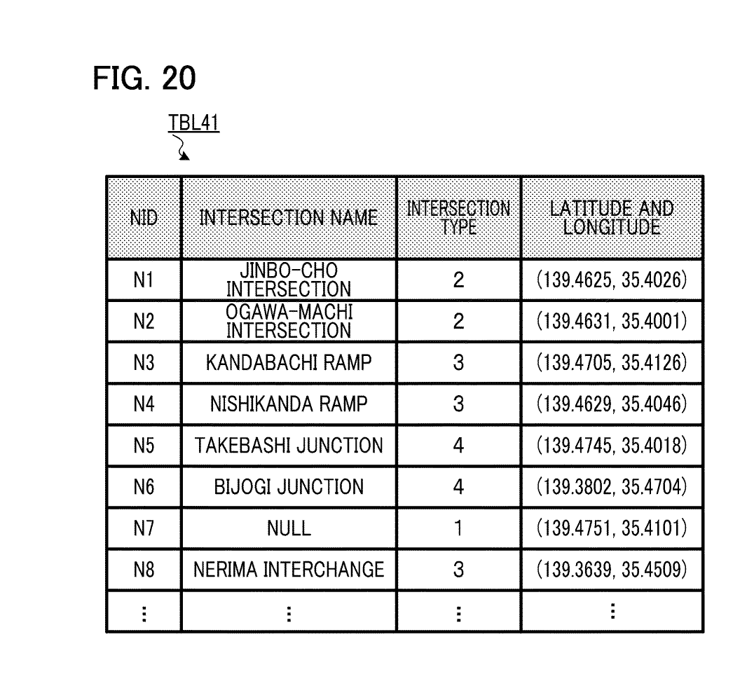

FIG. 20 shows an example data structure of the intersection information table TBL41. The intersection information table TBL41 has plural records. A record contains intersection identification information NID that uniquely identifies one of plural intersections throughout Japan, an intersection name, which is the name of the intersection, an intersection type indicating a type of the intersection, and latitude and longitude information describing a location of the intersection.

Intersections stored in the intersection information table TBL41 of the present embodiment include an intersection where local streets cross one another, an intersection where at least one local street and at least one highway (or freeway) cross one another (e.g., interchange, ramp, etc.,), and an intersection where highways cross one another (e.g., highway junctions, etc.).

The intersection name is left blank where a corresponding intersection is unnamed.

Each record of the intersection information table TBL41 stores one of 4 values indicating different intersection types: type 4 indicating an intersection where highways cross one another, type 3 indicating an intersection where at least one highway and at least local street cross one another, type 2 indicating an intersection where large-scale local streets (e.g., national roads and prefectural roads) cross one another, and type 1 indicating an intersection where small-scale local streets (e.g., city roads (municipal roads)) cross one another, or an intersection where at least one large-scale local street and at least one small-scale local street cross one another.

The intersection information table TBL41 of the present embodiment stores intersections throughout the nation, but may simply store major intersections (e.g., intersections of the above-mentioned intersection types 2 to 4).

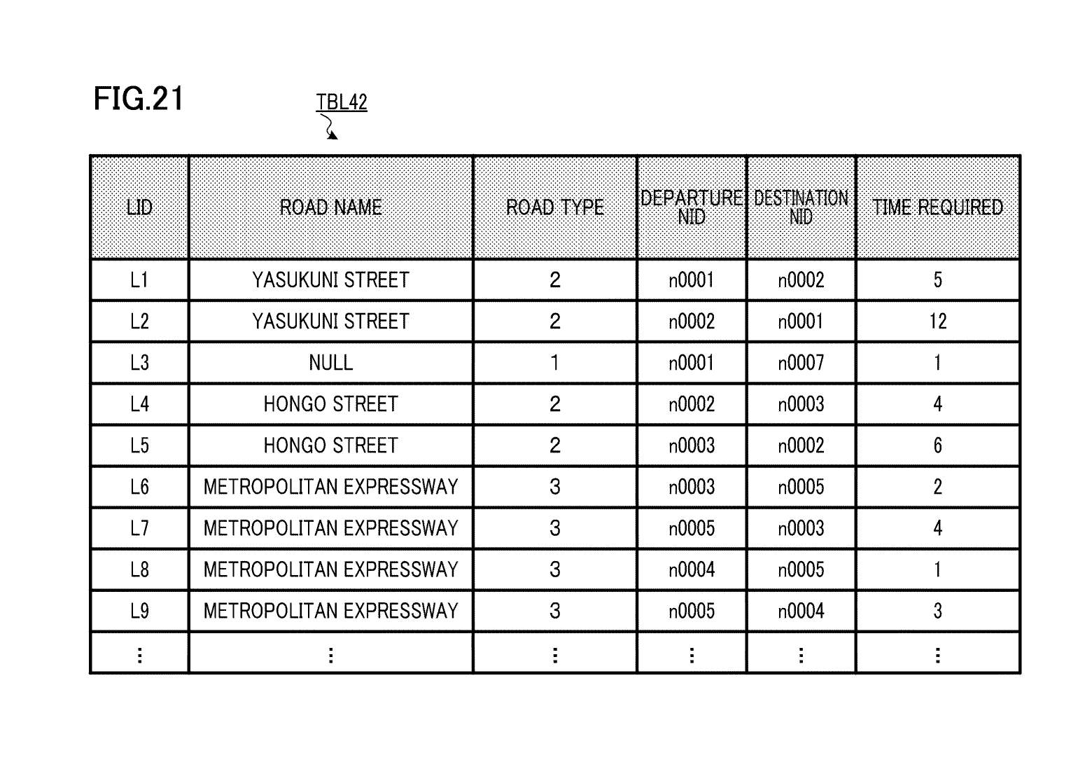

FIG. 21 shows an example data structure of the road information table TBL42. The road information table TBL42 stores information on roads (to be more precise, road segments), each connecting two adjacent intersections of the plural intersections recorded in the intersection information table TBL41, detail of which follows.

The road information table TBL42 has plural records. Each record contains road identification information LID that uniquely identifies a road segment connecting two adjacent intersections, a road name of the road, a road type indicating a type of the road, a departure NID, a destination NID, and time required.

The road name field is left blank where a corresponding road is not named.

Each record stores one of 3 values of different road types: type 3 indicating a highway, type 2 indicating a large-scale local street (e.g., national road or prefectural road), and type 1 indicating a small-scale local street (e.g., city road).

The departure NID stored in each record indicates intersection identification information NID of an intersection which is a starting point (i.e., one of two adjacent intersections) in traveling between the two ends of the road segment of the record, and the destination NID indicates intersection identification information NID of the other intersection, which is the end point of the travel.

A time required stored in each record indicates time required for traveling, using a corresponding road, from an intersection corresponding to the intersection identification information NID stored under the departure NID to an intersection corresponding to the intersection identification information NID stored under the destination NID. The time required may be a fixed value determined in advance, or may vary dynamically in response to a congestion situation, etc., of a corresponding road.

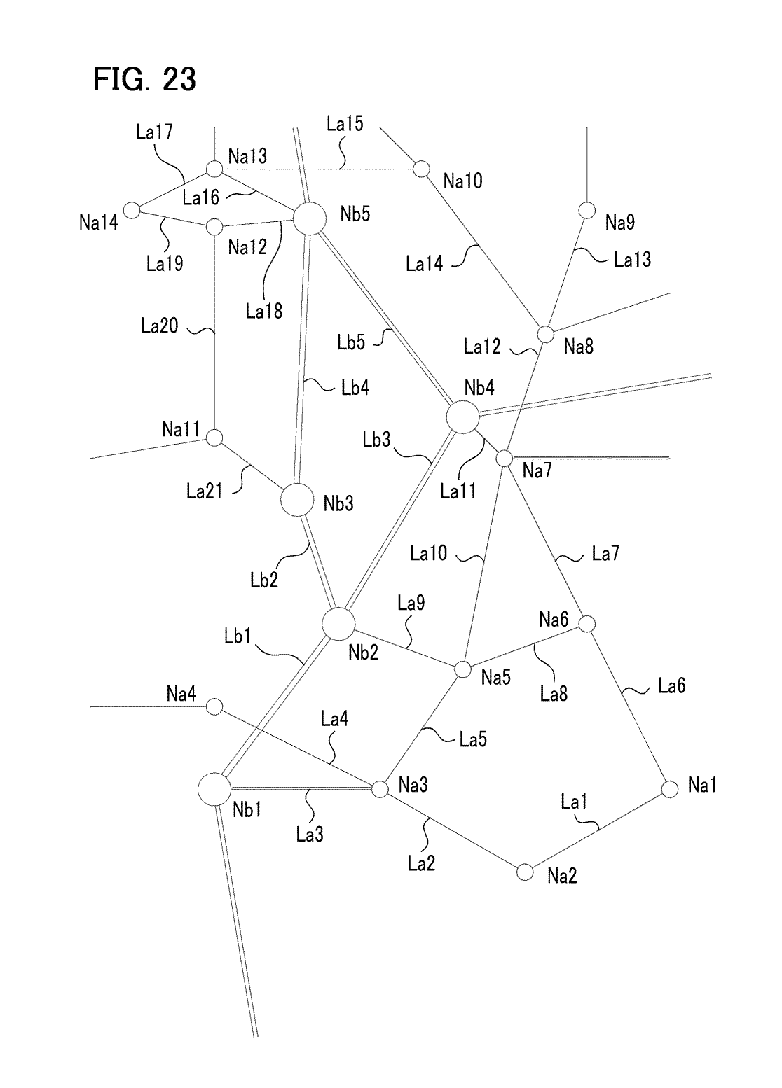

Turning again to FIG. 19, at Step S420, the CPU 60 of the map information server 4 generates information for a graph such as is illustrated in FIG. 23 based on information on intersections recorded in the intersection information table TBL41 and information on roads (road segments) recorded in the road information table TBL42.

In the graph illustrated in FIG. 23, reference symbols Na1 to Na14 and reference symbols Nb1 to Nb5 are nodes representing intersections. Reference symbols La1 to La21 and reference symbol Lb1 to Lb5 are links, each representing a road segment.

In the illustrated example, the links La1 to La21 represented by single lines indicate local streets, and links Lb1 to Lb5 represented by double lines indicate highways. The nodes Na1 to Na14 represented by small circles indicate intersections where local streets cross one another, and the nodes Nb1 to Nb5 represented by large circles are intersections (junctions) where highways cross one another, or intersections (interchanges) where at least one highway and at least one local street cross one another. Although not shown, a time required recorded in the road information table TBL42 is allocated to each link in the form of a cost. Performing a publically known route search calculation using such a graph enables the finding of a route (i.e., combination of nodes and links representing the route) at a minimum cost (i.e., time required), from among different routes for traveling from one node to another node.

It is of note that the graph shown in FIG. 23 is only a schematic diagram for facilitating ready understanding of the information generated by the map information server 4. Accordingly, the generation of such a graph as an explicit representation is not necessarily required for the CPU 60 of the map information server 4. In other words, the CPU 60 of the map information server 4 may simply generate information alone when providing a graph.

The information in the form of a graph is information for a graph provided in accordance with a publically known method (publically known data structure). The information in the form of a graph may be, for example, an adjacency matrix representing, with a matrix, adjacency relationships among nodes of the graph and a cost (time required) allocated to links respectively connecting nodes, or may alternatively be an adjacency list showing a list of adjacent nodes having direct traveling relationships. Information for a graph (and the like) is stored in the storage device 63 of the map information server 4.

An alternative configuration may be the CPU 60 of the map information server 4 performing a route search calculation by referring to the intersection information table TBL41 and the road information table TBL42, as required, without generating the information in the form of a graph.

As shown in FIG. 19, when a click operation on one of the plural golf course selection buttons B61 is received by the terminal device 2 of the predetermined golf user U1a on the golf course selection screen G6 displayed thereon (S220), the terminal device 2 transmits a view request for the nearby-route friend selection screen G7 to the management server 1. Upon receiving the view request, the management server 1 initiates the route determining process.

Specifically, upon receiving the view request for the nearby-route friend selection screen G7, the CPU 50 of the management server 1 obtains, on the basis of information, contained in the view request, for identifying the selected golf course, latitude and longitude information corresponding to the selected golf course from the golf course information table TBL12 (FIG. 18) and latitude and longitude information of the home of the predetermined golf user U1a from the golf user information table TBL11 (S120).

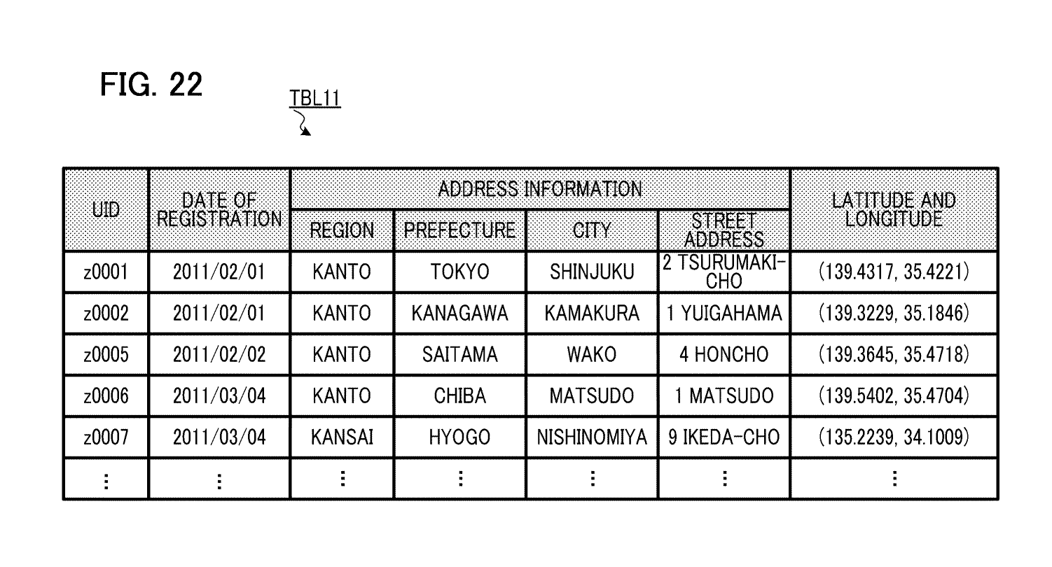

FIG. 22 shows an example data structure of the golf user information table TBL11. The golf user information table TBL11 has plural records. Each record contains identification information UID for uniquely identifying a golf user U1, a registered date when the golf user U1 is registered at the management server 1, address information indicating an address of the home of the golf user U1, and latitude and longitude information of the address of the home of the golf user U1. A golf user U1 is able to register or update, at the management server 1, the address information and latitude and longitude information of the golf user U1. Each record may contain another item.

The identification information UID of the golf user U1 of the present embodiment is identical to that of the SNS user U2. The identification information UID of the SNS user U2, however, does not necessarily have to be identical to that of the golf user U1 (i.e., they may be different from each other). In this case, the identification information of the SNS user U2 and that of the golf user U1 may be stored in association with each other in a corresponding record of the golf user information table TBL11.

The golf user information table TBL11 may store another information item in addition to the above-mentioned items, such as a hyperlink destination of the profile image Pg of the golf user U1. The items of information to be stored in the golf user information table TBL11 must include the identification information UID of the golf user U1 and the latitude and longitude information, but other items of information may be omitted. Additionally, the golf user information table TBL11 may be a relational database having associated plural tables containing key information (e.g., identification information UID).

The CPU 50 of the management server 1 accesses the golf user information table TBL11 to obtain the latitude and longitude information of the home of the predetermined golf user U1a by identifying a record containing the identification information UID of the predetermined golf user U1a and obtaining the latitude and longitude information stored in the identified record.

The CPU 50 of the management server 1 accesses the golf course information table TBL12 to obtain the latitude and longitude information of the selected golf course by identifying a record that contains the golf course ID of the selected golf course (or a record that contains the golf course name of the selected golf course, the golf course name being included in the view request for the nearby-route friend selection screen G7) and identifying the latitude and longitude information stored in the identified record.

The CPU 50 of the management server 1 then controls transmission of the latitude and longitude information of the home of the predetermined golf user U1a and that of the selected golf course obtained at Step S120 to the map information server 4 (S121).

Upon receiving the latitude and longitude information of the home of the predetermined golf user U1a and that of the selected golf course, the CPU 60 of the map information server 4 determines a route for traveling from the home of the predetermined golf user U1a to the selected golf course (S421).

Specifically, the CPU 60 of the map information server 4 identifies an intersection closest from the home of the predetermined golf user U1a and an intersection closest from the selected golf course, out of the intersections stored in the intersection information table TBL41. The CPU 60 of the map information server 4 determines a route that requires a minimum time from among different routes for traveling between the identified two intersections.

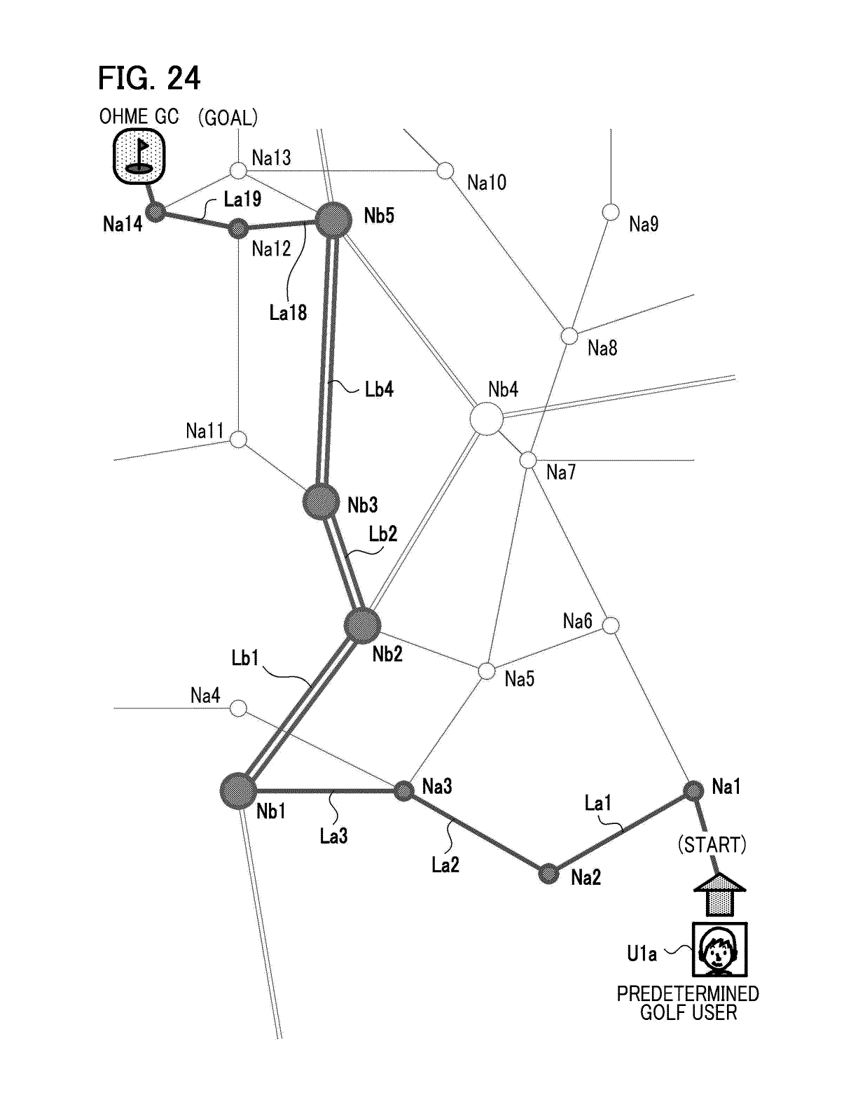

Assumed is a case in which, as shown in the graph illustrated in FIG. 23, the home of the predetermined golf user U1a is located adjacent to an intersection denoted by the node Na1 and in which the selected golf course is located adjacent to an intersection denoted by the node Na14. The CPU 60 of the map information server 4 performs a process at Step S421, to determine a route requiring the minimum time. Also it is assumed that the resultant route selected by the CPU 60 is formed by intersections represented by the nodes Na1, Na2, Na3, Nb1, Nb2, Nb3, Nb5, Na12, and Na14 (i.e. a route formed by connecting road segments represented by the links La1, La2, La3, Lb1, Lb2, Lb4, La18, and La19) as shown in FIG. 24.

The above-mentioned process performed by the CPU 60 of the map information server 4 to determine a route at Step S421 is merely an example. The map information server 4 may use a publically known route search method if the server 4 is able to determine a route for traveling from the home of the predetermined golf user U1a to the selected golf course.

The CPU 60 of the map information server 4 controls transmission of route information indicating the route determined at Step S421 to the management server 1 (S422). The route information includes one or more pieces of latitude and longitude information of intersections on the route, as determined in the process at Step S421, for traveling from the home of the predetermined golf user U1a to the selected golf course, where the plural pieces of latitude and longitude information have been arranged in the order of the intersections being passed through in traveling the route. In the example shown in FIG. 24, the intersections on the route include those represented by the nodes Na1, Na2, Na3, Nb1, Nb2, Nb3, Nb5, Na12, and Na14.

Upon receiving the route information, the CPU 50 of the management server 1 obtains the received route information (S122), thereby to end the route determining process.

### 3.5. Nearby-Route User Identifying Process

The management server 1 performs, in coordination with the map information server 4, a nearby-route user identifying process for identifying a target user Utg who has a home adjacent to the route determined in the route determining process. In the following, description will be given of an example of the nearby-route user identifying process.

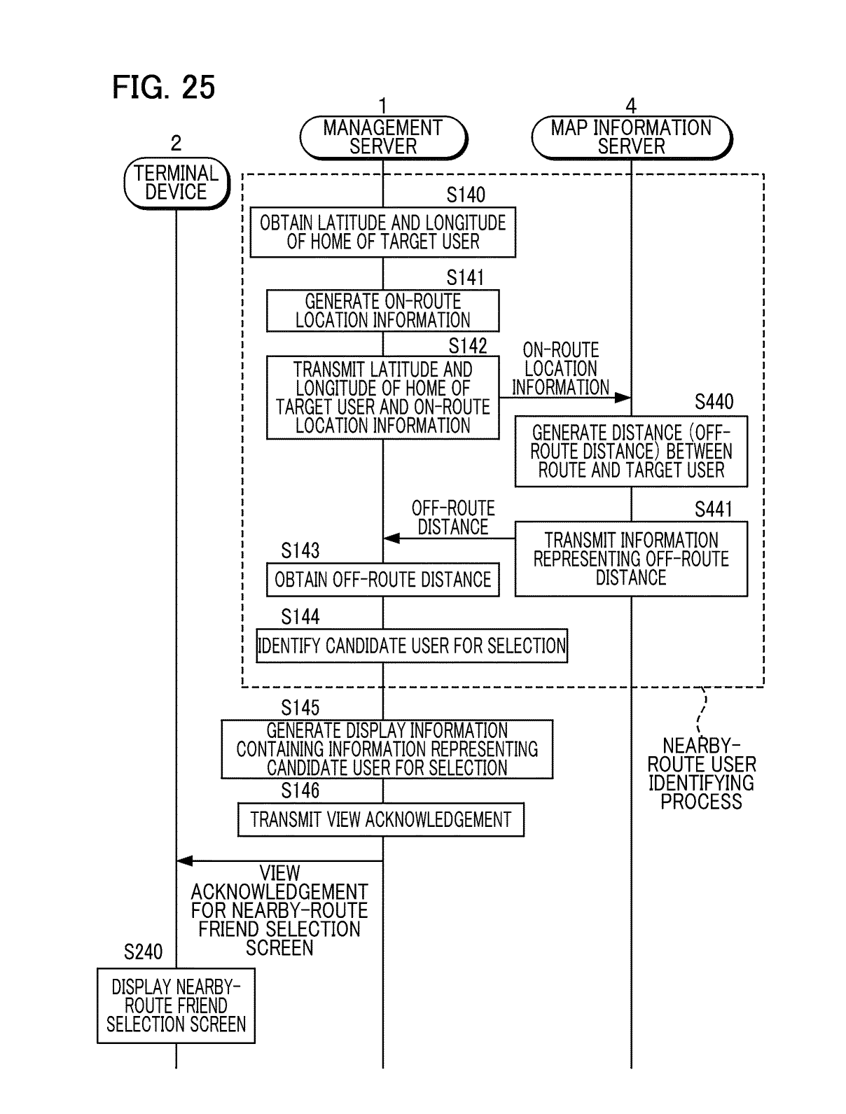

FIG. 25 is an example operation sequence of the nearby-route user identifying process in the service providing system 100.

The CPU 50 of the management server 1 obtains latitude and longitude information of the home(s) of the target user(s) Utg of the predetermined golf user U1a from the golf user information table TBL11 (FIG. 22) (S140). Specifically, the CPU 50 of the management server 1 accesses the golf user information table TBL11, to identify a record having the identification information UID of the concerned target user Utg to obtain latitude and longitude information contained in the identified record, thereby to obtain latitude and longitude information of the home of the concerned target user Utg.

The CPU 50 of the management server 1 generates on-route location information including one or more pieces of latitude and longitude information contained in the route information obtained at Step S122 of FIG. 19, and the latitude and longitude information of the home of the predetermined golf user U1a obtained at Step S120, and the latitude and longitude information of the selected golf course obtained at Step S120 (S141).

The CPU 50 of the management server 1 controls transmission of the on-route location information generated at Step S141 and the latitude and longitude information of the home(s) of the target user(s) Utg generated at Step S140 to the map information server 4 (S142).

When the map information server 4 receives the on-route location information and the latitude and longitude information of the home(s) of the target user(s) Utg, the CPU 60 of the map information server 4 calculates, for the target user(s) Utg, an off-route distance which is a distance between the home(s) of the target user(s) Utg and the route determined at Step S421 on the basis of the received information (S440). The off-route distance is a distance between a route-deviation point (route-departure point), described later, and the home of the target user(s) Utg.

The process performed at Step S440 for calculating the off-route distance is as follows.

The CPU 60 of the map information server 4 first calculates a distance between the home of the target user Utg and each of the spots on the route (i.e., intersections on the route, the home of the predetermined golf user U1a, and the selected golf course, hereinafter on occasion referred to as “on-route spots”), the spots corresponding to pieces of latitude and longitude information contained in the on-route location information. Specifically, the CPU 60 of the map information server 4 calculates a first distance between the latitude and longitude information of the home of the predetermined golf user U1a obtained at Step S120 and that of the home of a concerned target user Utg, a second distance which is a distance between the latitude and longitude information of the selected golf course obtained at Step S120 and that of the home of the target user Utg, and a third distance which is a distance between each of intersections corresponding to respective pieces of latitude and longitude information contained in the route information obtained at Step S122 and that of the home of the target user Utg.

The CPU 60 of the map information server 4 identifies, as an off-route distance, one with the minimum value of the resultant calculated distances. Specifically, the CPU 60 of the map information server 4 selects one with the minimum distance from among the first distance, the second distance, and the third distance as the off-route distance.

The CPU 60 of the map information server 4 identifies the off-route distance, thereby to identify an on-route spot to which a distance from the home of the target user Utg is the closest, from among plural on-route spots indicated by the on-route location information. The identified on-route spot is a route deviation point for the target user Utg (i.e., a spot where the route is diverged from in order to stop at the home of the target user Utg). Thus, the off-route distance is a distance between the route deviation point of the target user Utg and the home of the target user Utg.

In a case in which there are plural target users Utg of the predetermined golf user U1a, the CPU 60 of the map information server 4 performs the process at Step S440 for the plural target users Utg.

The CPU 60 of the map information server 4 controls transmission of information indicating the off-route distance generated at Step S440 to the management server 1 (S441).

The CPU 50 of the management server 1 obtains the received information indicating the off-route distance transmitted from the map information server 4 (S143).

The CPU 50 of the management server 1 determines whether the off-route distance obtained at Step S143, i.e., the distance between the home of the target user Utg and the route deviation point for the target user Utg, is equal to or shorter than a predetermined distance (in the following, the predetermined distance is assumed as being 5 km). In a case in which a result of the determination is affirmative, the CPU 50 identifies a corresponding target user Utg as a candidate user for selection Use1 of the predetermined golf user U1a (S144).

The nearby-route user identifying process then ends.

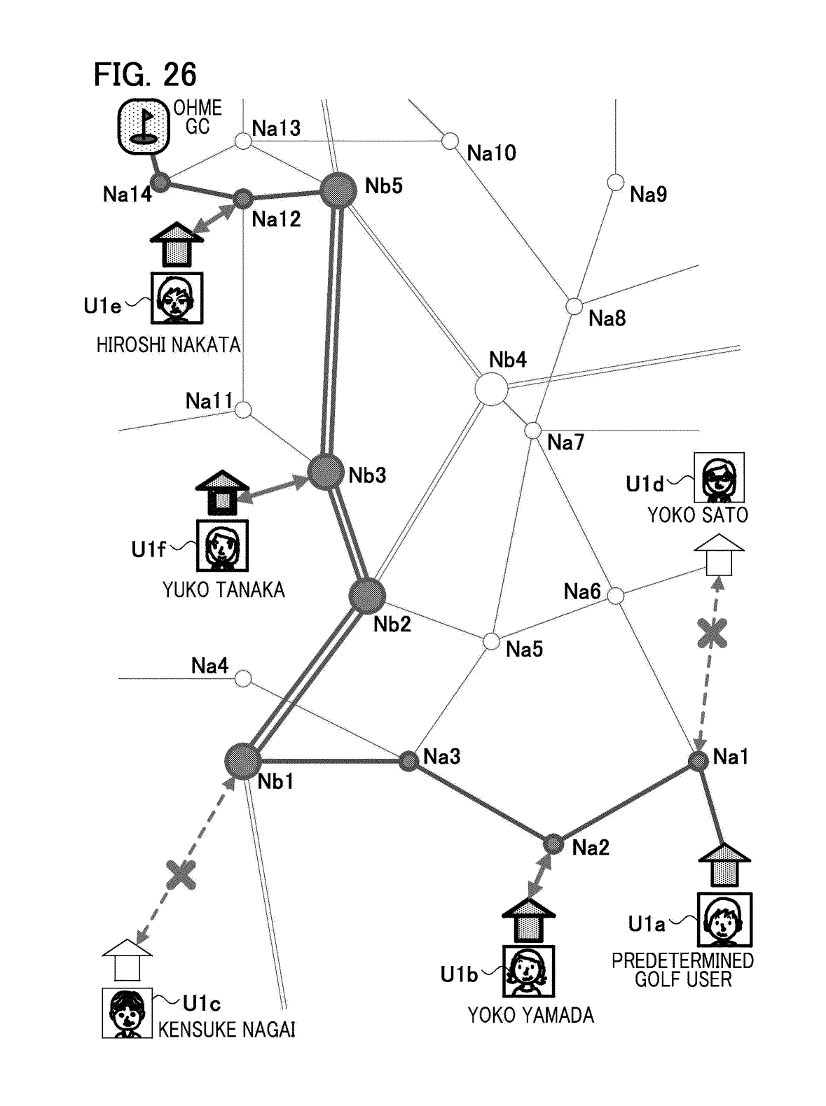

FIG. 26 is a schematic diagram illustrating whether to select each of the golf users U1b to U1f, who are each the target user Utg of the predetermined golf users U1a, as the candidate user for selection Use1, in a case in which the route as shown in FIG. 24 has been decided.

In the example shown in FIG. 26, the off-route distance between the home of the golf user U1b and the route deviation point, represented by the node Na2, of the golf user U1b is 5 km or shorter. The off-route distance between the home of the golf user U1c and the route deviation point, represented by the node Nb1, of the golf user U1c is greater than 5 km; the off-route distance between the home of the golf user U1d and the route deviation point, represented by the node Na1, of the golf user U1d is greater than 5 km; the off-route distance between the home of the golf user U1e and the route deviation point, represented by the node Na12, of the golf user U1e, is 5 km or shorter; and the off-route distance between the home of the golf user U1f and the route deviation point, represented by the node Nb3, of the golf user U1f is 5 km or shorter. Accordingly, in this example, the golf users U1b, U1e, and U1f, from among the golf users U1b to U1f, will be identified as candidate users for selection Use1.

The CPU 50 of the management server 1 subsequently generates information necessary for the CPU 20 of the terminal device 2 of the predetermined golf user U1a to cause the display 25 to display the nearby-route friend selection screen G7, i.e., display information of the nearby-route friend selection screen G7 (S145). The display information of the nearby-route friend selection screen G7 includes information representing one or more candidate users for selection Use1 identified at Step S144.

Specifically, the CPU 50 of the management server 1 extracts, for each of the one or more candidate users for selection Use1, hyperlink information indicating an address where profile image Pg data of the candidate user for selection Use1 is stored and the name of the candidate user for selection Use1, from one or more pieces of individual information (those of the one or more direct SNS friends Uf of the predetermined golf user U1a) obtained at Step S102 (FIG. 7) and from one or more pieces of individual information (those of the one or more indirect SNS friends Uff, if any, of the predetermined golf user U1a) obtained at Step S108. The CPU 50 of the management server 1 generates display information of the nearby-route friend selection screen G7 containing the extracted hyperlink information and name information for each of the one or more candidate users for selection Use1.

Subsequently, the CPU 50 of the management server 1 controls transmission of a nearby-route friend selection screen view acknowledgement containing the display information of the nearby-route friend selection screen G7 generated at Step S145, to the terminal device 2 of the predetermined golf user U1a (S146).

When the terminal device 2 of the predetermined golf user U1a receives the nearby-route friend selection screen view acknowledgement, the CPU 20 of the terminal device 2 displays the nearby-route friend selection screen G7 on the display 25 (S240).

The CPU 50 of the management server 1 performs Steps S120 and S140, thereby serving as the location information obtainer 13, and performs Steps S121 and S122, thereby serving as the route information obtainer 14, performs Steps S141, S142, and S143, thereby serving as the off-route distance obtainer 15, and performs Step S144, thereby serving as the candidate user for selection identifier 17, and performs Step S145, thereby serving as the display information generator 18, and performs Step S146, thereby serving as the transmission controller 181.

The CPU 60 of the map information server 4 performs Step S421, thereby serving as the route determiner 41, and performs Step S440, thereby serving as the distance calculator 42.

The management server 1 thus determines a route having the minimum time required, in coordination with the map information server 4, from among different routes for traveling from the home of the predetermined golf user U1a to the selected golf course. The predetermined golf user U1a is therefore freed from the time and trouble of determining by oneself a route for traveling to the selected golf course, and is also able to travel to the selected golf course requiring a minimum traveling time.

Moreover, the management server 1 identifies, in coordination with the map information server 4, the target user Utg who has a home adjacent to the route for traveling from the home of the predetermined golf user U1a to the selected golf course, and therefore, easy selection of a member for invitation to golf is enabled.

### 3.6. Screen for Selecting a Golf User Adjacent to Route

When the terminal device 2 of the predetermined golf user U1a receives the display information of the nearby-route friend selection screen G7, the CPU 20 of the terminal device 2 causes the display 25 to display the nearby-route friend selection screen G7 as illustrated in FIG. 27 as an example.

As shown in FIG. 27, the nearby-route friend selection screen G7 has a map display button B71, a message transmission button B73, a back button B72 for returning to the previous golf course selection screen G6, and a close button B74 for closing the nearby-route friend selection screen G7. The display area A71 of the nearby-route friend selection screen G7 displays information representing candidate users for selection Use1 of the predetermined golf user U1a (the profile images Pg and names of the candidate user for selection Use1) in the form of a list, and also displays check boxes CB71 for selecting one or more of the candidate users for selection Use1, such that each check box CB71 corresponds one to one with corresponding information representing one of the candidate users for selection Use1.

In the example shown in FIG. 27, information representing the three golf users U1 (U1b, U1e, and U1f) (the profile images Pg [U1b], Pg[U1e], Pg[U1f] of the golf users U1b, U1e, and U1f, respectively, and names thereof) are displayed, the three golf users U1 (U1b, U1e, and U1f) being the candidate users for selection Use1 of the predetermined golf user U1a identified in the nearby-route user identifying process.

In the nearby-route friend selection screen G7 illustrated in FIG. 27, when a click operation is performed on the message transmission button B73 with at least one of the candidate users for selection Use1 having been selected (i.e., a state of at least one of the check boxes CB71 having been checked), a process for inviting the selected candidate user for selection Use1 for golf is performed. The process for providing an invitation to play golf is the same as the process carried out when a click operation is performed on the message transmission button B23 of the golf friend selection screen G2 (FIG. 13).

Furthermore, in the nearby-route friend selection screen G7 shown in FIG. 27, when a click operation is performed on the map display button B71 with at least one of the candidate users for selection Use1 having been selected, a route for traveling from the home of the predetermined golf user U1a via the home of the selected candidate user for selection Use1 to the selected golf course is displayed.

Assuming a case such as that shown in FIG. 27, a click operation is performed on the map display button B71 of the nearby-route friend selection screen G7 with the golf user U1e and the golf user U1f having been selected. The CPU 50 of the management server 1 obtains the latitude and longitude information of the home of the predetermined golf user U1a, the latitude and longitude information of the selected golf course, and pieces of latitude and longitude information of the homes of the candidate users for selection Use1 (golf user U1e and U1f) selected on the nearby-route friend selection screen G7, for transmission to the map information server 4. The CPU 60 of the map information server 4 determines, on the basis of the transmitted pieces of latitude and longitude information, a route requiring a minimum time from among different routes for traveling from the home of the predetermined golf user U1a to the selected golf course via the homes of the candidate users for selection Use1 selected on the nearby-route friend selection screen G7, to control transmission, to the management server 1, of information on the determined route (hereinafter referred as “second route information” in order to distinguish the second route information from the route information (first route information) determined at Step S421).

The CPU 50 of the management server 1 generates display information on the basis of the second route information transmitted from the map information server 4, such that the display information contains a map representing a route from the home of the predetermined golf user U1a via the home of the golf user U1f and the home of the golf user U1e to the selected golf course, to control transmission of the display information to the terminal device 2 of the predetermined golf user U1a.

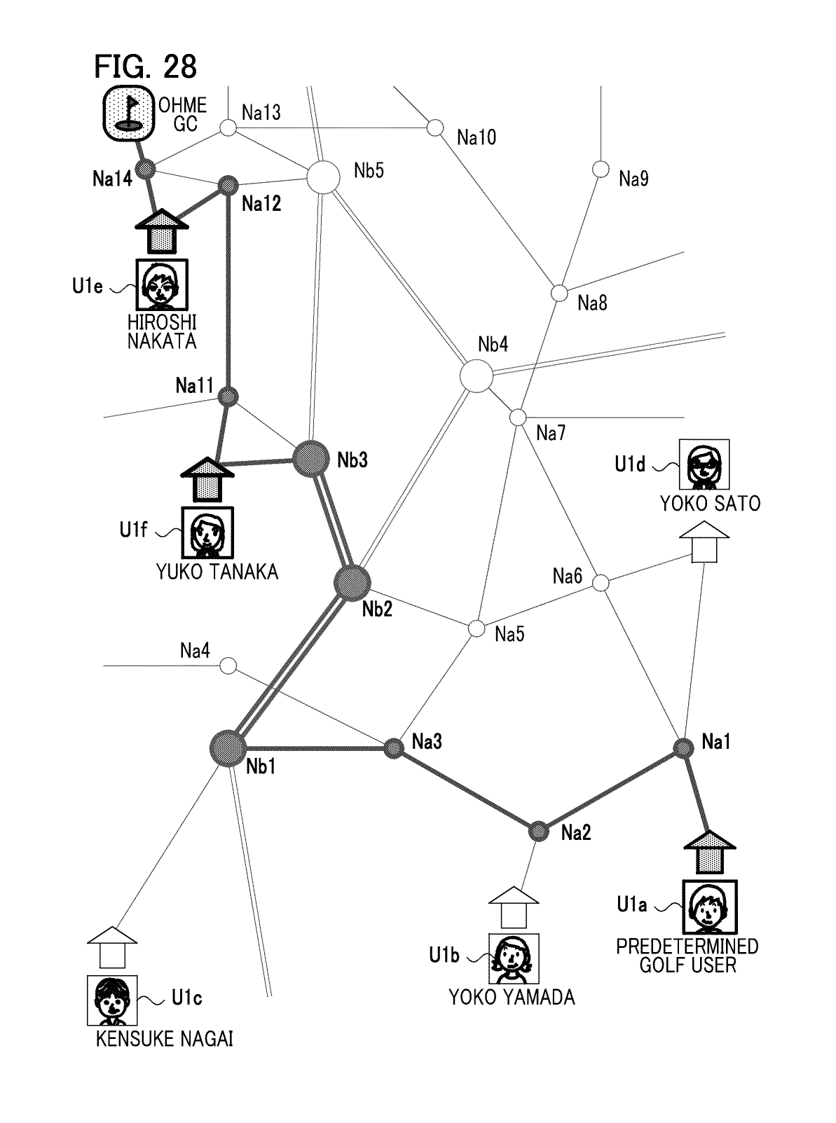

The resulting map displayed on the display 25 of the terminal device 2 of the predetermined golf user U1a is, such as shown in FIG. 28, a map representing a route from the home of the predetermined golf user U1a via the home of the golf user U1f and the home of the golf user U1e, to the selected golf course. As shown in FIG. 28, a route (route specified by the second route information) displayed in a case in which a click operation is performed on the map display button B71 of the nearby-route friend selection screen G7 is not always the same as a route (route specified by the first route information) determined in the route determining process of FIG. 24 or FIG. 26.

Thus, the predetermined golf user U1a, after actually selecting users to invite for golf, is able to confirm a revised route from the home to the selected golf course, and thus, the predetermined golf user U1a is able to travel to the selected golf course at a minimum traveling time.

### 3.7. Address Registration Screen

When a click operation is performed on the profile image Pg [U1a] of the predetermined golf user U1a on the golf friend list screen G1 illustrated in FIG. 6, the terminal device 2 transmits a view-request for the address registration screen G8 to the management server 1. The management server 1, upon receiving the view request for the address registration screen G8, the CPU 50 of the management server 1 generates display information of the address registration screen G8 which is information necessary for the CPU 20 of the terminal device 2 of the predetermined golf user U1a to cause the display 25 to display the address registration screen G8, to transmit a response containing the display information to the terminal device 2 of the predetermined golf user U1a.

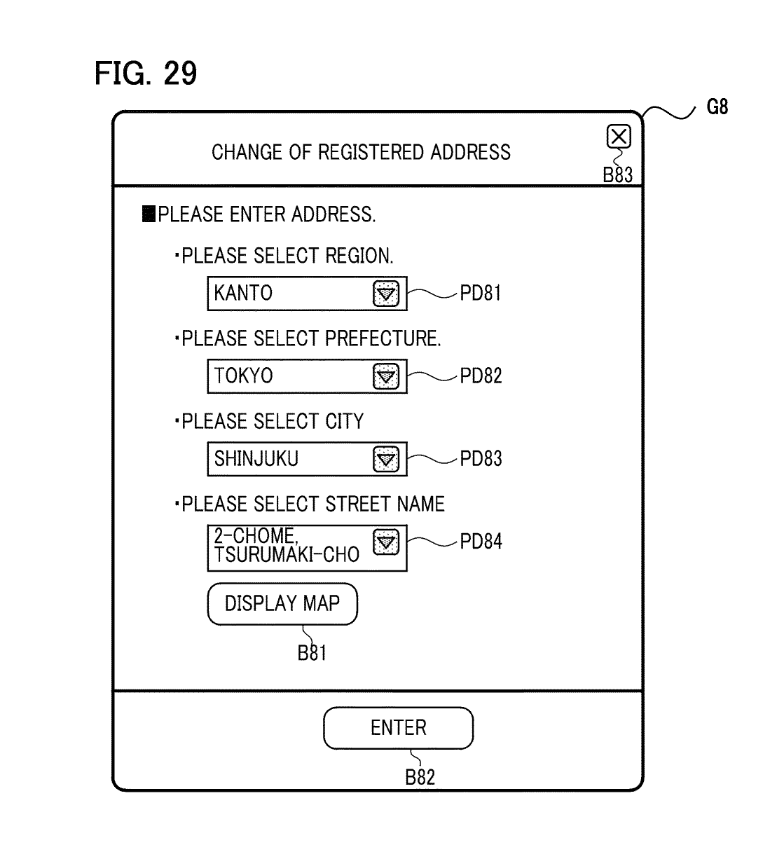

When the terminal device 2 of the predetermined golf user U1a receives the display information of the address registration screen G8, the CPU 20 of the terminal device 2 causes the display 25 to display the address registration screen G8, such as shown in FIG. 29, for example with a pop-up. The present embodiment displays the address registration screen G8 with a pop-up, but an alternative embodiment may display the address registration screen G8 by switching thereto from the golf friend list screen G1. Moreover, the terminal device 2 of the present embodiment transmits the view request for the address registration screen G8 to the management server 1 when a click operation is performed on the profile image Pg [U1a] of the predetermined golf user U1a. Alternatively, the terminal device 2 may transmit a view request for the profile information of the predetermined golf user U1a to the management server 1 when a click operation is performed on the profile image Pg [U1a] of the predetermined golf user U1a, such that the terminal device 2 displays the profile information of the predetermined golf user U1a in a profile information display screen (not shown) which displays an address registration button (not shown) for causing the address registration screen G8 to be displayed. In this case, when a click operation is performed on the address registration button, the terminal device 2 transmits a request for displaying the address registration screen G8 to the management server 1. The CPU 50 of the management server 1 then generates display information of the address registration screen G8, to transmit a response containing the display information to the terminal device 2.

As illustrated in FIG. 29, the address registration screen G8 includes pull-down menus PD81 to PD84, a map display button B81, an enter button B82, and a close button B83 for closing the address registration screen G8. The predetermined golf user U1a uses pull-down menus PD81 to PD84, to input the address of the home of the predetermined golf user U1a. When a click operation is performed on the map display button B81, the display 25 of the terminal device 2 of the predetermined golf user U1a displays a screen representing a map (not shown). The predetermined golf user U1a can use the screen representing the map, to input the address of the home of the predetermined golf user U1a. Alternatively, the address may be input through the same type of screen as the above-mentioned region selection screen G3, prefecture selection screen G4, etc.

When a click operation is performed on the enter button B82 with the address of the home having been input, the terminal device 2 of the predetermined golf user U1a transmits information containing the input address information to the management server 1.

The management server 1, upon receiving the address information of the home of the predetermined golf user U1a, with the address information having been transmitted from the terminal device 2 of the predetermined golf user U1a, transmits to the map information server 4a request containing a parameter indicative of an inquiry for latitude and longitude information of the address information.

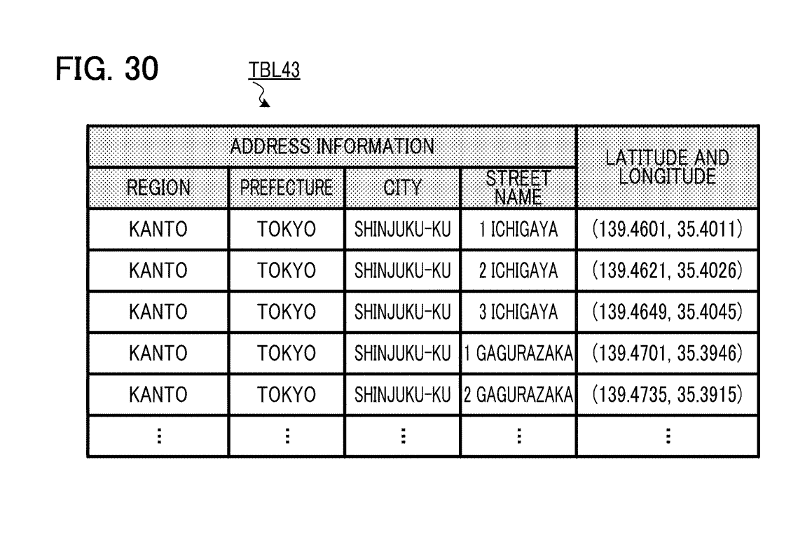

The map information server 4, upon receiving the request, refers to the address information table TBL43 shown in FIG. 30, to obtain latitude and longitude information that corresponds to the address information contained in the parameter, and transmits a response containing the obtained latitude and longitude information to the management server 1.

FIG. 30 shows an example data structure of the address information table TBL43. The address information table TBL43 has plural records. Each record includes address information and latitude and longitude information. Each record may include any other item, such as a zip code as the address information.

The management server 1 receiving a response from the map information server 4, the CPU 50 of the management server 1 accesses the golf user information table TBL11 (FIG. 22), to identify a record having the identification information UID of the predetermined golf user U1a.

The CPU 50 of the management server 1 then stores into the identified record the address information received from the terminal device 2 of the predetermined golf user U1a and the latitude and longitude information received from the map information server 4.

### Modifications

The present invention is not limited to the embodiments above, and various modifications as described below can be adopted. Needless to state, one or more of the modifications and one or more of the embodiments can be combined, as appropriate.

### Modification 1

In the above-mentioned embodiment, the off-route distance obtainer 15 (the CPU 50 of the management server 1) uses all of one or more pieces of latitude and longitude information contained in the route information generated in the route determining process as the on-route location information (the above-mentioned Step S141 (FIG. 25)), but may use only a part of the one or more pieces of latitude and longitude information contained in the route information as the on-route location information.

For example, a specific intersection (a non-limiting example of a specific transit candidate point) which has a specific attribute may be excluded from among one or more intersections corresponding to one or more pieces of latitude and longitude information contained in the route information, such that location information of target intersections (a non-limiting example of a target transit point) corresponding to the remaining intersections alone may be included in the on-route location information. More specifically, the target intersections may be limited to the type 1 or 2 intersections, and latitude and longitude information of only the target intersections may be included in the on-route location information, on the basis of which the nearby-route user identifying process is carried out. Intersections where highways cross one another (junctions of the intersection type 4) and intersections where one or more highways and one or more local streets cross one another (interchanges of the intersection type 3) are regarded as specific intersections, and the nearby-route user identifying process uses the on-route location information other than the latitude and longitude information of the specific intersections.

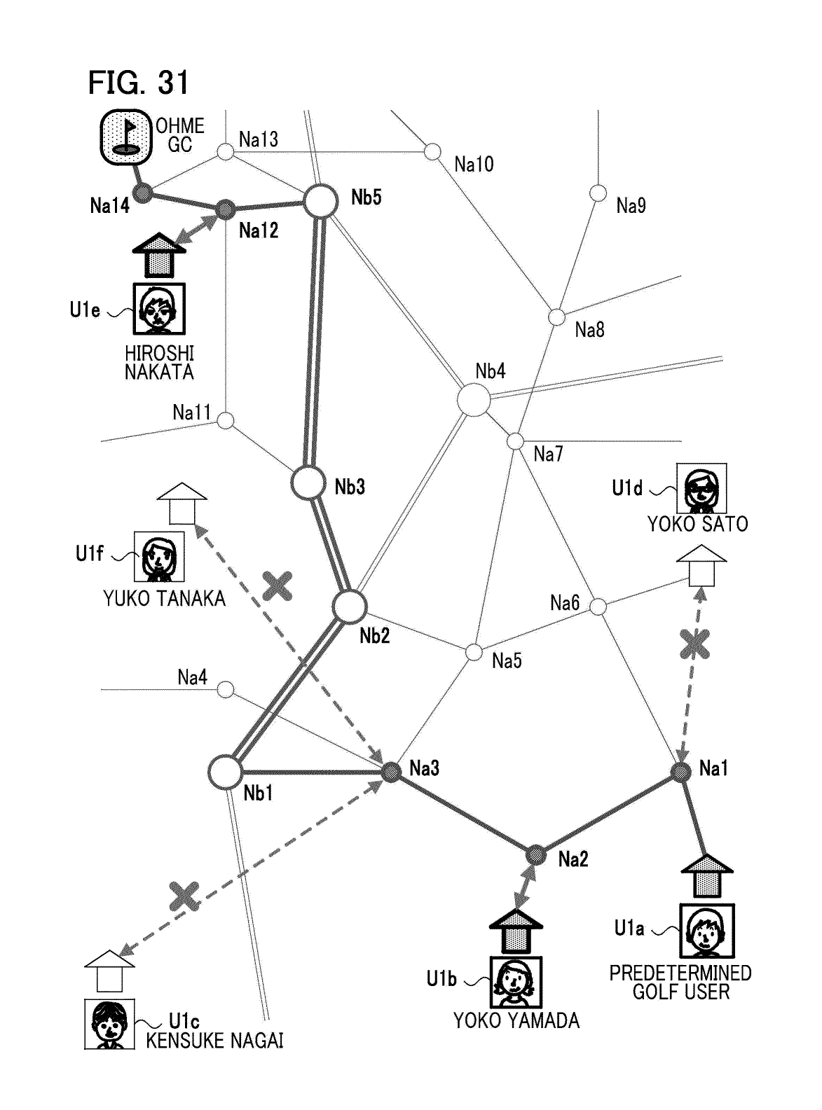

FIG. 31 is a schematic diagram illustrating candidate users for selection Use1 identified in the nearby-route user identifying process according to the present modification. In this diagram, map information and locations of the home(s) of the target user(s) Utg are the same as those shown in FIG. 26, and the nearby-route user identifying process uses latitude and longitude information of type 1 or 2 target intersections as the on-route location information instead of using all pieces of latitude and longitude information contained in the route information as the on-route location information.

In the example shown in FIG. 31, from among the nodes Na1, Na2, Na3, Nb1, Nb2, Nb3, Nb5, Na12, and Na14 representing intersections corresponding to the route information, latitude and longitude information of specific intersection represented by the nodes Nb1, Nb2, Nb3, and Nb5 (nodes represented by open circles in FIG. 31) are excluded from the on-route location information. Consequently, the route deviation point of the golf user U1f is an intersection represented by the node Nb3 in the example of FIG. 26, while in the example of FIG. 31 it is the intersection represented by the node Na3. As a result, golf user U1f is one of the candidate users for selection Use1 in the example of FIG. 26 but is no longer a candidate user for selection Use1 in the example of FIG. 31. In the example shown in FIG. 26, since the predetermined golf user U1a needs to exit from the highway to local streets at the node Nb3 representing an interchange, to stop at the home of the golf user U1f, a time required for traveling is considerably increased even if, supposedly, the home of the golf user U1f is located adjacent to the intersection (interchange) represented by the node Nb3. If the predetermined golf user U1a travels via the home of the golf user U1f to the selected golf course, the predetermined golf user U1a will have to utilize local streets from the home of the golf user U1f to the selected golf course, as shown in FIG. 28. In this case, the distance of using highway is decreased in comparison with the shortest route shown in FIG. 26. As a result, compared with a case where the predetermined golf user U1a does not stop by the home of the golf user U1f, time required for traveling increases substantially.

In contrast, in the present modification, since latitude and longitude information of type 1 or 2 target intersections (i.e., intersections where local streets cross with one another) alone is included in the on-route location information, there is no need to exit a highway off to the local street while traveling the highway. As a result, according to the modification, the increase in time required for traveling via the home of the candidate users for selection Use1 can be suppressed to be less than that in the embodiment above.

### Modification 2

In the embodiment and modification above, the off-route distance obtainer 15 (the CPU 50 of the management server 1) uses plural pieces of latitude and longitude information including a part or all of the one or more pieces of latitude and longitude information contained in the route information generated in the route determining process, the latitude and longitude information of the home of the predetermined golf user U1a, and the latitude and longitude information of the selected golf course, as the on-route location information (the above Step S141 (FIG. 25)), but may use only the latitude and longitude information of the home of the predetermined golf user U1a and the latitude and longitude information of the selected golf course as the on-route location information.

Specifically, in traveling from the home of the predetermined golf user U1a to the selected golf course, the target user(s) Utg whose home(s) are within a predetermined distance (e.g., 10 km or shorter) from the home of the predetermined golf user U1a and the target user(s) Utg whose home(s) is within the predetermined distance from the selected golf course may be a candidate user for selection Use1.

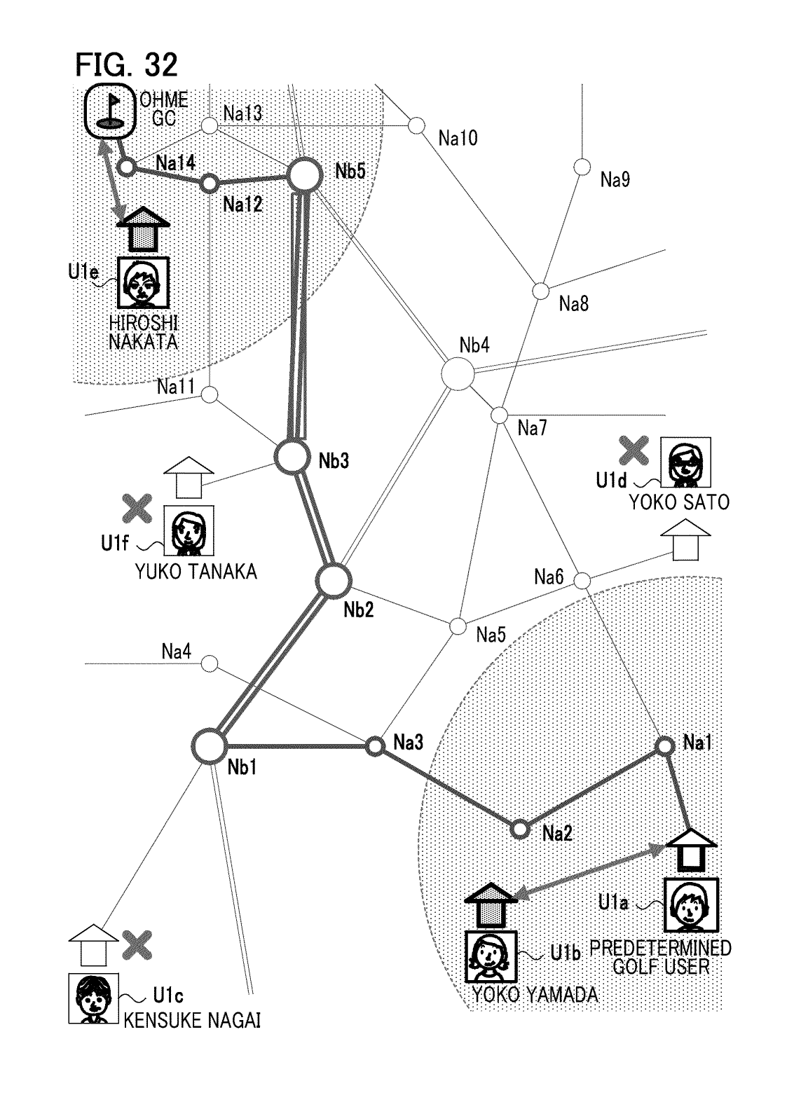

For example, as shown in FIG. 32, we assume a case in which the home of the golf user U1b is located within a predetermined distance (e.g., 10 km) from the home of the predetermined golf user U1a, which is the starting point of traveling, and the home of the golf user U1e is located within the predetermined distance from the selected golf course, which is the end of the traveling. In this case, there is a little possibility of diverging from highways out to local streets and again returning to the highways, and thus the time required for traveling does not increase considerably. Therefore, according to the present modification, time required for traveling is not increased substantially even if the predetermined golf user U1a stops by the homes of the candidate user for selection Use1.

In other words, in the above embodiment, the off-route distance obtainer 15 transmits all of the pieces of latitude and longitude information including a part or all of the one or more pieces of latitude and longitude information contained in the route information generated in the route determining process, the latitude and longitude information of the home of the predetermined golf user U1a, and the latitude and longitude information of the selected golf course, as the on-route location information, but may employ a part or all (i.e., at least one) of the plural pieces of latitude and longitude information as the on-route location information.

### Modification 3

In the embodiment and modifications above, the route determiner 41 (the CPU 60 of the map information server 4) determines a route for traveling from one place to another on the basis of the latitude and longitude information representing locations of the two places (the above Step S421(FIG. 19)). Alternatively, the route determiner 41 may determine a route for traveling from one place to another via a route point on the basis of latitude and longitude information of the route point.

In other words, the route determiner 41 may determine a route from the home of the predetermined golf user U1a to the selected golf course via the home of a predetermined target user Utgx on the basis of the latitude and longitude information of the home of the predetermined golf user U1a, that of the selected golf course and, and that of the home of a predetermined one Utgx of the target user(s) Utg.

In this case, the route information obtainer 14 (refer to Step S121 (FIG. 19)) transmits latitude and longitude information of the home of the predetermined target user Utgx as latitude and longitude information of a route point to the map information server 4, as well as that of the home of the predetermined golf user U1a and that of the selected golf course. Moreover, in this case, the off-route distance obtainer 15 (refer to Step S141 (FIG. 25)) may generate on-route location information so as to include latitude and longitude information of the home of the predetermined target user Utgx, in addition to one or more latitude and longitude information contained in the route information, that of the home of the predetermined golf user U1a, and that of the selected golf course. The off-route distance obtainer 15 (refer to Step S142) then may control transmission, to the map information server 4, of the generated on-route location information and latitude and longitude information of the home of a specific target user Utgy who is a golf user U1 but is not the predetermined target user Utgx, from among the target users Utg.

Furthermore, the distance calculator 42 (refer to Step S440) may calculate an off-route distance only for the specific target user Utgy who is a golf user U1 but is not the predetermined target user Utgx, from among the target users Utg.

For example, a companion for golf of the predetermined golf user U1a is sometimes predetermined. In this case, a route needs to be determined for travel from the home of the predetermined golf user U1a via the home of the companion to the selected golf course. In this case, if a route for traveling from the home of the predetermined golf user U1a to the selected golf course is simply determined as shown in an example shown in FIG. 26, etc., the resultant route could be no use for the predetermined golf user U1a because the resultant route could be substantially different from an actual route (a route stopping by the home of the companion) through which the predetermined golf user U1a travels.

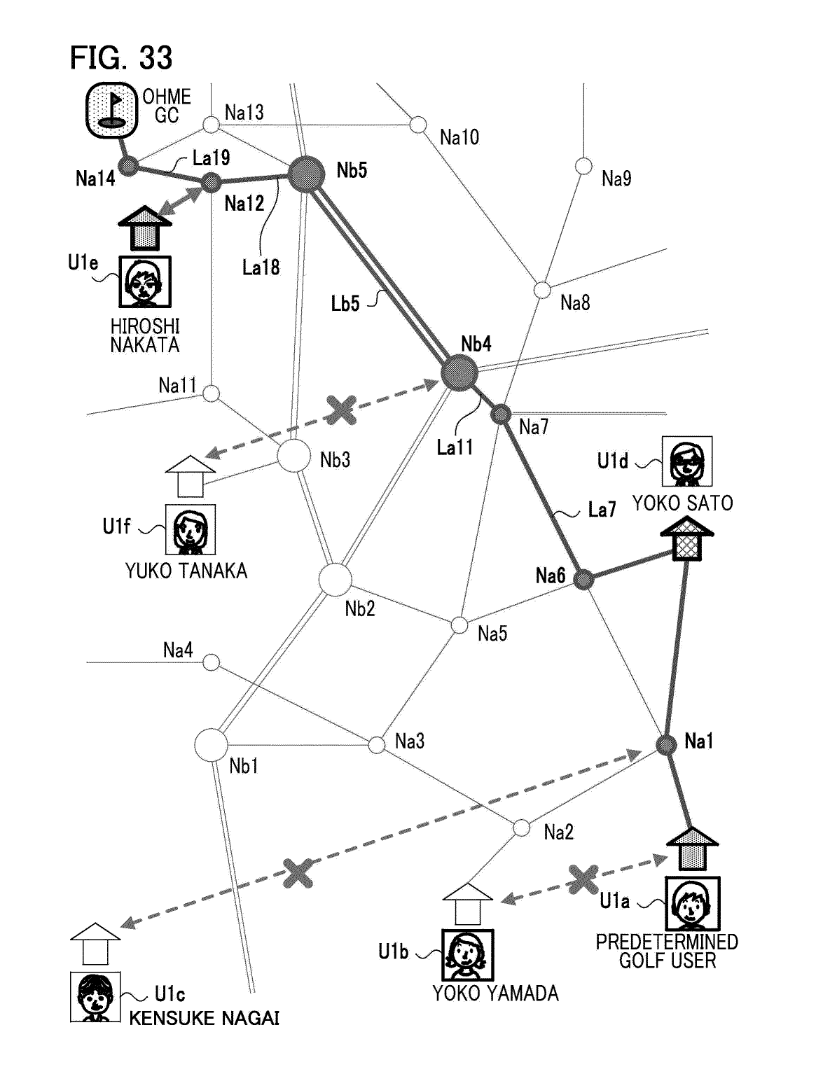

In contrast, as shown in FIG. 33, in a case in which the predetermined golf user U1a plans to go golfing with a golf user U1d as a companion (predetermined target user Utgx), a route for traveling via the home of the golf user U1d to the selected golf course can be determined according to the present modification. In the example shown in FIG. 33, the distance calculator 42 calculates as the off-route distance, a distance between a place on the route for traveling via the home of the golf user U1d (predetermined target user Utgx) to the selected golf course and the home of the target user(s) Utg (specific target user Utgy) except for the golf user U1d, to determine the candidate users for selection Use1.

### Modification 4

In the embodiment and modifications above, the distance calculator 42 calculates a distance between a selected place and a route on the basis of latitude and longitude information describing a location of the place, and on-route location information, which is the latitude and longitude information of one or more places on the route (the above Step S440 (FIG. 25)), but may instead calculate a distance between two places on the basis of the latitude and longitude information of the two places.

In this case, the off-route distance obtainer 15 may transmit to the map information server 4, a part or all of plural sets of combinations including a combination of the latitude and longitude information of intersections contained in the route information and that of the home of the target user Utg, a combination of the latitude and longitude information of the home of the predetermined golf user U1a and that of the home of the target user Utg, and a combination of the latitude and longitude information of the target golf course and that of the home of the target user Utg. The distance calculator 42 of the map information server 4 obtains as the off-route distance, one having the minimum distance from among distances calculated on the basis of the transmitted combinations of the latitude and longitude information pieces.

### Modification 5

In the embodiment and modifications above, the route information obtainer 14 and the off-route distance obtainer 15 each transmit latitude and longitude information to the map information server 4, but may instead transmit address information. Information transmitted from the management server 1 to the map information server 4 may be any information if location is identifiable on the basis of the information.

In the embodiment and modifications above, the location information obtainer 13 obtains the latitude and longitude information of the home of the golf user U1 and that of the golf course, etc., but may instead obtain address information. Information obtained by the location information obtainer 13 may be any information if location is identifiable on the basis of the information.

### Modification 6

In the embodiment and modifications above, a vehicle is given as an example means of transportation for use in traveling between two places. The present invention, however, is not limited thereto, and means other than a vehicle may be used as means for traveling between two places. Such traveling means includes, for example, railways, airplanes, bicycles, walking, or any combination thereof.

In the embodiment and modifications above, an intersection is given as an example of a transit point candidate through which one may possibly go through when traveling between two places, but the present invention is not limited thereto. Any place can be a transit point candidate if it is a place through which one may pass in traveling, such as railway stations, airports, harbors, or any combination thereof.

### Modification 7

In the embodiment and modifications above, the route determiner 41 determines a route having the minimum time required for traveling between two places, but the present invention is not limited thereto. The route determiner 41 may determine a route that minimizes an index value indicative of an amount of burden involved in traveling. The index value indicative of an amount of burden involved in travel may be a time required (strictly, a value indicative of the amount of time required), travel cost (a value indicative of the amount (expense) of the travel cost), travel distance (a value indicative of the traveling distance), the number of times of transfers when traveling by transportation facilities such as railway or bus (a value indicative of the number of transfers), a value indicative of heaviness of traffic congestion when traveling by vehicle, or any combination thereof.

### Modification 8

In the embodiment and modifications above, the route determiner 41 determines a route by use of map information represented in one graph, but may determine a route by use of map information represented by two or more graphs.

For example, in the example of FIG. 26, the route determiner 41 may determine a route by use of two hierarchical sets of map information, including map information (graph) representing only highways (freeways) and map information (graph) representing only local streets. In short, the route determiner 41 may determine a route for traveling between two places on the basis of any type of index that represents an amount of burden involved in travel.

### Modification 9

In the embodiment and modifications above, the service providing system 100 has the map information server 4. Alternatively, the service providing system 100 may have no map information server 4, and the management server may instead have a function achieved by the map information server 4.

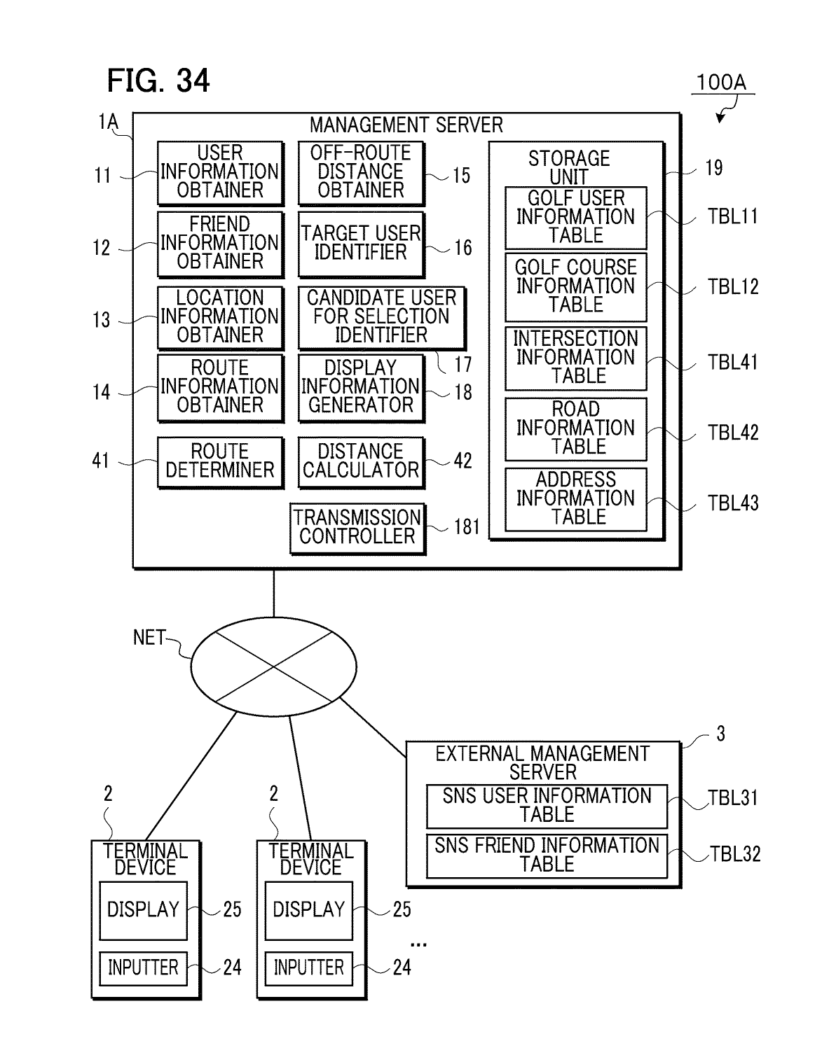

FIG. 34 is a block diagram of a service providing system 100A according to the modification. The service providing system 100A has a configuration substantially the same as the above-mentioned service providing system 100, except that it does not have the map information server 4 and has a management server 1A in place of the management server 1.

The management server 1A has a configuration substantially the same as the management server 1 except that it has the route determiner 41 and the distance calculator 42, and that the storage unit 19 has the intersection information table TBL41, the road information table TBL42, and the address information table TBL43.

The management server 1A of the modification is, for example, for providing a golf information application service with a golf user U1. The management server 1A has the user information obtainer 11 that obtains identification information UID for uniquely identifying the golf user U1, the friend information obtainer 12 that obtains friend information representing a specific relationship with the golf users U1, the location information obtainer 13 that obtains latitude and longitude information of a home of the golf user U1 and that of a golf course, the target user identifier 16 that identifies, based on at least the identification information UID of the predetermined golf user U1a and friend information, a direct golf friend Ug of the predetermined golf user U1a and an indirect golf friend Ugg of the predetermined golf user U1a as the target user Utg, the route determiner 41 that determines, based on the latitude and longitude information of the home of the predetermined golf user U1a and that of the golf course, a route for traveling from the home of the predetermined golf user U1a to the golf course, the distance calculator 42 that calculates a distance between the home of the target user Utg and a route determined by the route determiner 41 as off-route distances, the candidate user for selection identifier 17 that identifies a target user Utg with respect to which off-route distance calculated by the distance calculator 42 is equal to or smaller than a predetermined value, as a candidate user for selection Use1, the display information generator 18 that generates display information representing the candidate user for selection Use1 which the candidate user for selection identifier 17 has identified, and a transmission controller 181 that controls transmission of the display information generated by the display information generator 18 to the terminal device 2 of the predetermined golf user U1a.

### Modification 10

In the service providing system (the service providing system 100 or the service providing system 100A) of the embodiment and modifications above, the external management server 3 manages friend information, and the management server (the management server 1 or the management server 1A) does not manage the friend information. The present invention is not limited thereto, and the management server may manage friend information independently.

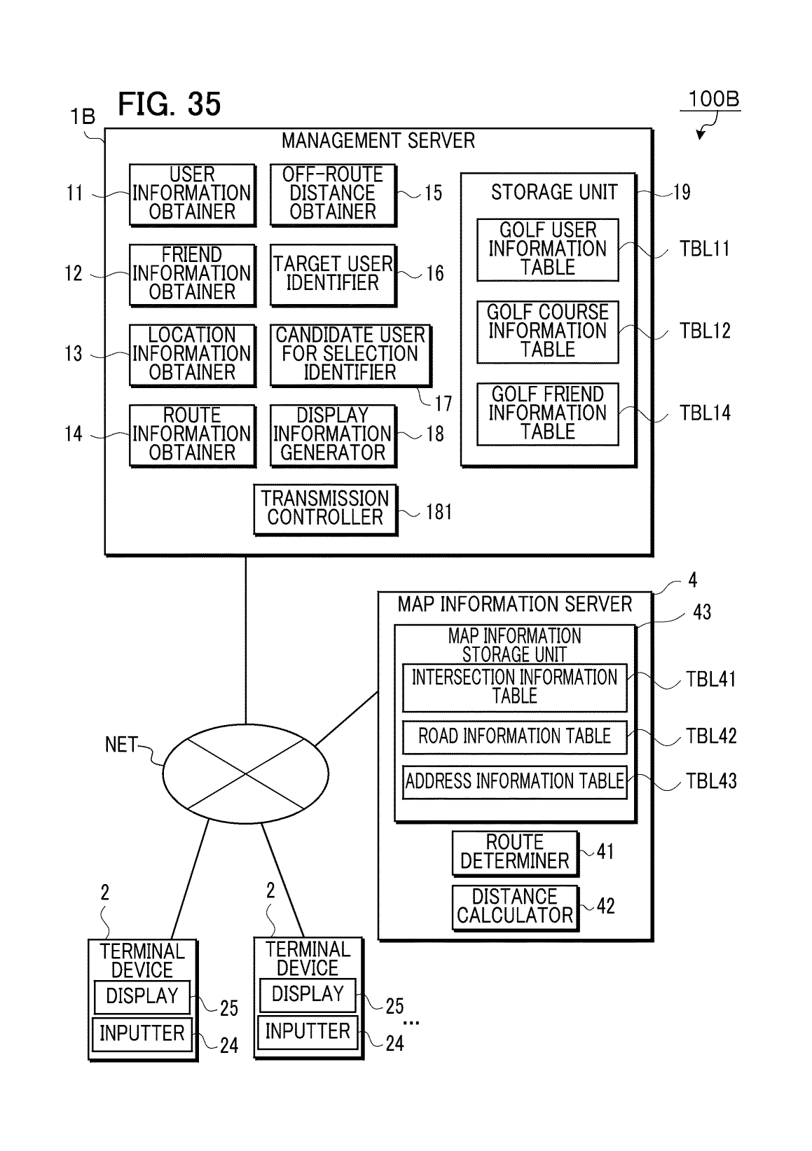

FIG. 35 shows a service providing system 100B of the present modification. The service providing system 100B has a configuration substantially the same as the service providing system 100 of the embodiment, except that it does not have the external management server 3 and has a management server 1B in place of the management server 1. The management server 1B differs from the management server 1 in that it has a golf friend information table TBL 14 in the storage unit 19.

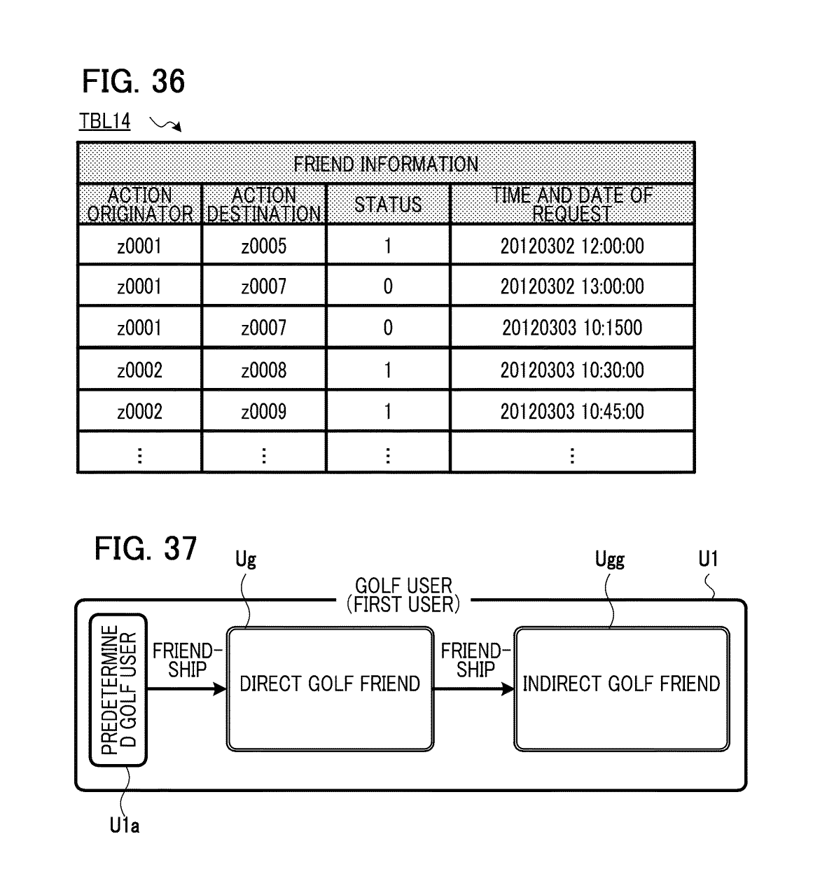

FIG. 36 shows an example data structure of the golf friend information table TBL 14. The golf friend information table TBL 14 has stored therein plural records. Each record has a set of golf friend information, i.e., identification information of an action originator, identification information of an action destination, status, and time and date of a friend request. The action originator is one of the golf users U1 who has transmitted a golf friend request, and the action destination is one of the SNS users U2 who has received the golf friend request. The status indicates a golf friend request status, with “0” indicating a corresponding request pending, and “1” indicating a corresponding request having been accepted.

In the service providing system 100B, the golf user U1 set is not included in the SNS user U2 set. Specifically, as shown in FIG. 37, the management server 1B manages golf users U1 having friendship with the predetermined golf user U1a as the direct golf friends Ug of the predetermined golf user U1a. The management server 1B manages golf users U1 who have friendship with the direct golf friends Ug who have friendship with the predetermined golf user U1a, as indirect golf friends Ugg of the predetermined golf user U1a. Thus, the management server 1B has the target user identifier 16 capable of identifying, as the target user Utg, based on the friend information and the identification information UID of the predetermined golf user U1a stored in the storage unit 19, direct golf friends Ug who are golf users U1 having friendship with the predetermined golf user U1a, and indirect golf friends Ugg who are golf users U1 having friendship with the direct golf friend Ug.

In this case, the storage unit 19 preferably stores individual information (i.e., name, age, storage location of profile image Pg, etc.,) of each of the golf users U1. The friend information obtainer 12 of the present modification may obtain friend information from the storage unit 19.

### Modification 11

In the service providing system of the embodiment and modifications above, the management server (the management server 1, 1A, or 1B) is provided with the storage unit 19. However, the present invention is not limited to such a configuration, but the management server may be one not provided with the storage unit 19.

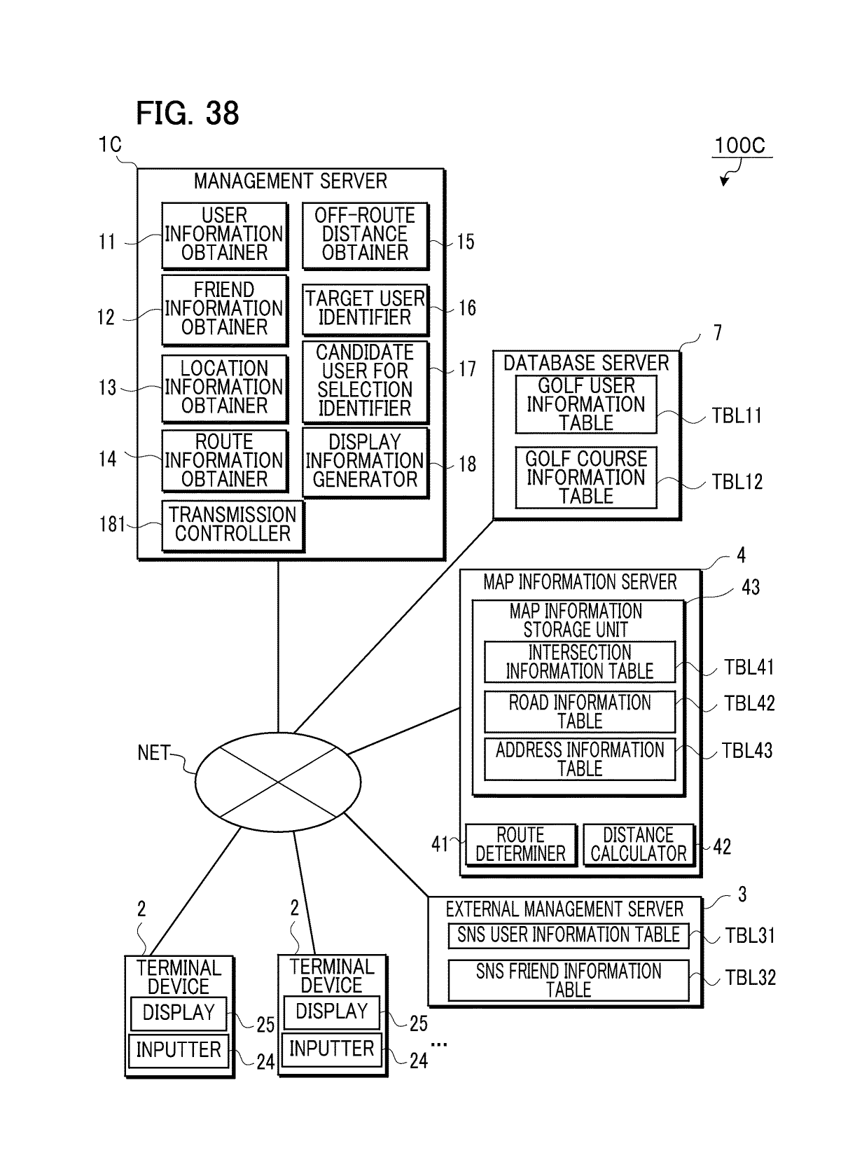

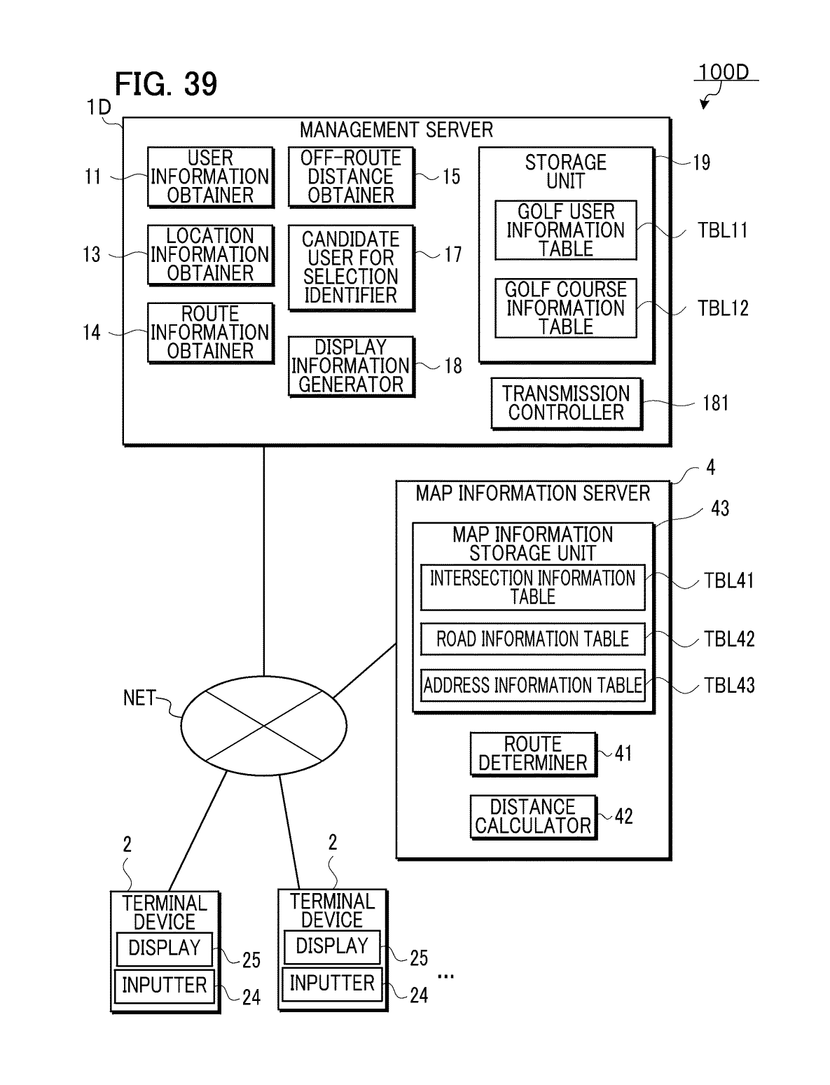

FIG. 38 shows the service providing system 100C of the present modification. The service providing system 100C has a configuration substantially the same as that of the service providing system 100 of the embodiment, except that it has a database server 7 and a management server 1C instead of the management server 1. The management server 1C has a configuration substantially the same as that of the management server 1 except that the management server 1C does not have the storage unit 19. The database server 7 has a storage device having stored therein the golf user information table TBL11 and the golf course information table TBL12 (in modification 9, the intersection information table TBL41 and the road information table TBL42 are additionally provided. In modification 10, the golf friend information table TBL 14 is additionally provided). The user information obtainer 11, the friend information obtainer 12, the location information obtainer 13, the route information obtainer 14, the off-route distance obtainer 15, the target user identifier 16, the candidate user for selection identifier 17, and the display information generator 18 of the management server 1C (in modification 9, also the route determiner 41 and the distance calculator 42) access the database server 7 where necessary, so as to refer to and obtain various types of data stored in the database server 7 in the tables.

### Modification 12

In the embodiment and modifications above, the target user identifier 16 identifies, as the target user Utg of the predetermined golf user U1a, the direct golf friend Ug of the predetermined golf user U1a and the indirect golf friend Ugg of the predetermined golf user U1a. The present invention is not limited thereto, and the target user identifier 16 may identify the direct golf friend Ug as the target user Utg. In this case, the target user identifier 16 may be one which does not identify the indirect golf friend Ugg.

As an alternative, the target user identifier 16 may identify both the direct golf friend Ug and the indirect golf friend Ugg, and may determine the indirect golf friend Ugg alone as the target user Utg.

As another alternative, the target user identifier 16 may identify both the direct golf friend Ug and the indirect golf friend Ugg, and may determine the direct golf friend Ug alone as the target user Utg.

Thus, the target user identifier 16 may be one which identifies either one or both of the direct golf friend Ug of the predetermined golf user U1a and the indirect golf friend Ugg of the predetermined golf user U1a as the target user Utg of the predetermined golf user U1a.

### Modification 13

In the embodiment and modifications above, the candidate user for selection Use1 of the predetermined golf user U1a is identified from among the target user Utg of the predetermined golf user U1a. The present invention is not limited thereto, and the candidate user for selection Use1 of the predetermined golf user U1a may be identified from among other golf users U1t (non-limiting example of “other users”, each one of whom is a user who is not the predetermined user from among users of a service relating to the predetermined object, i.e., users other than the predetermined user). The “other users” include golf users except for the predetermined golf user U1a, the golf users including the target user Utg of the predetermined golf user U1a.

FIG. 39 shows an example of a service providing system 100D according to the present modification.

As shown in FIG. 39, the service providing system 100D has a configuration substantially the same as the service providing system 100 of the above embodiment, except that the service providing system 100D does not have the external management server 3 and has a management server 1D in place of the management server 1. The management server 1D is substantially the same as the management server 1 of the above embodiment, except that the management server 1D does not have the friend information obtainer 12 or the target user identifier 16.

The nearby-route user identifying process of the present modification uses other golf users U1t in place of the target user Utg as used in the nearby-route user identifying process in the above-mentioned embodiment and the modifications.

The CPU (off-route distance obtainer 15) of the management server 1D transmits latitude and longitude information of the homes of the other golf users U1t in the process at the above Step S142 (FIG. 25), instead of latitude and longitude information of the home of the target user Utg.

The CPU (distance calculator 42) of the management server 1D calculates a distance between a route determined by the route determiner 41 and the homes of the other golf users U1t, as off-route distances in the process at the above Step S440 (FIG. 25), instead of distances between a route determined by the route determiner 41 and the home of the target user Utg.

The CPU (candidate user for selection identifier 17) of the management server 1D identifies, from among the other golf users U1t, those users with regard to whom the off-route distances are equal to or shorter than the predetermined distance, and selects the user as the candidate users for selection Use1 in the process at the above Step S144 (FIG. 25), instead of selecting those target user Utg with regard to whom the off-route distances are equal to or shorter than the predetermined distance. It is of note that, in the present modification, the golf user information table TBL11 has stored therein individual information of the golf users U1.

In the present modification, similar to modification 3 above, the route determiner 41 (the CPU of the management server 1D) may determine a route for traveling from the home of the predetermined golf user U1a to the selected golf course via the home of a golf user U1 (a non-limiting example of a “companion user”, hereinafter referred to as “golf companion user U1tx”) who is a companion of the predetermined golf user U1a at Step S421 (FIG. 19). In this case, the golf users U1 except for the predetermined golf user U1a and except for the golf companion user U1tx may be regarded as the other golf users U1t.

Specifically, the route information obtainer 14 (refer to Step S121 (FIG. 19)) transmits latitude and longitude information of the home of the predetermined golf user U1a and that of the selected golf course to the map information server 4, and also transmits to the map information server 4 latitude and longitude information of the home of the golf companion user U1tx as latitude and longitude information of a route point.

In this case, the route determiner 41 (refer to Step S421) may determine a route for traveling from the home of the predetermined golf user U1a and the selected golf course via the home of the golf companion user U1tx, on the basis of latitude and longitude information of the home of the predetermined golf user U1a, that of the selected golf course, and that of the home of the golf companion user U1tx.

The off-route distance obtainer 15 (refer to Step S141 (FIG. 25)) may generate on-route location information so as to include latitude and longitude information of the home of the golf companion user U1tx in addition to the latitude and longitude information contained in the route information, that of the home of the predetermined golf user U1a, and that of the selected golf course. The off-route distance obtainer 15 (refer to Step S142) may transmit the generated on-route location information and latitude and longitude information of the homes of the other golf users U1t (golf user U1s excluding the predetermined golf user U1a and the golf companion user U1tx) to the map information server 4.

In this case, the distance calculator 42 (refer to Step S440 (FIG. 25)) may calculate the off-route distance only with respect to the other golf users U1t (golf users U1 excluding the predetermined golf user U1a and the golf companion user U1tx).

The candidate user for selection identifier 17 (refer to Step S144 (FIG. 25)) may identify, as the candidate user for selection Use1, from among the other golf users U1t, those users with respect to whom the off-route distances are equal to or shorter than a predetermined distance.

It is of note that FIG. 39 shows a mere example of the service providing system 100D of the present modification.

The service providing system 100D according to the present modification may be configured as one not provided with the map information server 4, as described in modification 9. In this case, the management server 1D has the route determiner 41 and the distance calculator 42, and the storage unit 19 has stored therein the intersection information table TBL41, the road information table TBL42, and the address information table TBL43.

The service providing system 100D may be provided with the database server 7, as described in modification 10. In this case, the management server 1D may be one which does not have the storage unit 19.

The service providing system 100D may be one which has the external management server 3 (or one which has stored the golf friend information table TBL 14 in the storage unit 19) as described in the embodiment and modifications above. In this case, the management server 1D may have the friend information obtainer 12 and the target user identifier 16. The predetermined golf user U1a may be able to select, on the personalized page, either identifying candidate users for selection Use1 out of the other golf users U1t from among the golf users U1 or identifying candidate users for selection Use1 from among the target users Utg.

### Modification 14

The management server (the management server 1, 1A, 1B, 1C, or 1D) of the embodiment and modifications above is capable of communicating with the terminal device 2, but the present invention is not limited thereto. The management server may be one which does not communicate with the terminal device 2. For example, in a case in which a Web server is capable of communicating with the terminal device 2, the management server may be one capable of communicating with the Web server. In this case, the management server may be one not provided with the transmission controller 181.

### Modification 15

The service providing system of the embodiment and modifications above provides golf users U1 with a personalized page including the address registration screen G8, so that a golf user U1 is able to register an address of the home on the address registration screen G8, but the present invention is not limited thereto. In a case in which the terminal device 2 of a golf user U1 is a portable phone, a smartphone, or the like, the GPS function of the terminal device 2 may be used to register an address or latitude and longitude of the home.

### Modification 16

In the embodiment and modifications above the golf information application service is shown as an example of a service provided by the management server (management server 1, 1A, 1B, 1C, 1D, etc.,), but the present invention is not limited thereto. The management server may provide any type of service if the service relates to a predetermined activity (predetermined object).

The predetermined activity may be one related to sports such as swimming, skiing, and tennis, one related to hobbies such as movies, music, games, and trip, or may be one related to business.

In the embodiment and modifications above, the location information obtainer 13 obtains latitude and longitude information of a golf course, but the latitude and longitude information obtained by the location information obtainer 13 is not limited to that of the golf course. For example, the location information obtainer 13 may obtain that of a facility relating to a predetermined object. The “facility relating to a predetermined object” is a pool, a bathing beach, etc., if the predetermined object is swimming, is a ski slope, etc., if the predetermined object is skiing, and is a movie theater etc., if the predetermined object is a movie.

The specific relationship is not limited to friendship. For example, the specific relationship may be a relationship between superiors and subordinates, or a relationship between wholesalers and retailers. In short, the specific relationship can be any relationship if it is established on the basis of a certain rule.

### Modification 17

In the embodiment and modifications above, the management server 1 (or 1A, 1B, 1C, or 1D) generates display information representing a hierarchical, specific relationship between users, and the terminal device 2 causes the display 25 to display a screen based on the display information. However, the present invention is not limited thereto, and an information processing device alone, such as a personal computer, may generate the display information and may display information based on the generated display information.

A computer readable recording medium may be used to store a computer program for realizing functions of the present invention, such that a computer system reads and runs the computer program recorded in the recording medium. The computer system includes hardware such as an operating system and peripherals. Also, the computer system may include plural computer apparatuses connected through a network including telecommunication media such as the Internet, WAN, LAN, and private lines. The computer-readable recording medium may be a non-transitory portable recording medium such as flexible disks, magneto-optical disks, ROMs, and CD-ROMs or a non-transitory storage device such as hard disk drives built into the computer system. The computer-readable recording medium includes one that stores a computer program for a certain period, such as a volatile memory (RAM) in a server or client computer system in a case where the computer program is transmitted via a network. The computer program may be one that achieves only a part of the above-described functions. Furthermore, the functions described above may be realized by a combination of a so-called, differential file (differential program) and computer programs already stored in a computer system.

A part or all of the functions above may be realized by an integrated circuit such as an LSI (Large Scale Integration), etc. Separate processors may incorporate the ones of the functions. Alternatively, a processor may incorporate a part or all of the functions on an integrated circuit. An integrated circuit may be in the form of LSI, but alternatively be in the form of an exclusive circuit or a general purpose processor. Furthermore, if new integrated circuit fabrication technology replaces an LSI in the future as a result of evolution in semiconductor technology, an integrated circuit of the new technology may be used. Moreover, the present invention includes a distribution server for distributing a computer program for realizing the functions (even partially) of the present invention, a storage medium provided with the distribution server, and a storage medium that resides external to the distribution server and that stores the computer program for distribution through the distribution server.

The following aspects of the invention are understood from the embodiments and modifications described in the foregoing.

In accordance with one aspect of the present invention, a non-transitory computer-readable recording medium has recorded thereon a computer program for a management apparatus that provides users with a service relating to a predetermined object, the management apparatus having a computer. The computer program causes the computer to execute: a location information obtaining process for obtaining location information of a reference point of a user and location information of a facility relating to the predetermined object; a determination process for determining a route for traveling from a reference point of a predetermined user to a predetermined facility based on location information of the reference point obtained for the predetermined user and location information of the predetermined facility; a calculation process for calculating an off-route distance, which is a distance between a place on the route determined in the determination process and a reference point of a user who is not the predetermined user from among the users of the service relating to the predetermined object; a candidate identifying process for identifying, from among the users other than the predetermined user, at least one user for whom the off-route distance calculated in the calculation process turns out to be equal to or smaller than a predetermined value, as a candidate user for selection; and a display information generating process for generating display information representing the candidate user for selection identified in the candidate identifying process.

In a preferred embodiment, the determination process may determine the route so as to additionally stop by a reference point of a companion user to accompany the predetermined user, and it may be configured so that the reference point of the user who is not the predetermined user does not include the reference point of the predetermined user or the reference point of the companion user.

Preferably, the determination process may determine, from among preset transit point candidates, a transit point to pass through in traveling from the reference point of the predetermined user to the predetermined facility via the reference point of the companion user, such that an index value indicative of an amount of burden involved in traveling is minimized, to determine the route.

In another preferred embodiment, the computer program may cause the computer to further execute: an identification information obtaining process for obtaining identification information that uniquely identifies one of the users; and a relationship information obtaining process for obtaining specific relationship information that indicates a specific relationship between at least two of the users, the user who is not the predetermined user is a target user who has the specific relationship with the predetermined user.

Preferably, the determination process may determine, from among preset transit point candidates, a transit point to pass in traveling from the reference point of the predetermined user to the predetermined facility, such that an index value indicative of an amount of burden involved in traveling is minimized, to determine the route.

Preferably, the determination process may determine the route so as to additionally stop at a reference point of a predetermined target user, and, when there is a plurality of the target users including the predetermined target user, the user who is not the predetermined user is a target user who is not the predetermined target user.

Use of the non-transitory recording medium enables installment of the computer program on the computer. The non-transitory recording medium having the computer program stored thereon may be any suitable recording medium, such as a CD-ROM, and so on.

In the above aspect of the present invention, a service relating to a predetermined object is, for example, an application service for providing information on a predetermined object. A facility relating to a predetermined object is, for example, a golf course, or the like, when the predetermined object is golf. A reference point of a user may be a home of the user, a closest station from the home of the user, a workplace of the user, or any other place that serves as a base point for daily life or action of the user. The location information may include a latitude and a longitude, or alternatively an address. The location information obtaining process may be one that obtains location information from a storage device having stored therein location information on a reference point of a user and location information on a facility relating to the predetermined object. In this case, the storage device may be one that is provided at a management apparatus or may be provided at an apparatus different from the management apparatus.

In a preferred embodiment of the non-transitory computer-readable recording medium above, the computer program may further cause the computer to execute: an identification information obtaining process for obtaining identification information that uniquely identifies one of the users; a relationship information obtaining process for obtaining specific relationship information that indicates a specific relationship between at least two of the users; a target user identifying process for identifying, based at least on identification information of a predetermined user and the specific relationship information, one or more, or all of the users having the specific relationship with the predetermined user as a target user. The calculation process may calculate a distance between a reference point of the target user from among the users of the service and the route determined in the determination process, as an off-route distance.

In this embodiment, the relationship information obtaining process may be one that obtains specific relationship information from a storage device having stored therein the specific relationship information. In this case, the storage device may be one that is provided at a management apparatus or may be provided at an apparatus different from the management apparatus.

Furthermore, in this embodiment, the target user identifying process may be a process of identifying, based on identification information of a predetermined user and specific relationship information, one or more, or each of a direct relationship user who is a user who has the specific relationship with the predetermined user, and an indirect relationship user who has the specific relationship with the direct relationship user, as a target user.

Specifically, the target user identifying process may identify as a target user, based on the specific relationship information and using identification information of a predetermined user, a direct relationship user who has the specific relationship with the predetermined user, and an indirect relationship user who has the specific relationship with the direct relationship user, by use of identification information of the direct relationship user.

The target user identifying process may identify, after identifying a direct relationship user and an indirect relationship user, one or more of the identified users (e.g., the direct relationship user) as a target user.

A non-transitory computer-readable recording medium according to another aspect of the present invention has recorded thereon a computer program for a management apparatus that provides users with a service relating to a predetermined object, the management apparatus having a computer, the computer program causing the computer to execute: an identification information obtaining process for obtaining identification information uniquely identifying one of the users; a relationship information obtaining process for obtaining specific relationship information that indicates a specific relationship between at least two of the users; a location information obtaining process for obtaining location information of a reference point of a user and location information of a facility relating to the predetermined object; a target user identifying process for identifying, based at least on identification information of a predetermined user and the specific relationship information, one or more, or all the users having the specific relationship with the predetermined user as a target user; a determination process for determining a route for traveling from the reference point of the predetermined user to the predetermined facility based on location information of the reference point obtained for the predetermined user and the location information of the predetermined facility; a calculation process for calculating an off-route distance which is a distance between a place on the route determined in the determination process and a reference point of the target user; a candidate identifying process for identifying at least one target user for whom the off-route distance calculated in the calculation process turns out to be equal to or smaller than a predetermined value, as a candidate user for selection; and a display information generating process for generating display information representing the candidate user for selection identified in the candidate identifying process.

In a preferred embodiment of the non-transitory computer-readable recording medium above, the determination process preferably may determine, from among preset transit point candidates, a transit point to pass through in traveling from the reference point of the predetermined user to the predetermined facility, such that an index value indicative of an amount of burden involved in traveling is minimized, to determine the route.

According to this embodiment, traveling may involve at least one of vehicles and public transportation such as railways and airplanes, etc. Transit point candidates are places through which a traveler could pass in traveling between two places. If a predetermined user travels by vehicle, transit point candidates are, for example, intersections, interchanges, etc., through which the user could pass when traveling by vehicle. In the case of traveling by railway, transit point candidates are railway stations, and in the case of traveling by airplane transit point candidates are airports. An index value indicative of an amount of burden involved in traveling may be, for example, a value indicative of an amount of time required for traveling or a value indicative of costs required for traveling.

Preferably, the location information obtaining process additionally may obtain location information of the transit point, the calculation process may calculate, as the off-route distance, a shortest one of a first distance which is a distance between the reference point of the predetermined user and the reference point of the target user, a second distance which is a distance between the predetermined facility and the reference point of the target user, and a third distance which is a distance between the transit point and the reference point of the target user.

In still another embodiment, the transit point candidates may include a specific transit candidate point having a specific attribute, and the location information obtaining process may obtain the location information of the transit point, and the calculation process may calculate, as the off-route distance, the shortest one of a first distance which is a distance between the reference point of the predetermined user and the reference point of the target user, a second distance which is a distance between the predetermined facility and the reference point of the target user, and a third distance which is a distance between the reference point of the target user and a target transit point which is not the specific transit candidate point. Attributes of transit point candidates are different types of places, such as intersections, interchanges, railway stations, airports, etc., through which a traveler could possibly pass in traveling between two places.

In still yet another embodiment, the calculation process may calculate, as the off-route distance, a shortest one of a first distance which is a distance between the reference point of the predetermined user and the reference point of the target user and a second distance which is a distance between the predetermined facility and the reference point of the target user.

A non-transitory computer-readable recording medium according to still another aspect has recorded thereon a computer program for a management apparatus that provides users with a service relating to a predetermined object, the management apparatus having a communicator for communicating with a first external apparatus that determines a route for traveling between two places and calculates a distance between the two places and the management apparatus having a computer, the computer program causing the computer to execute: a location information obtaining process for obtaining location information of a reference point of a user and location information of a facility relating to the predetermined object; a route information obtaining process for transmitting location information of a reference point obtained for a predetermined user and location information of the predetermined facility to the first external apparatus, and of obtaining, from the first external apparatus, location information of one or more transit points on a route having been determined by the first external apparatus based on the transmitted location information; a distance information obtaining process for transmitting, to the first external apparatus, location information of a reference point obtained for a user who is not the predetermined user, from among the users of the service relating to the predetermined object, and at least one of, the location information of the one or more transit points obtained in the route information obtaining process, the location information of the reference point of the predetermined user, and the location information of the predetermined facility, and of obtaining an off-route distance which is the shortest one of a first distance between the reference point of the user who is not the predetermined user and the one or more transit points, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information; a candidate identifying process for identifying, from among the users other than the predetermined user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

A non-transitory computer-readable recording medium according to still another aspect has recorded thereon a computer program for a management apparatus that provides users with a service relating to a predetermined object, the management apparatus having a computer, the computer program causing the computer to execute: a location information obtaining process for obtaining location information of a reference point of a user and location information of a facility relating to a predetermined object; a route information obtaining process for transmitting location information of a reference point obtained for a predetermined user and location information of the predetermined facility to a first external apparatus, and of obtaining, from the first external apparatus, location information of one or more transit point on a route from the reference point of the predetermined user to the predetermined facility, the route having been determined by the first external apparatus based on the transmitted location information; a distance information obtaining process for transmitting, to the first external apparatus, location information of a reference point obtained for a user who is not the predetermined user from among the users of the service relating to the predetermined object and at least one of, the location information of the one or more transit points obtained in the route information obtaining process, the location information of the reference point of the predetermined user, or the location information of the predetermined facility, and for obtaining an off-route distance which is a shortest one of a first distance between the reference point of the user who is not the predetermined user and the transit point, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information; a candidate identifying process for identifying, from among the users other than the predetermined user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

In a preferred embodiment, when the route has one or a plurality of transit points, it may be configured so that location information of the one or plurality of transit points used in the distance information obtaining process does not include location information of a transit point having a particular attribute, wherein, when the transit point having the particular attribute is selected as a route deviation point, a road type thereby is changed from a predetermined type to another type (such that an index value indicative of an amount of burden involved in traveling is minimized, to determine the route).

In a non-limiting embodiment, the route has one or a plurality of intersections as the transit points, and location information of the one or plurality of intersections used in the distance information obtaining process does not include location information of a specific intersection as a transit point having a particular attribute, wherein, when the specific intersection is selected as a route deviation point, a road type thereby is changed from a predetermined type to another type. An example of the specific intersection is intersections where highways cross one another (junctions of the intersection type 4) or intersections where one or more highways and one or more local streets cross one another (interchanges of the intersection type 3). In a non-limiting example, the predetermined road type is type 3 indicating a highway, and other road types include type 2 indicating a large-scale local street and type 1 indicating a small-scale local street.

In another preferred embodiment, the route information obtaining process may further transmit, to the first external apparatus, location information of a reference point obtained for a companion user as route point location information, in a case in which the predetermined user stops at the reference point of the companion user to accompany the predetermined user in traveling from the reference point of the predetermined user to the predetermined facility, and the distance information obtaining process may transmit, to the first external apparatus, the location information of the reference point of a user who is not the predetermined user or the companion user from among the users of the service relating the predetermined object and at least one of the location information of the one or more transit points obtained in the route information obtaining process, the location information of the reference point of the predetermined user, the location information of the reference point of the companion user, or the location information of the predetermined facility, and obtains an off-route distance which is a shortest one of the first distance, the second distance, the third distance, and a fourth distance between the reference point of the user who is not the predetermined user or the companion user and the location information of the reference point of the companion user, with the fourth distance having been calculated by the first external apparatus based on the transmitted location information.

Preferably, the management apparatus may be configured to communicate with a second external apparatus that manages identification information uniquely identifies external users including the users of the service relating to the predetermined object and specific relationship information indicating specific relationships between the external users, and the computer program may cause the computer to further execute: an identification information obtaining process for obtaining identification information uniquely identifying one of the external users; and a relationship information obtaining process for obtaining specific relationship information indicating a specific relationship between at least two of the external users based on the identification information of the external users obtained in the identification information obtaining process.

In still another preferred embodiment, the computer program may cause the computer to further execute: an identification information obtaining process for obtaining identification information uniquely identifying one of the users; and a relationship information obtaining process for obtaining specific relationship information indicating a specific relationship between at least two of the users, and the user who is not the predetermined user may be a target user who is at least one user (a part or all of one or more users) who has the specific relationship with the predetermined user.

Preferably, when the route has one or a plurality of transit points, it may be configured so that location information of the one or plurality of transit points used in the distance information obtaining process does not include location information of a transit point having a particular attribute, wherein, when the transit point having the particular attribute is selected as a route deviation point, a road type is thereby changed from a predetermined type to another type.

In the above aspect of the present invention, a service relating to a predetermined object is, for example, an application service for providing information on a predetermined object. A facility relating to a predetermined object is, for example, a golf course, etc., when the predetermined object is golf. A reference point of a user may be any place that could be a base point of action of the user. The location information may describe latitude and longitude, or alternatively an address. The location information obtaining process may be one that obtains location information from a storage device stored therein, location information of a reference point of a user and location information of a facility relating to the predetermined object. In this case, the storage device may be one that is provided at a management apparatus or may be provided at an apparatus (e.g., a first external apparatus) different from the management apparatus.

Furthermore, in the computer-readable recording medium above, the computer program may cause the computer to further execute an identification information obtaining process for obtaining identification information that uniquely identifies one of the users; a relationship information obtaining process for obtaining specific relationship information indicating a specific relationship between at least two of the users; and a target user identifying process for identifying, based at least on identification information of a predetermined user and the specific relationship information, one or more, or all of the users having the specific relationship with the predetermined user as a target user. The distance information obtaining process may transmit location information of a reference point of the target user and at least one of, the location information of the one or more transit points obtained in the route information obtaining process, the location information of a reference point obtained for the predetermined user, and the location information of the predetermined facility, to the first external apparatus. The off-route distance may be the shortest one of a first distance between the reference point of the target user and the one or more transit points, a second distance between the reference point of the target user and the reference point of the predetermined user, and a third distance between the reference point of the target user and the predetermined facility, with the first distance, the second distance, and the third distance having been calculated by the first external apparatus based on the transmitted location information, and the candidate identifying process may identify at least one target user for whom the off-route distance obtained in the distance information obtaining process turns out to be equal to or smaller than a predetermined value, as a candidate user for selection.

The relationship information obtaining process may be one that obtains specific relationship information from a storage device having stored therein specific relationship information. In this case, the storage device may be one that is provided at a management apparatus or may be provided at an apparatus, such as a first external apparatus, different from the management apparatus. It is of note that the target user identifying process may identify as a target user, based on the specific relationship information and identification information of a predetermined user, one or more, or all of, a direct relationship user who has the specific relationship with the predetermined user, and an indirect relationship user who has the specific relationship with the direct relationship user.

A non-transitory computer-readable recording medium according to yet another aspect has recorded thereon a computer program for a management apparatus that provides users with a service relating to a predetermined object, the management apparatus having a communicator for communicating with a first external apparatus that determines a route for traveling between two places and calculates a distance between the two places, and the management apparatus having a computer, the computer program causing the computer to execute: an identification information obtaining process for obtaining identification information that uniquely identifies one of the users; a relationship information obtaining process for obtaining specific relationship information indicating a specific relationship between at least two of the users; a location information obtaining process for obtaining location information of a reference point of a user and location information of a facility relating to the predetermined object; a target user identifying process for identifying, based at least on identification information of a predetermined user and the specific relationship information, one or more, or all of the users having the specific relationship with the predetermined user as a target user; a route information obtaining process for transmitting location information of a reference point obtained for the predetermined user and the location information of the predetermined facility to the first external apparatus, and for obtaining, from the first external apparatus, location information of one or more transit points on a route having been determined by the first external apparatus based on the transmitted location information; a distance information obtaining process for transmitting, to the first external apparatus, location information of a reference point obtained for the target user, and at least one of, the location information of the one or more transit points obtained in the route information obtaining process, the location information of the reference point of the predetermined user, and the location information of the predetermined facility, and for obtaining an off-route distance which is the shortest one of a first distance between the reference point of the target user and the one or more transit points, a second distance between the reference point of the target user and the reference point of the predetermined user, and a third distance between the reference point of the target user and the predetermined facility, with the first distance, the second distance, and the third distance having been calculated by the first external apparatus based on the transmitted location information; a candidate identifying process for identifying at least one target user for whom the off-route distance obtained in the distance information obtaining process turns out to be equal to or smaller than a predetermined value, as a candidate user for selection; and a display information generating process for generating display information representing the candidate user for selection identified in the candidate identifying process.

A non-transitory computer-readable recording medium according to yet another aspect has recorded thereon a computer program for a management apparatus that provides users with a service relating to a predetermined object, the management apparatus having a communicator for communicating with a first external apparatus that determines a route for traveling between two places and calculates a distance between the two places and the management apparatus having a computer, the computer program causing the computer to execute: a location information obtaining process for obtaining location information of a reference point of a user and location information of a facility relating to the predetermined object; a route information obtaining process for transmitting location information of a reference point obtained for a predetermined user and location information of the predetermined facility to the first external apparatus, and for obtaining, from the first external apparatus, location information of one or more transit points on a route having been determined by the first external apparatus based on the transmitted location information; a distance information obtaining process for transmitting, to the first external apparatus, location information of a reference point obtained for a user who is not the predetermined user, from among the users of the service relating to the predetermined object, and at least one of the location information of a target transit point, from among the one or more transit points obtained in the route information obtaining process, the target transit point not having a specific attribute, the location information of the reference point of the predetermined user, and the location information of the predetermined facility, and of obtaining an off-route distance which is the shortest one of a first distance between the reference point of the user who is not the predetermined user and the target transit point, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information; a candidate identifying process for identifying, from among the users other than the predetermined user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

In a case in which one or more transit points obtained in the route information obtaining process do not include a transit point having a specific attribute, all of the one or more transit points are used as target transit points. In a case in which all of one or more transit points each are a transit point having a specific attribute, the one or more transit points do not include a target transit point.

In the above aspect of the computer-readable recording medium, the computer program may cause the computer to further execute: an identification information obtaining process for obtaining identification information that uniquely identifies one of the users; a relationship information obtaining process for obtaining specific relationship information indicating a specific relationship between at least two of the users; and a target user identifying process for identifying, based at least on identification information of a predetermined user and the specific relationship information, one or more, or all of the users having a specific relationship with the predetermined user as a target user. The distance information obtaining process may transmit location information of a reference point of the target user and at least one of the location information of the target transit point, the location information of the reference point of the predetermined user, and the location information of the predetermined facility, to the first external apparatus. The off-route distance may be the shortest one of a first distance between the reference point of the target user and the target transit point, a second distance between the reference point of the target user and the reference point of the predetermined user, and a third distance between the reference point of the target user and the predetermined facility, with the first distance, the second distance, and the third distance having been calculated by the first external apparatus based on the transmitted location information, and the candidate identifying process may identify at least one target user for whom the off-route distance obtained in the distance information obtaining process turns out to be equal to or smaller than a predetermined value, as a candidate user for selection.

A non-transitory computer-readable recording medium according to yet another aspect has recorded thereon a computer program for a management apparatus that provides users with a service relating to a predetermined object, the management apparatus having a communicator for communicating with a first external apparatus that determines a route for traveling between two places and calculates a distance between the two places and the management apparatus having a computer, the computer program causing the computer to execute: an identification information obtaining process for obtaining identification information that uniquely identifies one of the users; a relationship information obtaining process for obtaining specific relationship information indicating a specific relationship between at least two of the users; a location information obtaining process for obtaining location information of a reference point of a user and location information of a facility relating to the predetermined object; a target user identifying process for identifying, based at least on identification information of a predetermined user and the specific relationship information, one or more, or all of the users having a specific relationship with the predetermined user as a target user; a route information obtaining process for transmitting location information of a reference point obtained for the predetermined user and the location information of the predetermined facility to the first external apparatus, and of obtaining, from the first external apparatus, location information of a transit point on a route having been determined by the first external apparatus based on the transmitted location information; a distance information obtaining process for transmitting, to the first external apparatus, location information of a reference point obtained for the target user and at least one of the location information of a target transit point, from among the one or more transit points obtained in the route information obtaining process, the target transit point not having a specific attribute, the location information of the reference point of the predetermined user, and the location information of the predetermined facility, and of obtaining an off-route distance which is the shortest one of a first distance between the reference point of the target user and the target transit point, a second distance between the reference point of the target user and the reference point of the predetermined user, and a third distance between the reference point of the target user and the predetermined facility, with the first distance, the second distance, and the third distance having been calculated by the first external apparatus based on the transmitted location information; a candidate identifying process for identifying at least one target user for whom the off-route distance obtained in the distance information obtaining process turns out to be equal to or smaller than a predetermined value, as a candidate user for selection; and a display information generating process for generating display information representing the candidate user for selection identified in the candidate identifying process.

A non-transitory computer-readable recording medium according to another aspect of the present invention has recorded thereon a computer program for a management apparatus that provides users with a service relating to a predetermined object, the management apparatus having a computer, the computer program causing the computer to execute: a location information obtaining process for obtaining location information of a reference point of a user and location information of a facility relating to the predetermined object; a determination process for determining, based on location information of a reference point obtained for a predetermined user, location information of the predetermined facility, and location information of a reference point obtained for a companion user from among the users other than the predetermined user, a route for traveling from the reference point of the predetermined user to the predetermined facility via the reference point of the companion user; a calculation process for calculating an off-route distance which is a distance between a place on the route determined in the determination process and a reference point of a user, from among the users of the service relating to the predetermined object, who is not the predetermined user or the companion user; a candidate identifying process for identifying, from among the users other than the predetermined user or the companion user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

In the computer-readable recording medium according to the aspect above, the computer program may cause the computer to further execute: an identification information obtaining process for obtaining identification information that uniquely identifies one of the users; a relationship information obtaining process for obtaining specific relationship information indicating a specific relationship between at least two of the users; and a target user identifying process for identifying, based at least on identification information of a predetermined user and the specific relationship information, one or more, or all of the users having a specific relationship with the predetermined user as a target user. The calculation process may, in a case in which a companion user is a target user, calculate a distance between a reference point of a target user who is not the companion user and the route determined in the determination process as an off-route distance, whereas in a case in which a companion user is not a target user, calculate a distance between a reference point of a target user and the route determined in the determination process as an off-route distance.

In a preferred embodiment, the determination process may determine, from among preset transit point candidates, a transit point to pass through in traveling from the reference point of the predetermined user to the predetermined facility via the reference point of the companion user, such that an index value indicative of an amount of burden involved in traveling is minimized, to determine the route.

A non-transitory computer-readable recording medium according to another aspect of the present invention has recorded thereon a computer program for a management apparatus that provides users with a service relating to a predetermined object, the management apparatus having a computer, the computer program causing the computer to execute: an identification information obtaining process for obtaining identification information that uniquely identifies one of the users; a relationship information obtaining process for obtaining specific relationship information indicating a specific relationship between at least two of the users; a location information obtaining process for obtaining location information of a reference point of a user and location information of a facility relating to the predetermined object; a target user identifying process for identifying, based at least on identification information of a predetermined user and the specific relationship information, one or more, or all of the users having the specific relationship with the predetermined user as a target user; a determination process for determining a route for traveling from a reference point of a predetermined user to a predetermined facility via a reference point of a predetermined target user based on location information of the reference point obtained for the predetermined user, location information of the predetermined facility, and location information of the reference point of the predetermined target user; a calculation process for calculating an off-route distance which is a distance between a place on the route determined in the determination process and a reference point of a target user who is not the predetermined target user; a candidate identifying process for identifying at least one target user for whom the off-route distance obtained in the distance information obtaining process turns out to be equal to or smaller than a predetermined value, as a candidate user for selection; and a display information generating process for generating display information representing the candidate user for selection identified in the candidate identifying process.

In a preferred embodiment, the determination process may determine, from among preset transit point candidates, a transit point to pass through in traveling from the reference point of the predetermined user to the predetermined facility via the reference point of the predetermined target user, such that an index value indicative of an amount of burden involved in traveling is minimized, to determine the route.

A non-transitory computer-readable recording medium according to yet another aspect has recorded thereon a computer program for a management apparatus that provides users with a service relating to a predetermined object, the management apparatus having a communicator for communicating with a first external apparatus that determines a route for traveling between two places via a route point and calculates a distance between the two places and the management apparatus having a computer, the computer program causing the computer to execute: a location information obtaining process for obtaining location information of a reference point of a user and location information of a facility relating to the predetermined object; a route information obtaining process for, when a predetermined user stops by a reference point of a companion user from among the users of the service relating to the predetermined object in traveling from a reference point of the predetermined user to the predetermined facility, transmitting location information of the reference point obtained for the predetermined user and the location information of the predetermined facility and transmitting location information of the reference point obtained for the companion user as location information of the route point to the first external apparatus, and of obtaining, from the first external apparatus, location information of one or more transit points on a route from the reference point of the predetermined user to the predetermined facility, the route having been determined by the first external apparatus based on the transmitted location information; a distance information obtaining process for transmitting, to the first external apparatus, location information of a reference point obtained for a user who is not the predetermined user or the companion user, from among the users of the service relating to the predetermined object, and at least one of, the location information of the one or more transit points obtained in the route information obtaining process, the location information of the reference point of the companion user, and the location information of the predetermined facility, and of obtaining an off-route distance which is the shortest one of a first distance between the reference point of the user who is not the predetermined user or the companion user and the one or more transit points, a second distance between the reference point of the user who is not the predetermined user or the companion user and the reference point of the predetermined user, a third distance between the reference point of the user who is not the predetermined user or the companion user and the predetermined facility, and a fourth distance between the reference point of the user who is not the predetermined user or the companion user and the reference point of the companion user, with the first distance, the second distance, the third distance, and the fourth distance having been calculated by the first external apparatus based on the transmitted location information; a candidate identifying process for identifying, from the users other than the predetermined user or the companion user, at least one user for whom the off-route distance obtained in the distance information obtaining process turns out to be equal to or smaller than a predetermined value, as a candidate user for selection; and a display information generating process for generating display information representing the candidate user for selection identified in the candidate identifying process.

In the computer-readable recording medium in accordance with the above aspect, the computer program may cause the computer to further execute: an identification information obtaining process for obtaining identification information that uniquely identifies one of the users; a relationship information obtaining process for obtaining specific relationship information indicating a specific relationship between at least two of the users; a target user identifying process for identifying, based at least on identification information of a predetermined user and the specific relationship information, one or more, or all of users having the specific relationship with the predetermined user as a target user(s). The distance information obtaining process may, in a case in which there is a plurality of target users and in which the companion user is a target user, transmit at least one of, the location information of the one or more transit points obtained in the route information obtaining process, the location information of the reference point of the predetermined user, the location information of the reference point of the companion user, and transmit location information of a reference point of the target user other than the companion user as location information of the route point, to the first external apparatus. The distance information obtaining process may, in a case in which the companion user is not the target user, transmit at least one of, the location information of the one or more transit points obtained in the route information obtaining process, the location information of the reference point of the predetermined user, the location information of the reference point of the companion user, and transmit location information of the reference point of the target user as location information of the route point, to the first external apparatus. In a case in which the companion user is a target user, the off-route distance may be the shortest one of a first distance between the reference point of the target user other than the companion user and the one or more transit points, a second distance between the reference point of the target user who is not the companion user and the reference point of the predetermined user, a third distance between the reference point of the target user other than the companion user and the predetermined facility, and a fourth distance between the reference point of the target user other than the companion user and the reference point of the companion user, with the first distance, the second distance, the third distance, and the fourth distance having been calculated by the first external apparatus based on the transmitted location information. In a case in which the companion user is not a target user, the off-route distance may be the shortest one of a first distance between the reference point of the target user and the one or more transit points, a second distance between the reference point of the target user and the reference point of the predetermined user, a third distance between the reference point of the target user and the predetermined facility, and a fourth distance between the reference point of the target user and the reference point of the companion user. In a case in which the companion user is a target user, the candidate identifying process may identify, from among the target users other than the companion user, at least one user for whom the off-route distance obtained in the distance information obtaining process turns out to be equal to or smaller than a predetermined value, as a candidate user for selection, whereas in a case in which the companion user is not a target user, the candidate identifying process may, from among the target users, identify at least one target user for whom the off-route distance obtained in the distance information obtaining process turns out to be equal to or smaller than a predetermined value, as a candidate user for selection.

A non-transitory computer-readable recording medium according to yet another aspect has recorded thereon a computer program for a management apparatus that provides users with a service relating to a predetermined object, the management apparatus having a communicator for communicating with a first external apparatus that determines a route for traveling between two places via a route point and calculates a distance between the two places and the management apparatus having a computer, the computer program causing the computer to execute: an identification information obtaining process for obtaining identification information that uniquely identifies one of the users; a relationship information obtaining process for obtaining specific relationship information indicating a specific relationship between at least two of the users; a location information obtaining process for obtaining location information of a reference point of a user and location information of a facility relating to the predetermined object; a target user identifying process for identifying, based at least on identification information of a predetermined user and the specific relationship information, one or more, or all of the users having the specific relationship with the predetermined user as a target user; a route information obtaining process for, when the predetermined user stops by a reference point of a predetermined target user in traveling from a reference point of the predetermined user to the predetermined facility, transmitting location information of the reference point obtained for the predetermined user and the location information of the predetermined facility and transmitting location information of the reference point of the predetermined target user as location information of the route point to the first external apparatus, and for obtaining, from the first external apparatus, location information of one or more transit points on a route from the reference point of the predetermined user to the predetermined facility, the route having been determined by the first external apparatus based on the transmitted location information; a distance information obtaining process for transmitting, to the first external apparatus, location information of a reference point of a specific target user who is a target user but is not the predetermined target user, from among the users other than the predetermined user, and at least one of, the location information of the one or more transit points obtained in the route information obtaining process, the location information of the reference point of the predetermined user, the location information of the reference point of the predetermined target user, and the location information of the predetermined facility, and of obtaining an off-route distance which is the shortest one of a first distance between the reference point of the specific target user and the one or more transit points, a second distance between the reference point of the specific target user and the reference point of the predetermined user, a third distance between the reference point of the specific target user and the predetermined facility, and a fourth distance between the reference point of the specific target user and the predetermined target user, with the first distance, the second distance, the third distance, and the fourth distance having been calculated by the first external apparatus based on the transmitted location information; a candidate identifying process for identifying at least one specific target user for whom the off-route distance obtained in the distance information obtaining process turns out to be equal to or smaller than a predetermined value, as a candidate user for selection; and a display information generating process for generating display information representing the candidate user for selection identified in the candidate identifying process.

Preferably, in the non-transitory computer-readable recording medium above, the management apparatus may be capable of communicating with a second external apparatus that manages identification information that uniquely identifies external users including the users of the service relating to the predetermined object and specific relationship information indicating specific relationships between the external users, and the relationship information obtaining process may obtain the specific relationship information from the second external apparatus based on the identification information of external users obtained in the identification information obtaining process.

A control method of a management apparatus in accordance with one aspect of the present invention is a method of controlling a management apparatus that provides users with a service relating to a predetermined object. The management apparatus is capable of communicating with a terminal device of a user having a display unit for displaying a screen based on predetermined display information. The method includes: obtaining location information of a reference point of a user and location information of a facility relating to a predetermined object; in response to a request from a terminal device of a predetermined user, determining a route for traveling from a reference point of the predetermined user to a predetermined facility based on location information of the reference point obtained for the predetermined user and location information of the predetermined facility; calculating an off-route distance which is a distance between a reference point of a user who is not the predetermined user from among the users of the service relating to the predetermined object and a place on the route; identifying, from among the users other than the predetermined user, a user for whom the off-route distance turns out to be equal to or smaller than a predetermined value, as a candidate user for selection; generating display information representing the candidate user for selection; and executing transmission control of transmitting the display information to the terminal device of the predetermined user.

In this aspect of the invention, a terminal device is for example, a personal computer, portable phone, smartphone, or tablet-type terminal device. A service relating to a predetermined object may be, for example, an application service for providing information on a predetermined object.

In a preferred embodiment, the control method of the management apparatus further includes: obtaining identification information uniquely identifying one of the users; and obtaining specific relationship information indicating a specific relationship between at least two of the users, wherein the user who is not the predetermined user is a target user who is at least one user who has the specific relationship with the predetermined user.

A control method of a management apparatus in accordance with another aspect of the present invention is a method of controlling a management apparatus that provides users with a service relating to a predetermined object. The management apparatus is capable of communicating with a terminal device of a user having a display unit for displaying a screen based on predetermined display information. The method includes: obtaining identification information that uniquely identifies one of the users; obtaining specific relationship information indicating a specific relationship between at least two of the users; obtaining location information of a reference point of a user and location information of a facility relating to a predetermined object; in response to a request from a terminal device of a predetermined user, identifying, based at least on identification information of the predetermined user and the specific relationship information, one or more, or all of the users having the specific relationship with the predetermined user as a target user; determining a route for traveling from a reference point of the predetermined user to a predetermined facility based on location information of the reference point obtained for the predetermined user and location information of the predetermined facility; calculating an off-route distance which is a distance between a reference point of the target user and the route; identifying a target user for whom the off-route distance turns out to be equal to or smaller than a predetermined value, as a candidate user for selection; generating display information representing the candidate user for selection; and executing transmission control of transmitting the display information to the terminal device of the predetermined user.

According to another aspect of the present invention, a management apparatus is one that provides users with a service relating to a predetermined object, and has: a location information obtainer configured to obtain location information of a reference point of a user and location information of a facility relating to the predetermined object; a determiner configured to determine a route for traveling from a reference point of a predetermined user to a predetermined facility based on location information of the reference point obtained for the predetermined user and location information of the predetermined facility; a calculator configured to calculate an off-route distance which is a distance between a place on the route determined by the determiner and a reference point of a user who is not the predetermined user from among the users of the service relating to the predetermined object; a candidate identifier configured to identify, from among the users other than the predetermined user, at least one user for whom the off-route distance calculated by the calculator turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, and has: an identification information obtainer configured to obtain identification information that uniquely identifies one of the users; a relationship information obtainer configured to obtain specific relationship information indicating a specific relationship between at least two of the users; a location information obtainer configured to obtain location information of a reference point of a user and location information of a facility relating to the predetermined object; a target user identifier configured to identify, based at least on identification information of the predetermined user and the specific relationship information, one or more, or all of the users having a specific relationship with the predetermined user as a target user; a determiner configured to determine a route for traveling from a reference point of the predetermined user to the predetermined facility based on location information of the reference point obtained for the predetermined user and the location information of the predetermined facility; a calculator configured to calculate an off-route distance which is a distance between a place on the route determined by the determiner and a reference point of the target user; a candidate identifier configured to identify a target user for whom the off-route distance calculated by the calculator turns out to be equal to or smaller than a predetermined value, as a candidate user for selection; and a display information generator configured to generate display information representing the candidate user for selection identified by the candidate identifier.

According to yet another aspect of the present invention, a management apparatus is one that provides users with a service relating to a predetermined object, the management apparatus having a communicator for communicating with a first external apparatus that determines a route for traveling between two places and calculates a distance between the two places, the management apparatus has: a location information obtainer configured to obtain location information of a reference point of a user and location information of a facility relating to the predetermined object; a route information obtainer configured to transmit location information of a reference point obtained for a predetermined user and location information of the predetermined facility to the first external apparatus, and obtain, from the first external apparatus, location information of one or more transit points on a route having been determined by the first external apparatus based on the transmitted location information; a distance information obtainer configured to transmit, to the first external apparatus, location information of a reference point obtained for a user who is not the predetermined user, from among the users of the service relating to the predetermined object, and at least one of, the location information of the one or more transit points obtained by the route information obtainer, the location information of the reference point of the predetermined user, and the location information of the predetermined facility, and obtain an off-route distance which is the shortest one of a first distance between the reference point of the user who is not the predetermined user and the one or more transit points, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information; a candidate identifier configured to identify, from among the users other than the predetermined user, at least one user for whom the off-route distance obtained by the distance information obtainer turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, the management apparatus having a communicator for communicating with a first external apparatus that determines a route for traveling between two places and calculates a distance between the two places, the management apparatus including: an identification information obtainer configured to obtain identification information that uniquely identifies one of the users; a relationship information obtainer configured to obtain specific relationship information indicating a specific relationship between at least two of the users; a location information obtainer configured to obtain location information of a reference point of a user and location information of a facility relating to the predetermined object; a target user identifier configured to identify, based at least on identification information of the predetermined user and the specific relationship information, one or more, or all of the users having the specific relationship with the predetermined user as a target user; a route information obtainer configured to transmit location information of a reference point obtained for the predetermined user and the location information of the predetermined facility to the first external apparatus, and obtain, from the first external apparatus, location information of one or more transit points on a route having been determined by the first external apparatus based on the transmitted location information; a distance information obtainer to transmit, to the first external apparatus, location information of a reference point obtained for the target user, and at least one of, the location information of the one or more transit points obtained by the route information obtainer, the location information of the reference point of the predetermined user, and the location information of the predetermined facility, and obtain an off-route distance which is the shortest one of a first distance between the reference point of the target user and the one or more transit points, a second distance between the reference point of the target user and the reference point of the predetermined user, and a third distance between the reference point of the target user and the predetermined facility, with the first distance, the second distance, and the third distance having been calculated by the first external apparatus based on the transmitted location information; a candidate identifier configured to identify at least one target user for whom the off-route distance obtained by the distance information obtainer turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, and has: a location information obtainer configured to obtain location information of a reference point of a user and location information of a facility relating to the predetermined object; a determiner configured to determine, based on location information of a reference point obtained for a predetermined user, location information of the predetermined facility, and location information of a reference point obtained for a companion user from among the users of the service relating to the predetermined object, a route for traveling from the reference point of the predetermined user to the predetermined facility via the reference point of the companion user; a calculator configured to calculate an off-route distance which is a distance between a place on the route determined by the determiner and a reference point of a user, from among the users of the service relating to the predetermined object, who is not the predetermined user or the companion user; a candidate identifier configured to identify, from among the users other than the predetermined user or the companion user, at least one user for whom the off-route distance obtained by the distance information obtainer turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, and has: an identification information obtainer configured to obtain identification information that uniquely identifies one of the users; a relationship information obtainer configured to obtain specific relationship information indicating a specific relationship between at least two of the users; a location information obtainer configured to obtain location information of a reference point of a user and location information of a facility relating to the predetermined object; a target user identifier configured to identify, based at least on identification information of the predetermined user and the specific relationship information, one or more, or all of the users having the specific relationship with the predetermined user as a target user; a determiner configured to determine a route for traveling from a reference point of a predetermined user to the predetermined facility via a reference point of a predetermined target user based on location information of the reference point obtained for the predetermined user, location information of the predetermined facility, and location information of the reference point of the predetermined target user; a calculator configured to calculate an off-route distance which is a distance between a place on the route determined by the determiner and a reference point of a target user who is not the predetermined target user; a candidate identifier configured to identify at least one target user for whom the off-route distance obtained by the distance information obtainer turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, the management apparatus having a communicator for communicating with a first external apparatus that determines a route for traveling between two places via a route point and calculates a distance between the two places. The management apparatus has: a location information obtainer configured to obtain location information of a reference point of a user and location information of a facility relating to the predetermined object; a route information obtainer configured to, when the predetermined user stops by a reference point of a companion user from among the users of the service relating to the predetermined object in traveling from a reference point of the predetermined user to the predetermined facility, transmit location information of the reference point obtained for the predetermined user and the location information of the predetermined facility and transmit also location information of the reference point obtained for the companion user as location information of the route point to the first external apparatus, and obtain, from the first external apparatus, location information of one or more transit points on a route from the reference point of the predetermined user to the predetermined facility, the route having been determined by the first external apparatus based on the transmitted location information; a distance information obtainer configured to transmit, to the first external apparatus, location information of a reference point of a user who is not the predetermined user or the companion user, from among the users, and at least one of, the location information of the one or more transit points obtained by the route information obtainer, the location information of the reference point of the predetermined user, the location information of the reference point of the companion user, and the location information of the predetermined facility, and obtain an off-route distance which is the shortest one of a first distance between the reference point of the user who is not the predetermined user or the companion user and the one or more transit points, a second distance between the reference point of the user who is not the predetermined user or the companion user and the reference point of the predetermined user, a third distance between the reference point of the user who is not the predetermined user or the companion user and the predetermined facility, and a fourth distance between the reference point of the user who is not the predetermined user or the companion user and the reference point of the companion user, with the first distance, the second distance, the third distance, and the fourth distance having been calculated by the first external apparatus based on the transmitted location information; a candidate identifier configured to identify, from among the users other than the predetermined user or the companion user, at least one user for whom the off-route distance obtained by the distance information obtainer turns out to be equal to or smaller than a predetermined value, as a candidate user for selection; and a display information generator configured to generate display information representing the candidate user for selection identified by the candidate identifier.

According to another aspect of the present invention, a management apparatus is one that provides users with a service relating to a predetermined object, the management apparatus having a communicator for communicating with a first external apparatus that determines a route for traveling between two places via a route point and calculates a distance between the two places. The management apparatus has: an identification information obtainer configured to obtain identification information that uniquely identifies one of the users; a relationship information obtainer configured to obtain specific relationship information indicating a specific relationship between at least two of the users; a location information obtainer configured to obtain location information of a reference point of a user and location information of a facility relating to the predetermined object; a target user identifier configured to identify, based at least on identification information of the predetermined user and the specific relationship information, one or more, or all of the users having the specific relationship with the predetermined user as a target user; a route information obtainer configured to, when the predetermined user stops by a reference point of a predetermined target user in traveling from a reference point of the predetermined user to the predetermined facility, transmit location information of the reference point obtained for the predetermined user and the location information of the predetermined facility and transmit also location information of the reference point of the predetermined target user as location information of the route point to the first external apparatus, and obtain, from the first external apparatus, location information of one or more transit points on a route from the reference point of the predetermined user to the predetermined facility, the route having been determined by the first external apparatus based on the transmitted location information; a distance information obtainer configured to transmit, to the first external apparatus, location information of a reference point of a specific target user who is the target user but is not the predetermined target user, and at least one of, the location information of the one or more transit points obtained by the route information obtainer, the location information of the reference point of the predetermined user, the location information of the reference point of the predetermined target user, and the location information of the predetermined facility, and obtain an off-route distance which is the shortest one of a first distance between the reference point of the specific target user and the one or more transit points, a second distance between the reference point of the specific target user and the reference point of the predetermined user, a third distance between the reference point of the specific target user and the predetermined facility, and a fourth distance between the reference point of the specific target user and the predetermined target user, with the first distance, the second distance, the third distance, and the fourth distance having been calculated by the first external apparatus based on the transmitted location information; a candidate identifier configured to identify at least one specific target user for whom the off-route distance obtained by the distance information obtainer turns out to be equal to or smaller than a predetermined value, as a candidate user for selection; and a display information generator configured to generate display information representing the candidate user for selection identified by the candidate identifier.

According to one aspect of the present invention, a service providing system is one that has a management apparatus that provides users with a service relating to a predetermined object and terminal devices of the users. The terminal device is provided with a display unit for displaying a screen based on predetermined display information, and is capable of communicating with the management apparatus. The management apparatus has: a location information obtainer configured to obtain location information of a reference point of a user and location information of a facility relating to the predetermined object; in response to a request from a terminal device of a predetermined user, a determiner configured to determine a route for traveling from a reference point of a predetermined user to a predetermined facility based on location information of the reference point obtained for the predetermined user and location information of the predetermined facility; a calculator configured to calculate an off-route distance which is a distance between a place on the route determined by the determiner and a reference point of a user who is not the predetermined user from among the users of the service relating to the predetermined object; a candidate identifier configured to identify, from among the users other than the predetermined user, at least one user for whom the off-route distance calculated by the calculator turns out to be equal to or smaller than a predetermined value, as a candidate user for selection; a display information generator configured to generate display information representing the candidate user for selection identified by the candidate identifier; and a transmission controller configured to control transmission of the display information to the terminal device of the predetermined user.

According to one aspect of the present invention, a service providing system is one that has a management apparatus that provides users with a service relating to a predetermined object and terminal devices of the users. The terminal device is provided with a display unit for displaying a screen based on predetermined display information, and is capable of communicating with the management apparatus. The management apparatus has: an identification information obtainer configured to obtain identification information that uniquely identifies one of the users; a relationship information obtainer configured to obtain specific relationship information indicating a specific relationship between at least two of the users; a location information obtainer configured to obtain location information of a reference point of a user and location information of a facility relating to the predetermined object; in response to a request from a terminal device of a predetermined user, a target user identifier configured to identify, based at least on identification information of the predetermined user and the specific relationship information, one or more, or all of the users having the specific relationship with the predetermined user as a target user; a determiner configured to determine a route for traveling from a reference point of the predetermined user to the predetermined facility based on location information of the reference point obtained for the predetermined user and the location information of the predetermined facility; a calculator configured to calculate an off-route distance which is a distance between a place on the route determined by the determiner and a reference point of the target user; a candidate identifier configured to identify at least one target user for whom the off-route distance calculated by the calculator turns out to be equal to or smaller than a predetermined value, as a candidate user for selection; a display information generator configured to generate display information representing the candidate user for selection identified by the candidate identifier; and a transmission controller configured to control transmission of the display information to the terminal device of the predetermined user.

### DESCRIPTION OF REFERENCE NUMERALS

1 . . . management server
2 . . . terminal device
3 . . . external management server
4 . . . map information server
11 . . . user information obtainer
12 . . . friend information obtainer
13 . . . location information obtainer
14 . . . route information obtainer
15 . . . off-route distance obtainer
16 . . . target user identifier
17 . . . candidate user for selection identifier
18 . . . display information generator
19 . . . storage device
41 . . . route determiner
42 . . . distance calculator

What is claimed is:

1. A non-transitory computer-readable recording medium having recorded thereon a computer program for a management apparatus that provides users with a service relating to a predetermined object, the management apparatus having a computer,
the computer program causing the computer to execute:
a location information obtaining process for obtaining location information of a reference point of a user and location information of a facility relating to a predetermined object;
a determination process for determining a route for traveling from a reference point of a predetermined user to a predetermined facility based on location information of the reference point obtained for the predetermined user and location information of the predetermined facility;
a calculation process for calculating an off-route distance which is a distance between a place on the route determined in the determination process and a reference point of a user who is not the predetermined user from among the users of the service relating to the predetermined object;
a candidate identifying process for identifying, from among the users other than the predetermined user, at least one user for whom the off-route distance calculated in the calculation process turns out to be equal to or smaller than a predetermined value, as a candidate user for selection; and
a display information generating process for generating display information representing the candidate user for selection identified in the candidate identifying process.

2. The non-transitory computer-readable recording medium according to claim 1,
wherein the determination process determines, from among preset transit point candidates, a transit point to pass through in traveling from the reference point of the predetermined user to the predetermined facility, such that an index value indicative of an amount of burden involved in traveling is minimized, to determine the route.

3. The non-transitory computer-readable recording medium according to claim 1,
wherein the determination process determines the route so as to additionally stop by a reference point of a companion user to accompany the predetermined user, and
wherein the reference point of the user who is not the predetermined user does not include the reference point of the predetermined user or the reference point of the companion user.

4. The non-transitory computer-readable recording medium according to claim 3,
wherein the determination process determines, from among preset transit point candidates, a transit point to pass through in traveling from the reference point of the predetermined user to the predetermined facility via the reference point of the companion user, such that an index value indicative of an amount of burden involved in traveling is minimized, to determine the route.

5. The non-transitory computer-readable recording medium according to claim 1,
the computer program causing the computer to further execute:
an identification information obtaining process for obtaining identification information that uniquely identifies one of the users; and
a relationship information obtaining process for obtaining specific relationship information that indicates a specific relationship between at least two of the users,
wherein the user who is not the predetermined user is a target user who is at least one user who has the specific relationship with the predetermined user.

6. The non-transitory computer-readable recording medium according to claim 5,
wherein the determination process determines, from among preset transit point candidates, a transit point to pass in traveling from the reference point of the predetermined user to the predetermined facility, such that an index value indicative of an amount of burden involved in traveling is minimized, to determine the route.

7. The non-transitory computer-readable recording medium according to claim 5,
wherein the determination process determines the route so as to additionally stop at a reference point of a predetermined target user, and
wherein, when there is a plurality of the target users including the predetermined target user, the user who is not the predetermined user is a target user who is not the predetermined target user.

8. A non-transitory computer-readable recording medium having recorded thereon a computer program for a management apparatus that provides users with a service relating to a predetermined object, the management apparatus having a computer,
the computer program causing the computer to execute:
a location information obtaining process for obtaining location information of a reference point of a user and location information of a facility relating to a predetermined object;
a route information obtaining process for transmitting location information of a reference point obtained for a predetermined user and location information of the predetermined facility to a first external apparatus, and of obtaining, from the first external apparatus, location information of one or more transit points on a route from the reference point of the predetermined user to the predetermined facility, the route having been determined by the first external apparatus based on the transmitted location information;
a distance information obtaining process for transmitting, to the first external apparatus, location information of a reference point obtained for a user who is not the predetermined user from among the users of the service relating to the predetermined object and at least one of, the location information of the one or more transit points obtained in the route information obtaining process, the location information of the reference point of the predetermined user, or the location information of the predetermined facility, and for obtaining an off-route distance which is a shortest one of a first distance between the reference point of the user who is not the predetermined user and the one or more transit points, a second distance between the reference point of the user who is not the predetermined user and the reference point of the predetermined user, and a third distance between the reference point of the user who is not the predetermined user and the predetermined facility, with the first distance, the second distance, and the third distance having been calculated by the first external apparatus based on the transmitted location information;
a candidate identifying process for identifying, from among the users other than the predetermined user, at least one user for whom the off-route distance obtained in the distance information obtaining process turns out to be equal to or smaller than a predetermined value, as a candidate user for selection; and
a display information generating process for generating display information representing the candidate user for selection identified in the candidate identifying process.

9. The non-transitory computer-readable recording medium according to claim 8,
wherein, when the route has one or a plurality of transit points, location information of the one or plurality of transit points used in the distance information obtaining process does not include location information of a transit point having a particular attribute, wherein, when the transit point having the particular attribute is selected as a route deviation point, a road type thereby is changed from a predetermined type to another type.

10. The non-transitory computer-readable recording medium according to claim 8,
wherein the route information obtaining process further transmits, to the first external apparatus, location information of a reference point obtained for a companion user as route point location information, in a case in which the predetermined user stops at the reference point of the companion user to accompany the predetermined user in traveling from the reference point of the predetermined user to the predetermined facility, and
wherein the distance information obtaining process transmits, to the first external apparatus, the location information of the reference point of a user who is not the predetermined user or the companion user from among the users of the service relating the predetermined object and at least one of the location information of the one or more transit points obtained in the route information obtaining process, the location information of the reference point of the predetermined user, the location information of the reference point of the companion user, or the location information of the predetermined facility, and obtains an off-route distance which is a shortest one of the first distance, the second distance, the third distance, and a fourth distance between the reference point of the user who is not the predetermined user or the companion user and the location information of the reference point of the companion user, with the fourth distance having been calculated by the first external apparatus based on the transmitted location information.

11. The non-transitory computer-readable recording medium according to claim 10,
wherein the management apparatus is capable of communicating with a second external apparatus that manages identification information uniquely identifies external users including the users of the service relating to the predetermined object and specific relationship information indicating specific relationships between the external users,
the computer program causing the computer to further execute:
an identification information obtaining process for obtaining identification information uniquely identifying one of the external users; and
a relationship information obtaining process for obtaining specific relationship information indicating a specific relationship between at least two of the external users based on the identification information of the external users obtained in the identification information obtaining process.

12. The non-transitory computer-readable recording medium according to claim 8,
the computer program causing the computer to further execute:
an identification information obtaining process for obtaining identification information uniquely identifying one of the users; and
a relationship information obtaining process for obtaining specific relationship information indicating a specific relationship between at least two of the users,
wherein the user who is not the predetermined user is a target user who is at least one user who has the specific relationship with the predetermined user.

13. The non-transitory computer-readable recording medium according to claim 12,
wherein, when the route has one or a plurality of transit points, location information of the one or plurality of transit points used in the distance information obtaining process does not include location information of a transit point having a particular attribute, wherein, when the transit point having the particular attribute is selected as a route deviation point, a road type is thereby changed from a predetermined type to another type.

14. A control method of a management apparatus that provides users with a service relating to a predetermined object, wherein the management apparatus is capable of communicating with a terminal device of a user having a display unit for displaying a screen based on predetermined display information,
the method comprising:
obtaining location information of a reference point of a user and location information of a facility relating to a predetermined object;
in response to a request from a terminal device of a predetermined user,
determining a route for traveling from a reference point of the predetermined user to a predetermined facility based on location information of the reference point obtained for the predetermined user and location information of the predetermined facility;
calculating an off-route distance which is a distance between a reference point of a user who is not the predetermined user from among the users of the service relating to the predetermined object and a place on the route;
identifying, from among the users other than the predetermined user, at least one user for whom the off-route distance calculated in the calculation process is equal to or smaller than a predetermined value, as a candidate user for selection;
generating display information representing the candidate user for selection; and
executing transmission control of transmitting the display information to the terminal device of the predetermined user.

15. The control method of the management apparatus according to claim 14, further comprising:
obtaining identification information uniquely identifying one of the users; and
obtaining specific relationship information indicating a specific relationship between at least two of the users,
wherein the user who is not the predetermined user is a target user who is at least one user who has the specific relationship with the predetermined user.
